(19) United States
(12) Patent Application Publication
(10) Pub. No.: US 2025/0307877 A1
(43) Pub. Date: Oct. 2, 2025

(54) AUTOMATED PERSONAL AI-DRIVEN LIFESTYLE ORCHESTRATION AND EXECUTION SYSTEM

(71) Applicant: Mack Craft, Los Angeles, CA (US)

(72) Inventor: Mack Craft, Los Angeles, CA (US)

(21) Appl. No.: 19/237,871

(22) Filed: Jun. 13, 2025

Related U.S. Application Data
(63) Continuation-in-part of application No. 18/652,738, filed on May 1, 2024.
(63) Continuation-in-part of application No. 18/064,337, filed on Dec. 12, 2022.
Application No. 18/064,337 is a continuation-in-part of application No. 18/051,273, filed on Oct. 31, 2022, now Pat. No. 12,079,263.
Application No. 18/051,273 is a continuation-in-part of application No. 17/248,185, filed on Jan. 13, 2021, now Pat. No. 11,526,472.
(60) Provisional application No. 62/974,091, filed on Nov. 13, 2019.

(51) Int. Cl. G06Q 30/0251; G06Q 10/02; G06Q 10/1093; G06Q 30/0601

(52) U.S. Cl. CPC G06Q 30/0269; G06Q 10/02; G06Q 10/1093; G06Q 30/0601

(57) ABSTRACT

An Automated AI-Driven Lifestyle Orchestration System proactively manages a user's daily life by intelligently populating calendars with relevant, time-sensitive marketing objects. This is achieved through sophisticated AI-driven analysis of user directives, preferences, and real-time location data obtained via computing devices like smartphones. The system leverages advanced media identification modules employing fingerprinting and watermarking to accurately match user-captured media (via a Percipient Sample Pack (PSP)) to specific content and associated products. It facilitates dynamic commerce through hierarchical linked lists for purchasing authentic or similar items, supported by an affiliate program. This inventive solution significantly improves personal organization and digital commerce by transforming passive interaction into a proactive, intelligent, and monetizable user experience.

### RELATED APPLICATION

This application is a continuation in part and claims the benefit of priority of U.S. Nonprovisional application Ser. No. 18/652,738 filed May 1, 2024, which is a continuation in part and claims the benefit of priority of U.S. Nonprovisional application Ser. No. 18/064,337 filed Dec. 12, 2022 and nonprovisional of U.S. Nonprovisional application Ser. No. 18/051,273 filed Oct. 31, 2022, which claim the benefit of priority of U.S. Nonprovisional application Ser. No. 17/248,185 filed Jan. 13, 2021 which is now patented as U.S. Pat. No. 11,526,472, issued Dec. 13, 2022; which claims the benefit of priority of U.S. Provisional Application 62/974,091 filed Nov. 13, 2019, the entire contents of which are incorporated herein by this reference and made a part hereof; and which is a continuation-in-part of application Ser. No. 16/213,959 filed Dec. 7, 2018, which is a nonprovisional of and claims the benefit of Provisional Application No. 62/596,003 filed Dec. 7, 2017.

### FIELD OF THE INVENTION

This invention relates generally to artificial intelligence systems and, more particularly, to an automated personal AI-driven lifestyle orchestration system that proactively manages a user's calendar and daily life by intelligently delivering and scheduling marketing objects within a digital ecosystem.

### BACKGROUND

The pervasive integration of digital technologies into daily life has, paradoxically, created new challenges in personal organization and information management. Individuals today are immersed in a torrent of digital content, commercial solicitations, and personal obligations, leading to a state of information overload and a persistent feeling of being reactive rather than proactive in managing their own lives. While various technological solutions have emerged to address specific aspects of these challenges, they invariably suffer from significant shortcomings, collectively demonstrating a critical unmet need for a more holistic and intelligent approach.

Existing calendar and scheduling applications, while foundational, are fundamentally passive and reactive. They serve primarily as digital repositories for manually entered appointments and reminders. The onus remains entirely on the user to meticulously input every event, update changes, and remember contextual details. This manual burden is exacerbated in scenarios involving multiple calendars (e.g., personal, professional, family), leading to fragmented schedules, overlooked commitments, and frequent scheduling conflicts. For example, a user might manually add a concert to their calendar, but the system offers no intelligent suggestions for pre-show dining, parking, or post-event activities based on their preferences or location. This lack of dynamic integration with a user's broader lifestyle, real-time context, and evolving preferences means that these tools fail to truly *manage* a user's time; they merely record it, leaving a significant void in proactive lifestyle orchestration. The sheer volume of digital tools for different aspects of life—from separate apps for travel, entertainment, and shopping-further exacerbates this fragmentation, preventing a unified view and intelligent management of a user's daily life.

The current generation of AI assistants, exemplified by voice-activated smart speakers or smartphone-based virtual assistants, are largely constrained to a command-response paradigm. While they competently execute direct queries (e.g., “What's the weather?”), their “intelligence” rarely extends to genuine anticipation or complex inference about a user's needs. They lack the sophisticated contextual awareness, predictive analytics, and deep understanding of evolving user intent required to offer truly personalized and proactive assistance. For instance, an existing AI assistant might remind a user of a flight if manually added to a calendar, but it will not proactively suggest alternative travel arrangements based on real-time traffic, recommend nearby attractions at the destination based on learned interests, or even propose packing items based on predicted weather, without explicit user prompting. This deficiency stems from their limited ability to synthesize disparate data sources (user preferences, location, real-time events, commercial inventories) and infer complex correlations to deliver timely, relevant, and actionable information or services without direct command. The constant need for explicit verbal or manual input for every task places a substantial cognitive load on the user, preventing a truly “ambient” or “invisible” assistance experience.

The vast amount of digital content consumed daily presents immense commercial potential, yet existing systems struggle to efficiently bridge user interest with actionable opportunities. While rudimentary content recognition technologies exist (e.g., Shazam for music), they are largely siloed and lack comprehensive integration with broader commercial ecosystems. For example, a user watching a streaming series might admire an actor's outfit or a piece of furniture in a scene. While they might be able to manually search for these items, there is no seamless, real-time mechanism to identify these “marketing objects” within the media, link them to their “use information” (e.g., brand, designer, scene context), and instantly provide purchasing options. Current monetization efforts often rely on broad, often irrelevant advertising overlays or static product placements that fail to capture immediate user intent. This leads to a significant “friction point” in the user journey, as the moment of peak interest is often separated from the opportunity to act, resulting in lost commercial conversions and a frustrating user experience. There is a clear need for a system that can intelligently parse ephemeral media content, identify specific items within it, and connect these items directly to commercial avenues tailored to the individual viewer's preferences, making the transition from passive consumption to active engagement effortless.

The current landscape of digital advertising, despite advancements in targeting, largely fails to integrate promotions contextually and proactively into a user's personal planning space. Advertisements are often delivered as intrusive pop-ups, banners, or email blasts that disrupt the user experience and are frequently irrelevant to their immediate needs or schedule. There is a profound unmet need for a system that can intelligently analyze a user's preferences, location, calendar commitments, and real-time activities to seamlessly inject *relevant* advertising or promotional content directly into their calendar or daily flow. For instance, if a user has a rare free evening, a sophisticated system should be able to suggest a concert based on their musical tastes, a dining experience near their current location, or a special event matching their interests, and proactively schedule it into their calendar, rather than simply displaying a generic advertisement. This represents a fundamental shift from interruptive marketing to value-added, contextually intelligent engagement, which current systems are incapable of achieving due to their limited understanding of complex user context and lack of direct calendar integration.

Beyond digital information, individuals also manage a plethora of physical assets. However, existing personal inventory management solutions are rudimentary at best. Users typically rely on manual lists, ad-hoc spreadsheets, or simply memory to keep track of their belongings. There is no comprehensive system that intelligently logs, tracks, and analyzes the usage of personal items (e.g., clothing, equipment). This leads to inefficiencies such as underutilized assets, redundant purchases, and difficulty in identifying items suitable for sale, rental, or donation. Furthermore, when a user decides to dispose of an item, the process is often manual and disconnected from their inventory, requiring separate efforts for listing, selling, or finding donation centers. A significant problem in the prior art is the absence of an integrated system that not only helps users understand the “use information” of their items but also proactively facilitates their monetization or responsible disposition in an intelligent, incentivized, and streamlined manner, thereby optimizing personal resource management and extending the utility and lifespan of personal assets.

In light of these pervasive shortcomings and the increasing demand for more intelligent and integrated digital assistance, there is a clear and pressing need for a novel technological solution. This solution must move beyond reactive tools and fragmented systems to provide an automated, AI-driven platform capable of proactively orchestrating a user's lifestyle by intelligently managing their calendar, personal assets, and interactions with commercial opportunities, all while delivering a seamless and highly personalized experience. The present invention addresses these critical deficiencies by offering a comprehensive and anticipatory system designed to bridge the gap between digital capabilities and real-world needs.

The invention is directed to overcoming one or more of the problems and solving one or more of the needs as set forth above.

### SUMMARY OF THE INVENTION

To solve one or more of the problems set forth above, in an exemplary implementation of the invention, an Automated Personal AI-Driven Lifestyle Orchestration System is provided. The Automated Personal AI-Driven Lifestyle Orchestration System proactively manages a user's calendar and daily life by intelligently delivering and scheduling marketing objects within a digital ecosystem. This system fundamentally revolutionizes how individuals interact with information and commercial opportunities by moving beyond reactive responses to provide anticipatory, personalized assistance.

At its core, the system operates on a computer-implemented method for proactively managing a user's lifestyle and facilitating real-time commerce. This method involves a computing system storing databases, at least one of which is associated with virtual repositories. These virtual repositories uniquely include marketing objects with “use information,” which details contextual data (dates, times, locations, associated media) about an item or service's past, present, or intended use. An artificial intelligence (AI) computing processing engine automates the population of these virtual repositories with marketing objects and their comprehensive “use information.” This intelligent, automated population, incorporating detailed use context, significantly departs from conventional static inventory systems by providing a richer, more dynamic dataset for personalized recommendations. Each virtual repository is also associated with one or more users and their respective marketing objects and “use information,” further enabling multi-user contexts through a “second virtual repository” associated with a “second user” for shared experiences.

A central element is an artificial intelligence-powered assistant within the computing system. This assistant receives files, such as images or videos, which are intelligently associated with marketing objects created, used, or owned by a second user (e.g., a celebrity). The Artificial intelligence system then associates these marketing objects with detailed “use information” for the second user and automatically populates them into categorized fields within the second virtual repository. This automated, semantic-driven population of repositories with rich, context-aware use information from media represents a key technical advancement over systems requiring manual data input or lacking deep contextual understanding.

Interaction with the system is initiated when the computing system receives a first trigger voice command subject matter directive from a first user's digital device. This voice command intuitively expresses the user's interest, requesting specific information, user data, and marketing objects associated with a particular subject matter. These marketing objects are critically linked to one or more virtual repositories of the second user. Upon receiving the voice command, the semantic intelligence computing system performs marketing object identification, intelligently interpreting the subject matter and identifying both the first and second users. If the identified subject matter of interest for the second user matches the voice command, the system makes available to the first user a copy of one or more matching marketing objects on their device, invariably including relevant links. This ability to interpret complex voice commands, perform semantic matching across disparate data sources, and deliver actionable results in real-time addresses a significant technological problem of bridging human intent with digital information and commerce, providing an inventive concept that enhances human-computer interaction in a highly personalized and efficient manner.

### Proactive Scheduling and Calendar Integration

A crucial aspect of this invention is its ability to proactively manage a user's calendar. The system intelligently populates a user's calendar with date and time-sensitive information or marketing objects based on interpreted user-created, selected, or voice-command directives, preferences, source data, marketing objects, and location data. This process can occur without explicit user prompting for scheduling. Information or marketing objects are then delivered as a comprehensive list to the user's mobile computing device interface, incorporating associated information, links, images, and/or videos. The system's ability to intelligently schedule events into the user's calendar is a key improvement, moving beyond passive calendar entries.

The system's innovative approach further includes populating an event or advertisement to a user's calendar, enabled by the semantic intelligence-powered assistant carrying out functions like initiating a purchase. The assistant can also save marketing objects or information at a user's explicit direction and populate a calendar with date and time-sensitive information directly on command. Beyond simple scheduling, the system can automatically schedule reservations via third-party applications, demonstrating its practical utility.

This Automated Personal AI-Driven Lifestyle Orchestration System distinguishes itself by intelligently pulling date and time-sensitive information, including media or event details, from various source data. This is achieved through the system's interpretation and analysis of consumer directives, user profiles, preferences, and history. The analyzed results are presented in a user interface, precisely matching source data (including marketing objects) against the consumer's subject matter of interest, user preferences, comprehensive user profiles (including gender and ethnicity), and user history. This deep contextualization and proactive matching provide a significant technical improvement over systems relying solely on keyword searches or manual data entry for scheduling.

The system also uniquely incorporates an automated Smart Calendar associated with the AI-driven lifestyle assistant. This Smart Calendar integrates date and time-sensitive information from diverse source data, dynamically populated based on interpreted consumer directives, user profiles, preferences, and history.

A groundbreaking aspect of this technology is its ability to push paid or curated date and time-sensitive advertising and promotional information, including marketing objects, directly into a user's calendar. This is uniquely based on the system's interpretation and analysis of consumer directives, user profiles, preferences, history, and marketing directives, marketing objects, and frequently updated source data feed information. The user information is rigorously matched against marketing directives, location information, marketing objects, and data feeds from advertisers, sources, or establishments. This in-depth interpretation and analysis accurately identify matching directives and marketing objects to populate a user's calendar at a specific time and date (according to the user's location time zone) for reminders, recommendations, informational purposes, and/or to facilitate a purchase. The calendar can be flexibly structured with 24/7 date and time slots. This intelligent, targeted advertising and scheduling capability represents a significant technical improvement in marketing automation, providing contextually relevant information directly into the user's personal planning space, which is far more effective than untargeted advertisements.

The automated personal AI-Driven lifestyle assistant or smart calendar further enhances its utility by proactively populating a user's calendar based on user data, user location data (including GPS coordinates analyzed against location data), and source data including marketing objects. This continuous population occurs multiple times daily via the user's mobile computing device to determine user location. The AI lifestyle assistant's algorithms and logic constantly understand its owner and proactively populate the owner's calendar with activities and destinations 24/7. This proactive populating of a user calendar associated with a user computing device may populate as far out as 2 years, depending on the data received. A user may click on any future date within the digital calendar to see marketing objects and/or advertisement associated with their preferences or directives. This intelligent algorithm is capable of understanding existing personal and business calendar entries (e.g., Google Calendar, Apple Calendar, Outlook) and then intelligently suggesting complementary activities and places to go. For instance, after confirming a user's dental appointment, the system can seamlessly suggest subsequent activities, even verifying attendance at confirmed reservations by matching user GPS location to the establishment at the appropriate time. Furthermore, the AI assistant can execute tasks or assignments through user voice commands, such as sending emails or texts, inviting other users to trips or events, and accepting or declining invitations based on calendar availability. It proactively prompts the user with notifications or alerts about incoming invitations, crucial information, or events, and enriches calendar entries with valuable source data, marketing objects, direct links, relevant images, captivating video trailers, celebrity information, and even automatic streaming video or audio. This seamless integration extends to calendaring information by parsing confirmation receipts from various sources, including Google Calendar, Apple Calendar, third-party applications, and user emails, leveraging user preferences and location directives via an automated process. The system proactively solves problems with due dates, further enhancing its utility as a comprehensive lifestyle manager. This continuous monitoring and proactive behavior, facilitated by the AI processing engine, represent a significant technical improvement over basic calendar systems that require explicit user input for every entry.

The system empowers a user to instruct the computing system or Personal AI Concierge Lifestyle Assistant, through either selection or a voice command directive, to save or actively follow a specific directive or preference. Once a directive is saved, the user receives real-time notifications, information, products, or services associated with that directive. This real-time information can be gleaned from television or radio programs, or an event. For example, if a user chooses to follow “Oatmeal Ice Cream,” the AI assistant will notify the user via a computing device if a nearby establishment is selling oatmeal ice cream. This alleviates the need for the user to actively remember such details. Another example: if a user has saved “Tupac Shakur,” and a special program about him is scheduled, the AI Assistant will schedule that program into the user's calendar with a notification. A directive may be any topic, listed, viewed, or heard on various media outlets, or conveyed by an imperceptible watermark signal. This technology is a personal AI concierge lifestyle assistant designed to interpret and analyze consumer directives and respond with results as they exist, delivered via a mobile computing device if results are available immediately, have a future date, or become public for the first time. The AI assistant continuously checks for a user's current, new, or destination location. Once a location is detected, the AI assistant may identify one or more locations using GPS/latitude longitude coordinates and begin analyzing marketing objects, events, and files associated with the location against topic-driven consumer directives, subject matter, lifestyle preferences, popularity, and profile information of a first user to find exact matches. The AI assistant proactively populates recommendations to the user calendar in the order of date and time-sensitive events/matching marketing objects that are most likely to interest the user at that location. Results can also be delivered as a list to the user interface. Each marketing object/item record in the database is associated with latitude longitude coordinates.

A comprehensive database of marketing objects is meticulously organized into categories and subcategories (e.g., restaurants, nightclubs, live events, active life, beauty & spa services). The AI assistant is engineered to continuously understand its user's location and is smart enough to populate the calendar with the most likely schedule of things to do and places to go for its owner, spanning from early morning breakfast spots to late-evening events. The Personal AI assistant is also smart enough to interpret a dinner reservation from a populated confirmed reservation in Google Calendar or Apple Calendar and ascertain if the user actually attended by matching GPS coordinates at the precise time of the reservation. Furthermore, it is capable of scheduling different category events in time slots following a confirmed matching GPS location of the user and establishment. For example, if a user went to a restaurant at 6 PM, the personal AI assistant might not schedule another restaurant dinner for three hours, instead proposing a complementary activity such as dessert, bowling, or a rooftop live event. The AI assistant can also aggregate the selected or spoken subject matter of interest voice command directives and user profiles of one or more users to create a group trip or group event, constructing a unified group trip itinerary populated with relevant marketing events for each day throughout the duration of the trip or event. This includes the advanced capability of finding exact matching and expressing an event via a subject matter voice command directive for precise calendar population.

One significant technological advancement is a context-aware, location-sensitive AI assistant that operates as a Lifestyle Orchestration Engine. This AI-Driven Lifestyle Orchestration System represents a breakthrough in consumer-centric artificial intelligence by seamlessly unifying behavioral analysis, smart calendaring, real-time media recognition, and location-based marketing into a cohesive and fluid user experience. Unlike existing systems, which merely react to user inputs, this invention creates a continuous feedback loop of sensing, analyzing, predicting, and acting. It integrates several advanced technological components into a highly cohesive system: Natural Language Processing (NLP) enables understanding and interpretation of voice commands and preferences. Location-Based Services (LBS) uses GPS, latitude, and longitude coordinates to identify current and future (e.g. Destination) locations for personalized, automated geographically relevant recommendations. Calendar Integration & Behavioral Analysis interfaces with tools like Google Calendar or Apple Calendar to cross-reference and intelligently plan future activities based on date and time populated events and past behavior. Marketing Object Intelligence leverages user data including directives with a categorized database of establishments, locations, events, and products, each geotagged and timestamped for precise matching. Proactive Content Matching: Continuously analyzes broadcast and streaming content for sound, text, speech recognition, even using imperceptible audio signals, to deliver media-related topic-driven directive recommendations. Multi-User Aggregation facilitates group planning by combining interests and generating shared itineraries at destination locations. User-Centric Algorithms continuously refine themselves based on user interactions, preferences, and confirmations, enabling the system to evolve and better understand each individual's lifestyle. It avoids scheduling conflicts by recognizing existing commitments, adapting suggestions accordingly (e.g., proposing dessert options following a dinner reservation). This assistant does not just respond to commands, it anticipates needs, adapts, interprets context, and proactively manages schedules, transforming how users interact with their time, media, and surroundings. It marks a significant step forward in consumer AI, bridging lifestyle management with ambient computing. More than a calendar, this orchestration system acts as an ambient computing layer, an invisible assistant shaping the user's daily life. It provides not only reminders and scheduling but also curated experiences that align with a user's values, interests, habits, and surroundings. The AI assistant is constantly aware of the user's location, calendar state, preferences, and social context. It provides curated content and experiences ranging from breakfast suggestions and event recommendations to entertainment alerts and wellness activities, all personalized by time of day, location, and lifestyle profile. This marks a substantial leap beyond existing scheduling tools. The orchestration system functions with a level of autonomy and adaptability that mirrors human judgment, proposing plans after meals, coordinating group travel based on shared tastes, or reminding a user of a nearby interest as they pass by. It bridges digital life and real-world experience, transforming static scheduling into a dynamic, AI-powered proactive lifestyle engine. This technology signifies a meaningful advancement in lifestyle AI. The assistant also incorporates Adaptation to Plans, effectively avoiding scheduling conflicts.

This assistant transcends a simple command-response tool. It actively anticipates needs, adapts to changing circumstances, interprets subtle context, and proactively manages schedules, fundamentally transforming how users interact with their time, media, and surroundings. This marks a significant leap forward in consumer AI, effectively bridging comprehensive lifestyle management with the concept of ambient computing. More than just a calendar, this orchestration system acts as an ambient computing layer—an invisible, ever-present assistant that subtly shapes and enhances the user's daily life. It provides not only reminders and scheduling functionalities but also curates rich, personalized experiences that align deeply with a user's values, interests, habits, and immediate surroundings. The AI assistant is constantly aware of the user's location, their calendar state, their preferences, and their social context. It delivers highly curated content and experiences, all personalized by time of day, location, and lifestyle profile. This represents a substantial leap beyond existing scheduling tools. The orchestration system operates with a level of autonomy and adaptability that mirrors human judgment, proposing plans after meals, expertly coordinating group travel based on shared tastes, or subtly reminding a user of a nearby interest as they pass by. It seamlessly bridges the gap between digital life and real-world experience, transforming static scheduling into a dynamic, AI-powered proactive lifestyle engine, marking a truly meaningful advancement in lifestyle AI. The system further delivers real-time notifications/information to a mobile device. It also provides calendar entries enriched with hyperlinks, media previews, reviews, and geolocation data. Moreover, it can execute tasks/assignments based on user permission or learned behavior, such as sending messages, accepting, or declining invitations, responding to calendar conflicts, initiating purchases, and proactively solving problems with due dates.

### Location Awareness and User Interaction

The user's location is highly relevant, especially for time-sensitive programs or services. A user's location can be provided manually or automatically determined through GPS data, IP trace, or triangulation information. While GPS offers precise data, its signals may be unavailable indoors. IP trace, derived from the user's public IP address, can estimate probable location, and triangulation, utilizing public Wi-Fi access points, can also provide probable coordinates. IP trace data is always obtainable if the device can communicate with the Internet. Implementations utilizing location information prioritize GPS, then triangulation, then IP trace for optimal accuracy. This sophisticated location tracking and prioritization methods enhance the system's ability to provide contextually relevant information and services in real-time, overcoming the technical challenges of location ambiguity and precision that limit conventional location-based applications and significantly improving the user experience by delivering highly localized relevance. This geo-contextual awareness transforms generic content into personally resonant experiences.

The term “service provider” refers to any entity offering a service using this system or methodology, such as an online service provider that manages, creates, and shares a virtual repository. “Consumer,” “customer,” or “client” denotes any individual or entity utilizing the service provider's offerings. “User” or “end user” broadly refers to any individual or entity using the system for managing goods and services or buying goods and services or selling goods and services and sharing a virtual repository, often synonymous with “consumer,” but can also refer to an assistant or agent within the system. A “merchant” is a commercial party that accesses the system to supply data and reward consumers, and can also be a consumer, client, or end-user. A user may also be a building, location, establishment, or an advertiser. Users can create, manage, and share a virtual repository using a computing device and client software. This clarifies the various roles and how different entities interact within the system's ecosystem, enabling a robust, multi-stakeholder platform for personalized commerce that facilitates efficient data exchange and value creation among diverse participants.

Each exemplary computing device within this invention includes a processor, memory, power supply, display, storage, and user input device, along with a communication bus and various network communication components (cellular, WiFi, LAN). For example, a smartphone may incorporate processing units (CPUs, GPUs), RAM, ROM, a power supply, a display controller, a display, a touch digitizer, a camera, and/or a microphone for capturing media. These components can be implemented in hardware, software, or a combination of both, potentially including specialized signal processing or application-specific integrated circuits. The touch digitizer, which comprises a touchscreen, enables direct user interaction through simple or multi-touch gestures. It includes a transparent overlay that senses touch and converts it into electrical properties, which are then interpreted as commands communicated to applications. The display controller detects contact, movement, and the breaking of contact, translating these into interactions with user-interface objects. The visual display itself can utilize various technologies, including LCD, LPD, or LED. The touch digitizer is capable of detecting contact speed, velocity, and acceleration using a range of touch sensing technologies and proximity sensor arrays. These operations are applicable to single or multiple simultaneous contacts, with gestures detected by specific contact patterns like taps or swipes. The detailed description of these hardware components and their integrated capabilities highlights the technical infrastructure supporting the system's advanced user interaction and media processing features, representing a fundamental technological improvement over systems lacking such integrated capabilities for real-time sensing and response, thereby offering a more intuitive and responsive user experience that transcends simple touch-screen interactions.

### Comprehensive Virtual Repository Management System

A system and method based on this invention utilizes a data-populated virtual repository. When a user starts an application on a computing device, they gain access to a suite of functions, including administrative settings, the ability to create new virtual repositories, selection of existing virtual repositories, browse their own and/or other users' shared repositories, and searching for other users' shared repositories. This provides a flexible and comprehensive entry point for users to manage their digital item collections, effectively overcoming the inherent fragmentation and manual effort common in conventional personal inventory management systems.

Administrative functions encompass setting user information and preferences, including login credentials, multi-factor authentication details, personal information, payment information, and preferences for security, display, notifications (acting as user directives), and sound. These robust administrative controls ensure user privacy, security, and highly personalized system behavior, which is a critical improvement over less customizable and less secure conventional systems, addressing the technical problem of data security and user control in integrated digital platforms.

To create a new virtual repository, a user assigns it a name and category, then selects a presentation template (e.g., list, scrolling presentations, navigable 2D/3D models, or augmented reality displays). Item records are created, including images, descriptions, and the context of use. Users can also manage preferences specifically for this new virtual repository. The flexibility in presentation and detailed item record creation facilitates rich and organized digital inventories, addressing the technical problem of static and uncontextualized item management by providing dynamic and interactive organizational tools.

Managing an existing virtual repository allows users to review and edit preferences, modify the repository's name or category, or select and modify individual items. For clothing, a user can select an item for immediate wearing or schedule it for use on a specific date/time or event. Items can also be disposed of (sold, discarded, donated, or given away), which involves either removal from the repository or marking them unavailable for rental. Users can view items and their use history, and modify wearing and scheduling selections. This dynamic management of items and their associated use context goes beyond simple inventory management, offering a proactive lifestyle planning tool that significantly improves upon static asset tracking by integrating future intent and past usage, thereby providing a more comprehensive and anticipatory personal management system.

If a user inputs information about item use, the system can generate a history and frequency of use, calculating the last use and overall frequency. This feature can alert users to unused, infrequently used, or frequently used items, and remind them of items not used within a determined number of days. Knowing specific use dates helps users avoid wearing the same item too frequently. Items can also be modified (e.g., editing content, photos, adding comments on comfort, fit, or accessories). Some notes can be private, while others can be shared. This granular tracking of item usage and proactive reminders represent a technical improvement in personal asset management, addressing the problem of underutilization of resources by providing intelligent insights and nudges to the user, optimizing personal inventory efficiency.

The system incentivizes users to input use dates for items (e.g., via “current use” button, verbal command, or date entry). User location can be tracked via smartphone. Use information tracks items and can lead to rewards. Shared items are visible to other users. Other users can search for items worn by a user at an event, date/time, location, movie, TV show, or public appearance. Upon finding the item, interested users can click to purchase it from a merchant. Through an affiliate program, the merchant can reward the user who shared the item, thereby incentivizing regular use date input, item sharing, and effective presentation of items. This comprehensive system for incentivizing item tracking and sharing creates a dynamic network for product discovery and commerce, providing a technical solution to the problem of efficiently converting user-generated interest into measurable commercial activity.

Disposing of an item encompasses selling, renting, donating, gifting, or discarding it, followed by its removal from the virtual repository (or marking it unavailable for rental). These functions enable users to capitalize on their items. By leveraging item information from the virtual repository, setting a selling price or auction terms, and providing current photographs, an item can be marked for sale, making it searchable and viewable by all other system users for purchase or bidding. Similarly, users can mark an item for donation, receiving a list of willing charities in their vicinity, and a record is generated for tax purposes. Items can also be marked for renting (e.g., ball gowns, tuxedos, skiing apparel), making them searchable and rentable by other users. By providing these sale, donation, and rental functions, the system facilitates capitalizing on items, whether through monetary compensation (sales/rentals) or tax deductions (donations), ensuring items are put to good use. While other systems for selling, leasing, and donating exist, this invention uniquely integrates these functions with an existing virtual repository, which it leverages to identify unused or infrequently used items and streamline their sale, rental, or donation. The automated identification of underutilized assets and the streamlined process for their monetization or charitable disposition represents a novel and valuable technical solution to resource management, extending the utility and lifespan of personal assets.

Actions related to virtual repository items include Browse one's own virtual repositories, selecting a specific repository, and then viewing and selecting an individual item. Users can calendar the item, indicate an intended use date, or offer to sell or rent it, setting terms. Users can view items, including use-related information, and enter comments about comfort, fit, or events where the item was used, or provide endorsements. Users can also locate items in retail establishments to shop for similar items or accessories. This comprehensive set of actions streamlines personal inventory management and shopping, providing a technical improvement over fragmented digital tools that lack integrated lifecycle management for personal assets.

Virtual repositories and items of other users can be shared and browsed. A list of repositories can be generated by a search engine or directory, allowing users to search for specific users' or celebrity repositories, or repositories containing certain items. Users can navigate through categories and subcategories, and filters can be applied to narrow down the list. Once a repository is selected, a list of shared items is presented. Users can view shared calendar information for a selected item, revealing its use history. Users can offer to purchase items from such lists or simply view them. Users can enter comments about shared items and shop for selected items. Purchasing a selected item can lead to a reward for the user who shared it. This dynamic and interconnected Browse and purchasing capability overcomes the technical problem of passive item discovery and limited monetization avenues in conventional digital environments by actively linking social interest with commercial opportunities and rewarding sharing behavior.

Filtering extracts specific data subsets from larger datasets based on various criteria (numerical, text, temporal) to focus on relevant information, remove noise, and streamline analysis. This involves defining precise criteria for the presented dataset. This sophisticated filtering capability is a technical improvement that enhances the usability and relevance of presented information, addressing the problem of information overload in large data repositories by providing targeted and manageable data views.

An affiliate program tracks click-throughs to merchant sites, enabling commission payments to the user who shared the item that led to a purchase. An affiliate link, associated with each shared item, carries information identifying the click-through source. When clicked, a cookie is deposited on the user's device. Upon sale completion on the merchant's site, the merchant checks for this cookie to attribute commissions to the sharing user. Merchants have the flexibility to set their own commission structures and cookie lifetimes. This integrated affiliate system provides a novel technical solution for monetizing user-generated content and shared interests, directly benefiting users and merchants by converting social engagement into measurable commercial activity and establishing a new, efficient revenue stream for content creators and influencers, addressing a long-standing challenge in media and advertising industries where converting immediate interest into sales has been notoriously difficult.

Virtual repositories can be modified. Selected items can be modified (editing content, photos) or deleted. Items can be automatically deleted if sold or donated through the system, or manually by the repository owner. Items can be added manually by user input (typed commands, uploaded files, email, scanned documents via Optical Character Recognition (OCR), verbal commands). They can also be added from third-party sources like online retailer and marketplace accounts or merchant point-of-sale system data. Participating merchants can push, or a user can pull, purchase data via an API. Even brick-and-mortar purchase data is stored on merchant servers. This comprehensive approach to populating and maintaining the virtual repository from diverse sources, including automated and manual inputs, represents a technical improvement over fragmented inventory systems that often require tedious manual data entry and lack real-time integration capabilities.

Items can also be added manually or via applications (plugins, portals, add-ons) that use artificial intelligence to monitor user browser activity and emails for purchase data. Browser plugins can track online purchasing, detecting purchases via websites, AI, and user selections. Emails can provide order confirmations with hyperlinks to remote accounts, or detailed receipts, which can be uploaded for OCR processing. Data from non-manual sources is cached until verified by the user. Cached data can be displayed in lists or stored as collections. The system merges data from various remote and local sources into a cached list for potential addition to the virtual repository. Users verify, modify, or delete records before entry. This automated and intelligent data ingestion from various digital touchpoints, followed by user verification, provides a robust technical solution for creating comprehensive and accurate personal inventories, overcoming the practical challenges of manual data entry and disparate data sources that plague existing systems. The system's ability to automatically gather and curate digital records of physical purchases significantly improves personal asset management efficiency and accuracy.

### Real-Time Object Matching and Media Processing

A user device, such as a smartphone, typically features a touchscreen and microphone, and may also include a camera. A graphical user interface on the touchscreen presents a trigger control. Touching this control activates the trigger operation, initiating the method described below. Thus, a virtual repository can be populated with records of objects used at events, by people, in shows, movies, public settings, or elsewhere. Users input data for these objects, facilitating sharing, publicity, sales, and affiliate program rewards. While searching and navigating publicly accessible virtual repository records is possible, the matching engine enables automatic matching of an observed object with an exact record in the virtual repository, regardless of whether the object was perceived in public, at an event, in a concert, a broadcast, a streamed show, a movie, or elsewhere. This seamless, automated real-time object identification and matching represents a significant technical advancement, overcoming the limitations of manual or imprecise visual search tools that fail to provide immediate, actionable results from real-world observations and dynamic media content, thereby revolutionizing how users interact with their environment for product discovery.

With the virtual repository created and populated with data, including records corresponding to objects used in programs or advertisements, it can be queried. A consumer using an application on a portable computing device selects a trigger. This trigger creates a Percipient Sample Pack (PSP) containing user identification, location information, time information, and captured media (recorded audio and/or video and/or photo and/or advertisement of a target). The application can be configured to capture audio or video, or allow user selection. The target can be a television program, streamed program, or content from another source. The captured media specifically represents a portion of interest to the user, who might be interested in participants, their attire, or particular objects within the media. Captured audio is often preferred due to its lower bandwidth requirements and less sensitivity to factors like line of sight or lighting conditions compared to video. The creation of a PSP, a structured data pack that captures multimodal sensory input in real-time and associates it with user context, is a novel technical solution to the problem of efficiently capturing ephemeral user interest in dynamic media environments, which is a major technical hurdle for interactive content experiences. This goes beyond simple data collection; it is a dynamic packaging of contextual information that enables subsequent intelligent processing at an unprecedented level of detail.

The smartphone application then transmits the PSP to a remote computing system, which includes a media identification module (matching engine) composed of one or more computer programs. This matching engine processes the PSP or its captured media to determine if it contains a watermark and/or to generate a fingerprint of the captured media. When the captured media is video or an advertisement, it may be cropped to eliminate extraneous elements outside the broadcast or streamed video of interest. Fingerprinting will then focus exclusively on the relevant recorded segment. This invention supports various cropping methodologies, such as detecting regions of interest from contiguous frame comparisons. Similar cropping techniques can be applied to reference fingerprint databases. The integration of media cropping directly into the fingerprinting pipeline significantly improves the accuracy and efficiency of content identification by minimizing irrelevant data, representing a technical improvement over less refined methods that may struggle with extraneous visual information or environmental clutter. This selective processing ensures that only the most pertinent information is used for matching, optimizing system resources and reducing computational load.

A watermark, which is an imperceptible audio signal embedded within a program's audio or video, can be utilized to track content distribution from its origin to its destination. This is achieved by inserting a unique content identification code at a distribution center. This code can be transmitted by modulating carrier wave signals, such as inaudible sounds. Demodulating the appropriate frequency range of captured sounds provides the code. If a watermark is detected, it is demodulated to extract the modulated information. The program can then be identified from a database that relates known watermarks to specific programs, often providing a precise timing component. Live broadcasts and streamed content can incorporate watermarks to enable precise tracking. The use of watermarks provides a robust and efficient mechanism for content identification, improving upon less reliable methods that might be affected by signal degradation or external noise, ensuring reliable and precise content matching. This offers a higher degree of reliability for content creators and distributors, reducing errors common in less robust content tracking systems.

A local database of program fingerprints stores unique digital signatures that correspond to various programs, with each program potentially having multiple fingerprints for different segments. The same method used for generating these database fingerprints is applied to generate a fingerprint for the captured media in the PSP. This newly generated fingerprint is then compared with the database fingerprints to find a match, thereby revealing the program and its corresponding portion. A fingerprint is a unique proxy or signature generated from the characteristics of the captured media, compared to a set of reference fingerprints. When a substantial match is found, the program and its specific portion can be identified with high probability. The system is not limited to a specific fingerprint methodology, only one that efficiently generates unique fingerprints for captured media and program segments. Similarity searching, using a distance function, can be employed to find “similar” objects. This advanced fingerprint generation and similarity searching process addresses the technical problem of accurately identifying specific ephemeral content segments from noisy or partial user-captured media, a significant challenge in conventional content recognition systems that often yield inaccurate or irrelevant results, thus improving the overall precision and utility of content matching for interactive applications.

An exemplary audio fingerprinting method converts an audio signal into a sequence of relevant features. This process involves preprocessing, framing, applying a linear transformation (e.g., Fast Fourier Transform (FFT) or Discrete Cosine Transform (DCT)) to reduce data redundancy, and performing feature extraction (e.g., Mel-Frequency Cepstrum Coefficients (MFCC) or Spectral Flatness Measure (SFM)) to reduce dimensionality and increase invariance to distortions. Other music information retrieval features like harmonicity, bandwidth, loudness, and zero-crossing rates can also be utilized. High-order time derivatives can be added for temporal variations, and low-resolution quantization for robustness. The initial steps result in a sequence of feature vectors per frame. The fingerprint is then modeled (e.g., summarizing multidimensional vector sequences into a single vector, such as 16 filtered energies for 30 seconds of audio, resulting in a-bit signature). This approach is computationally efficient and produces compact fingerprints, which can also be sequences of features. Feature vectors can also be clustered for compact representation. This sophisticated audio fingerprinting algorithm efficiently solves the technical problem of robust and quick audio content identification, even amidst varying acoustic conditions and background noise, providing a tangible improvement over less resilient recognition methods that often struggle with real-world audio complexities and environmental interference.

Video fingerprinting involves capturing video, transforming it into a domain invariant under geometric operations (e.g., Radon transform, Fourier Mellin Transform, ResNET50, OpenAI), and extracting robust features. This process can include temporal and spatial downsampling, cropping sub-images, and low-pass filtering. Video fingerprinting aims to derive a small number of pertinent features (fingerprints) from video clips to identify video queries by measuring the distance between a query fingerprint and database fingerprints. Feature extraction can involve global features (e.g., color histogram) or local features (e.g., interest point detectors like Harris) for robustness against rescaling, cropping, logos, or picture-in-picture effects. Extracting features both spatially and temporally makes fingerprints more discriminative. For image, video, facial, or object processing, multiple companies' models (e.g., CNNs, ResNet50, EfficientNet, Vision Transformers) can be integrated. As an example, an input video clip can be converted to grayscale, resized, and local regions detected. Fingerprints or watermarks can also be created or digitized by detecting color patterns, item patterns, shadows, brightness, contrast, speed of changes, wavelengths, frequencies, and distances between participants or objects from the captured media or program. Fingerprints and watermarks can be created using a combination of one or more detections from the video recording or captured media. This multi-faceted approach to video fingerprinting produces highly robust and discriminative features, which technically solves the problem of accurately identifying specific visual content in dynamic media, even with various visual alterations, thereby surpassing the capabilities of prior art that struggle with complex visual environments and ensuring reliable content identification in real-time.

The matching engine then transmits user identification and program information to the Virtual Repository Matching Module (VRM), where a video or audio fingerprint becomes available for searching. Video fingerprinting specifically relates to faces, objects, text, scenes, and codes found in media information, while audio fingerprinting focuses on speech, voices, and composite sounds. The primary objective is to find a precise match between the captured media's fingerprint and a segment of a program's fingerprint stored in the database, using suitable searching techniques and distance metrics. The most likely reference in the database, which is the virtual repository, is then selected. In instances where the PSP detects more than one match, these are presented to the user, who can then select the program they are currently watching to view associated users, items, and/or services. To efficiently compare captured audio fingerprints against millions of others, advanced techniques like indexing or computational biology heuristics can be applied to generate candidate reference audio fingerprints for efficient exhaustive searching. This highly efficient and accurate matching engine, combining multimodal recognition with advanced searching techniques, provides an inventive concept that significantly improves upon conventional, less integrated content identification systems by reducing processing time and improving accuracy in real-time environments, which is crucial for delivering timely and relevant results.

After a program and its specific segment are identified, another database is consulted to determine participants or item records, particularly those associated with the captured portion. This participant and/or item database establishes relationships between participants and specific programs and scenes. Once participants are identified, the virtual repository can be queried. The VRM then searches a database or repository for records of participants (who are also virtual repository users) or items that appeared in the captured media, linking them to the identified program and its specific portion. This process identifies shared records of items, such as an actor's attire or an object used in a scene, often retrieved from a production company's virtual repository. The technical solution offered by the VRM in precisely linking detected media content to specific virtual repository items owned by individuals or production companies solves the practical problem of efficiently bridging ephemeral user interest in media content with actionable commercial opportunities, a capability missing from prior art solutions, enabling real-time monetization of content directly from its appearance.

In the current invention, a system and method that provides a functional response from a triggered target is needed. A target is a person, place, information, image, or thing of interest. A trigger should be generated by interacting with a target, such as by photographing or recording (e.g. video camera) a target or an identifier (e.g., 1-D or 2-D barcodes, electromagnetic device, QR code) for the target, recording (audio and/or video and/or location data and/or event data and/or image and/or object) a target or an identifier for the target, selecting a target, or activating a control while a target is present. A trigger should include data that includes information to identify the target and to identify the user who generated the trigger. A trigger associated with a target may carry out or generate a functional response including an assignment or task for a computing system to create materials, advertisements, certificates, cards, garments, or any type of item record with information related to the image data, video data, audio data, speech data, voice data, location data, user, participant, or a combination thereof. A first trigger is received on the computing system, which includes a programmed computer, from a first computing device of a first user. The first trigger requests information associated with at least one virtual repository of the plurality of virtual repositories. Results are sent from the computing system to the first computing device. The results including links to at least one virtual repository of the plurality of virtual repositories in response to the trigger. All notifications may be associated with a link. Using an application on a portable computing device or computing device such as a smartphone or smart TV, a consumer generates a trigger. The exemplary method accepts various triggers. A trigger requests information or creates information or marketing objects associated with a target. A target may be a location, a product, media, an event, gaming, an image, a face, a video, a marketing object, a confirmed schedule or reservation, a logo, a scene, a time code, a touch sensor (finger or cursor), biometric, pattern, voice, speaker, speech, text, typing, audio or sound, and a bounding box. The target is associated with at least one virtual repository of the plurality of virtual repositories. The target may be a user, person, group of people, place, video, audio, advertisement, image, event, location, or thing. A plane or train flight booking or confirmation trigger requests marketing objects and information from a virtual repository associated with events, restaurants, adventures, celebrities, or things to do at your traveling location, arrival city, or destination. An event trigger requests virtual repository information for one or more users or item records appearing at a scheduled event. A location trigger requests information for or from one or more users at the same location (which includes the vicinity and/or a physical street address) of the location of the first user who submitted the trigger or a second user or a second user item record or marketing object. A location trigger may also request information associated with your traveling locations or as your location changes. This location trigger request may be automated. A media trigger contains an image, video, video trigger, or sound recording, from which a user's identity is determined via facial, speaker recognition, time code, or temporal data recognition. A media trigger may be a photograph trigger, a voice trigger, location trigger, a speech trigger, a recorded audio trigger or a recorded video trigger or a time code trigger or a combination thereof. A time code trigger may work in combination with a touch sensor or touch digitizer trigger (e.g. Finger). A media trigger includes captured media. Media may be advertisement (ex. Billboard, Out of Home (OOH), social media ads, or digital advertisement), movies, tv series, tv shows, live broadcast, or recorded broadcast, users, celebrities or any image, content, a photograph, or video. Billboard advertisements or ads may be recognized using voice commands or scanning (ex. Photo or video recording) in this invention. Advertisement may be a video or image or item record. Within this invention, advertisement may be the same as products and services or associated with products or services. When a user triggers by voice commands using directives or questions, advertisements may also be identified with or without scanning or recording. The spoken words from a voice command may be associated with videos, images, sound, words, art, text, logos, participants, or marketing objects appearing or heard on the advertisement or associated with the advertisement and/or commercial ad uploaded or added to the repository or database. Spoken words from a voice command may also be associated with advertisement, marketing objects, art, participants, text, logos, words, videos, images, or sound appearing or heard on the advertisement and/or associated with a query search on the internet and may include a search with a web crawler. In this invention, a query search may be in combination of search a database, repository and internet including a web crawler. A computing system in this invention may understand meaning or comprehension when a user triggers by voice commands using directives and questions. A product trigger identifies a product and seeks links corresponding to the product. A directive trigger includes a condition, which, when satisfied, causes the computing system to send results that include responsive details. Various fields or collections of data may be associated with each directive, including a unique identifier (id) for the record of a user, a time of generation, an account (e.g., user account) associated with the notification, a subject for the directive, a category for the directive, each subcategory for the directive, a product or service identification for the directive, location information for the directive, and timing information for the directive. Data for each session may include a session identification, time information such as a start and end time, media type (e.g. advertisement, TV show) associated with the advertisement or product placement, an account (e.g., user account) associated with the session, an identification for the subject matter displayed, and information regarding friends that supplied or received data during the session. Session information may be shared among friends to allow friends to view the same display. During a session, a user may view one or more products, such as goods, services, or events. An item record may include various fields or collections of associated data, including a unique product identification, a time added to the database, a category and one or more descriptive subcategories, such as, for example, gender, color and brand information, scene information, location information, title, an image or pictogram, a link (e.g., hyperlink), and a description. For each display, such as a slide-by display, a unique identifier, time information, categories and subcategories, and product identifications may be stored. Thus, information for a user to replicate a particular display is stored and made available for communication to third parties. The information includes information regarding the session, the products displayed and the categories and subcategories covered. A unique identifier can be associated with each user. The identifier may be assigned at the time the user registers. A unique ID may be a user registration number or username created at sign-up. Similar to a consumer loyalty card account number, the identifier may be utilized at compatibly equipped points of sale, whether brick and mortar or online, to apply coupons. To be compatibly equipped, the point of sale must be configured to transmit data to and receive data from a system according to principles of the present invention. A user may be required to enter a PIN or password or biometrics authentication at checkout to authorize the transaction. The identifier may be stored on a magnetic stripe, as a scannable/readable barcode, as a numerical code, electronically in a smart card, or on the display screen of a mobile computing device, or in a wirelessly communicated signal, or in a data packet communicated via network communication. The identifier not only identifies the user, but may also identify the system. To solve one or more of the problems set forth above, in an exemplary implementation of the invention, a computer-implemented method of managing a virtual repository system includes providing on a computing system a plurality of virtual repositories. Each virtual repository is assigned to a user. Each virtual repository includes item records for items owned, used, and/or created by the user. A trigger may trigger to create. Create is creation in real-time associated to media or media event triggered by directive. For example, creating a celebrity baseball card in real-time when watching a baseball game the exact time a homerun was hit by a player. Owning the moment means a user could trigger the tv in real-time to capture the image associated with the moment (e.g. Segment in time, scene information) the homerun ball was hit that is associated with the player or athlete and the exact game the user is watching. The trigger will create the card or generate the card in real-time from one or more computing devices at the event location (using a location trigger-location information) capturing the media and moment in real-time. Each computing device is equipped with a camera for photographing and video recording. A first trigger is received on the computing system, which includes a programmed computer, from the first computing device of a first user. The first trigger requests and/or process information associated with at least one virtual repository of the plurality of virtual repositories or database. Results are sent from the computing system to the first computing device. The results include one or more links to at least one virtual repository of the plurality of virtual repositories in response to the trigger. The exemplary method accepts various triggers. A target trigger requests information associated with at least one virtual repository of the plurality of virtual repositories assigned to an identified user, individual or person. An event trigger requests virtual repository information from and for one or more users appearing at a scheduled event. A location trigger requests information from and for one or more users at the same location (which includes the vicinity) as the location of the first user who submitted the trigger. A user may be an establishment, merchant, participant, or building associated with source data associated with a database within the computing system. A trigger may be system generated. User and/or marketing object location trigger a system generated trigger associated to user data. A media trigger contains or may request information associated with an image, face, object, scene, video, location, video data, event data, text, timestamp, time value, time code, a QR Code, Multi-dimensional QR Code, invisible QR Code, transparent QR Code, temporal data, sound recording and repository information, from which a user's identity is determined via facial recognition, video recognition, sound recognition, pattern recognition, object recognition, scene recognition, text recognition, image recognition, time code recognition, timestamp recognition, voice recognition, audio recognition, optical character recognition, speaker recognition, temporal data recognition, and a combination thereof. A product trigger identifies a product and seeks links to users and/or virtual repositories that contain item records, marketing objects, matching objects, that corresponds to the product or game, gaming, or betting platform. A directive trigger includes a condition, an instruction, functions, which, when satisfied, causes the computing system to send results that may include active communication and responsive details. A text message trigger includes messages that trigger key words from a computing device that are keywords in the repository that match item records and marketing objects that works with the principles of the invention. These item records may be delivered to a user interface during a text. Phrases may also be triggered. Various triggers also include a time code trigger. A time code trigger may trigger or initiate time code recognition or trigger item record identification. Trigger item record identification initiates and/or identifies temporal data, a location, a voice, a speech, a timeframe, a timestamp, time value, time code or time code trigger and/or time code recognition associated to item records. A time code trigger, time value, timeframe, or time code recognition identifies all item records, media file, video data, user data, audio data, in real-time during a recording, streaming, or broadcast that correlates a time code of a program, broadcast, video, media, or audio time code with a time code associated with item records in a virtual repository or database. If the time code, time value, or timestamp on the video, broadcast, program, media, or audio matches the time code, time value, or timestamp in the virtual repository or database of a user, then all item records associated with that time code or timestamp is a match and will be sent as results to the computing device of the first trigger user. Therefore, all item records in a scene, media, video, audio, program, or broadcast do not have to be identified through other recognition technologies for the user to be sent the results of all item records in a scene, audio, media, or video. A confidence score does not have to be perfect. In this technological advancement, one example of time code recognition or temporal data recognition, only a user's top (or any trigger or a combination thereof) may be identified or generated through, but not limited to, object, video, audio, image, facial, scene, or sound recognition on a video or audio associated to a time code, timeframe, time value, or timestamp, to identify the user's shoes and pants if all three item records are associated to the same time code, time value, or timestamp of the same virtual repository. All time codes may be correlated to objects or item records. A time code trigger and/or time code recognition may also be associated with Temporal Data, Temporal Data Recognition, Multi-Recognition Technology, or Temporal Data Matching Engine. Temporal Data Matching Engine may also be referred to as Temporal Data Recognition. In this invention, temporal databases and virtual repositories stores data relating to time instances or time. It offers temporal data types and stores information related to the past, present, and future time. Temporal databases can be uni-temporal, bi-temporal, or tri-temporal. In this invention, temporal data identifies accuracy of data to make sure item records shown or heard on media matches the trigger time to determine what media program the viewer is watching or listening to, and temporal data identifies accuracy of the data to make sure item records matches the media file with time code in database or virtual repository at the time of the first trigger, and matches time the user who generated the trigger to determine who is the viewer, listener, and/or seller, and matches the time code of the results sent to the user. A time code trigger or/and time code recognition may be system generated, continuous, or ongoing throughout one or more programs, and may display or deliver item record results continuously to one or more user interfaces or computing devices from one or more virtual repositories via directives, user voice commands, system generated recommendations, a video or audio pause, a touch sensor or digitizer (e.g. finger on in-video mobile screen on smart phone or Smart TV) on the user interface of any image or object shown on video, or when an marketing object is heard on audio. Scrolling Chronological newsfeed of marketing objects timestamped in a repository associated with a video or audio program may display in sequence according to time duration of the video or audio program by timecode. Displaying marketing objects timestamped in a repository associated with a video or audio program may be automated to display in sequence according to time duration of the video or audio program by timecode. Synchronization between a smart TV program and a smartphone, a tv program and a TV remote control, a TV program and a smartphone streaming program and a smartphone streaming program and a user interface display on a smartphone can be synced to execute the invention by automatic content recognition, fingerprints, watermark signals, video or audio signals, Bluetooth technology, Wi-Fi technology, mirror casting, Touchscreen technology, data packets, IP-based datacasting, ATSC 3.0 (NextGen TV) technology (Advanced Television Systems Committee) or a combination thereof. ATSC technology has played a key role in the transition from analog to digital broadcasting. It enables the use of an analog audio subcarrier in addition to the digital signal. A TV remote control button or a cursor may be used to initiate the trigger. A remote control may be the same as a computing digital device. User Interface may include an overlay on a visual display. In this technological advancement to determine exact identical matching, item records associated with “TV, Video, advertisement, a location, or Audio Program” are systematically populated in virtual repository that are associated with a media file of one or more users (example: Merchants, actors, producers) of owned or used item records that are specifically being used in that “Program”. When recognition technology is generated, analyzed, and processed, the queries or technology does not need to search the entire internet or visual database looking for the “Black Shirt” for example, worn by Tom Cruise in the movie mission impossible to return a bunch or maybes or possibilities. The technology or system only has to search the specific database or virtual repository associated to that specific media file, media ID and/or program associated to the specific time code, timeframe, or time value when a trigger action was generated (e.g. program pause, voice, recording, speech, touch, click etc.). Since the “Black Shirt” item record in the virtual repository are synchronized up with video data at the identical time Tom Cruise was wearing the “Black Shirt” in the program Mission Impossible, during a trigger, the exact matching item “Black Shirt” is identified, instantly. For Example, (Color—All Black Shirt, Category—Shirt, Gender—Men, Brand—Calvin Klien, Size xl, ShortSleeve, Price—$98) In other use of recognition technology, like Google Lens, it's almost impossible to know the exact product details and attributes of a “Black Shirt”, because an “All Black Shirt” will return many possibilities and maybe of a “All Black Shirt”, but it can't return the exact or identical “Black Shirt”. Managing the media file of a program and item records used in the program is the technological advancement of recognizing identical record items from any program or any computing device where the technology is applied or integrated. Temporal Data Recognition, the combination of one or more recognition technologies (also referred to as multi-authentication recognition) being generated at once with time code recognition associated with triggers and managed media files associated with a virtual repository, creates the 100% identical match that Tom Cruise was wearing the “Black Shirt” in the exact scene or scenes. To double down on the technological advancement, the current invention eliminates the need to search. Information about things, people, or places you see on programs or in-person, can be identified through triggers and delivered to your user-interface, without searching or browsing the internet. If the time code, time value, or timestamp on the video, broadcast, program, media, or audio matches the time code, time value, or timestamp in the virtual repository or database of a user, then all item records associated with that time code or timestamp is a match and will be sent as results to the computing device of the first trigger user. Therefore, all item records in a scene, media, video, audio, program, or broadcast do not have to be identified through other recognition technologies for the user to be sent the results of all item records in a scene, audio, media, or video. A confidence score does not have to be perfect. In this technological advancement, one example of time code recognition, only a user's top (or any trigger or a combination thereof) may be identified or generated through, but not limited to, object, image, facial, or sound recognition on a video associated to a time code, time value, or timestamp, to identify the user's shoes and pants if all three item records are associated to the same time code, time value, or timestamp of the same virtual repository. Other technologies only identify one item at a time. A system generated recommendation or suggestion to a user via a virtual repository or database may also be triggered or initiated by a trigger or time code trigger. A Smart TV when triggered, may be synchronized to a user smartphone to deliver results to a user mobile smart phone or user interface. A gaming trigger identifies a sequence of events throughout a scene, program, TV show, movie, TV series, or event or time code related to marketing objects, and item records that are associated to video data that queries questions or betting options, including systematically created or generated questions or betting options using artificial intelligence that corelates to temporal data within a repository. These questions or betting options are sent to a user interface, smart TV, or digital device for user interaction. Compensation for gaming winnings may result in rewards not limited to monetary compensation, points, and gifts. User data associated with programs may also be computer or system generated on the fly or stored in a database or virtual repository to correlate to triggers. In all cases, displayed results may be filtered and sorted by the user or system. All results contain one or more item records, marketing objects, objects, matching objects, notifications, and links or a combination thereof. Item records include consumer product goods and semantic information.

Within the invention, ATSC 3.0 (NextGen TV) allows the transmission of application data, metadata, and triggers alongside audio/video content via IP-based datacasting. Traditional television shopping experiences are limited, requiring user initiation (e.g., commercial breaks or external apps). There exists an opportunity within the invention to use real-time content analysis and broadcast-injected metadata to surface non-intrusive, contextually relevant, shoppable moments to the viewer. A system and method that uses broadcast datacasting under ATSC 3.0 to inject real-time metadata into the broadcast stream. The metadata includes triggers for potential shoppable moments tied to visual or narrative content. A receiver device (TV, mobile app, or companion signage) analyzes both content and metadata to selectively surface personalized, relevant shopping prompts to the user in a non-disruptive way. The system intelligently filters and prioritizes shoppable moments based on content recognition, user preference, and location data.

Datacast Metadata Injection Engine-Embeds lightweight metadata packets (e.g., scene ID, object ID, timestamp, context label, shopping link) into the ATSC 3.0 datastream. Packets are time-synced to video frames and geo-tagged if necessary.

Local Shoppable Trigger Agent-Runs on the receiving device (TV or second-screen device). Continuously listens for datacast packets. Matches content being displayed with a database of shoppable opportunities.

Intelligent filtering algorithm-Personalizes which shoppable moments to surface based on: Viewer history/preferences, Context (e.g., genre, sentiment, pacing), Environmental factors (e.g., time of day, regional inventory availability), Prioritizes moments so only the most relevant items are shown, reducing ad fatigue.

Seamless UX Surfacing Mechanism: Surfaces lightweight, non-interruptive shoppable prompts: Pop-ups, QR codes, Companion app synchronizes, Ensures broadcast viewing experience is not degraded.

Integrated Purchase or Calendar Action: Direct purchase path, or save for later’ option that places the event/product into a calendar, wish list, or reminder queue tied to user identity.

Novelty/Differentiators: Context-Awareness: Not all products are surfaced-only those dynamically aligned with scene or narrative. Intelligent Surfacing: Prioritization engine avoids user overwhelm. Seamless ATSC 3.0 Integration: Works within the ATSC 3.0 broadcast-broadband hybrid environment without needing broadband fallback for every action. Multi-Screen Coordination: Syncs across TV, signage, and mobile experiences. Adaptive Rendering: Different UX options depending on device capabilities.

Example Use Case (Summary): While watching a drama series over an ATSC 3.0-enabled broadcast, a stylish handbag carried by the lead actress triggers a low-profile on-screen overlay offering a link to purchase it locally or online, without interrupting the show.

In another aspect of an exemplary implementation of the invention, a user may add or submit a media file to a repository. A submission of a file may be an upload of a file from a user computing device. An addition of a media file may be a file created within the centralized system to create a repository or add to a repository. A user page contains fields in which media file information may populate or be added to. The media file may include a written or voice script of a program. A script is a written document that serves as a guide for the production of audiovisual work such as a movie, tv series, broadcast, or event. The media file may be a file not limited to a document, excel spreadsheet, pdf file, wave file, mp4 file, mov file, xml file, csv file, FTP file. A file may be a data feed. A media file may be a script. A script may be a marketing object. A program may be an advertisement. Each marketing object, video or audio file may be analyzed, processed, fingerprinted and scripted to a unique text file, collections, or fields (e.g. closed captioning) using artificial intelligence, and/or speech recognition, and/or natural language processing and stored or recorded in a user repository or database associated with a program (e.g. TV show, movie, TV series, podcast, radio show, program title, TV guide information, program details, event, user details) in which it was scripted from. Each media, video or audio file that is scripted and/or fingerprinted may also go through machine learning training including semantic intelligence for understanding, interpretation, and interactions with user communication and voice command subject matter directives associated with a script. A file may also contain and/or obtain program details associated with marketing object details not limited to a media id, media type, product type (e.g. shirt, lamp, beverage) scene information, products each participant or cast member is wearing, advertisement details, product placement details, services, URL hyperlinks, retail store and brand information, source information, personal or business information, image hyperlinks, hyperlinks, dates, time, bios, profile pic hyperlinks, product description, pricing information, sizes of products, colors of products, an physical address, longitude and latitude GPS coordinates, location information, discounts, and promo codes. A media file submitted or added via a user portal to a user repository within the centralized system by a user, may be systematically categorized and populated through a triggered automation by an AI assistant (e.g. Artificial Intelligence) for user marketing object navigation and approval within an Information, advertisement, and product placement system (e.g. service provider and/or sales system, SaaS system, associated with user repository). The information, advertisement, and product placement system may also be referred as a “IAPP system” within the invention. An IAPP system is associated with a computing device. An IAPP system is associated with marketing objects of media files and items of retailers or brands or other information or marketing object providers. An IAPP system is basically a virtual repository with user controls for navigation functionality to control, change, or populate a database. An IAPP system includes a user interface via a portal and user account that allows a merchant user to sell, advertise, or push marketing objects to other consumer users seeking information or triggering media. The merchant user is allowed to navigate through its repository not limited to viewing, clicking, making changes, modifications, deletions, additions, sharing, declining, and approvals of populated fields of the media file submission or addition. Datafeeds via a file or API related to marketing objects from third party stores or sources may be associated with IAPP marketing objects associated with a program or media. Each IAPP system will have user permissions and user calendar options. Each IAPP system may have a unit limit number, an expiration date for marketing objects or a media file, start and ending dates of advertisement placement or information placement. An IAPP system allows any user to receive marketing objects associated with any program or media described within the invention. Once a user's IAPP system is populated with marketing objects and approved by a user, any user may trigger the media or programs approved within the IAPP system to receive marketing objects via their user interface on their computing device. In regard to a user subject matter voice command directive trigger, an AI assistant via an Interactive Voice Response (IVR) system and Automatic Speech Recognition (ASR) system may be used to analyze, understand, and interpret the subject matter spoken words so the system can respond appropriately. The AI assistant may analyze, understand, and interpret the subject matter voice command directives or spoken words and match it up against a matching sequence of words in a script associated with marketing objects of a scene or media file, match it up against keywords within a media file associated with marketing objects related to a scene of a script or program or repository or match it up against keywords only or match it up against subject matter voice commands associated with marketing objects and marketing objects not spoken in the voice command directive but is from the same scene though association. Both marketing objects related to the subject matter voice commands and marketing objects not spoken in the voice command, but are identified with the same scene through association, may both be associated with the same media file of a IAPP system or one or more virtual repositories of an IAPP system. One or more marketing objects within a media file and/or IAPP system may corelate, associate, or work in conjunction to each other to accomplish a goal and/or satisfy a directive when analyzed, understood, and interpreted by an AI assistant. For example, a user may be watching a movie called “Mother” and would like to know the red dress Jennifer Lopez is wearing right now and want the AI assistant to make the purchase for them. For a user to accomplish this, a user may use a subject matter voice command directive trigger “Hey SlinkIt (e.g. Wake call), can you tell me information about the “red dress” “Jennifer Lopez” is wearing in the movie “Mother” on “ABC Network” right now? The AI assistant may first analyze the entire directive to interpret the meaning of the directive and/or the subject matter actress or character name Jennifer Lopez, the red dress, the movie name “Mother” and the TV Network ABC and perform a search to determine if Jennifer Lopez is currently TV by search a TV guide associated with the IAPP system or virtual repository to determine a matching objects and a channel the user is watching, if her name isn't identified on TV right now, the AI assistant may send a message to the user that the item couldn't be found or search other networks like Netflix or Hulu for network identification, but if one or more words of the subject matter is identified to determine a match, then the AI assistant will determine a match and identify the marketing objects including the “Red Dress” associated the subject matter Jennifer Lopez, ABC, and the Movie “Mother” in the repository or IAPP system and send the red dress product details including a link to the user who initiated the voice command via a user interface on a computing device. The AI assistant via voice response may communicate back to the user with an interactive voice response the product details about the red dress including the brand name, retail information, pricing, possible discounts, a location, and store name to purchase in-person. The AI assistant may proceed with asking the user if the user wants the AI assistant to purchase the red dress for them. If told to proceed with a purchase, the AI assistant may continue with more conversation or interaction to determine size, color, and shipping address and method of payment via a user mannequin, or sizes pre-set in the repository for a user (e.g. User Account). The AI assistant may even apply discounts. The AI assistant may then continue with a complete purchase or transaction process including using user authentication and authorization via verbal code, voice biometrics/recognition, eyes, face biometrics, handprint, or fingerprint biometrics. User authentication and authorization may be required and initiated. All other marketing objects associated with a scene or scenes that are associated with the red dress, may also be presented or displayed to a user via a user interface on a computing device from the same voice command trigger. A user may also tell the AI assistant to just save the red dress (e.g. marketing object) for viewing later using the same subject matter voice command directive but adding the spoken word or utterance “Save” to the command. Voice command may enable voice control. Where the user may control a system via voice spoken words and/or speech recognition. Voice Commerce may be term used to access any third-party application or website through voice command subject matter directives to seek product or services and authorize a payment from media. As for an advertisement or information associated with people, places, or things as it pertains to a user subject matter voice command directive trigger, the AI assistant may analyze, understand, and interpret the subject matter voice command directive trigger, a location of the advertiser and the user that initiated the subject matter voice command to identify the marketing objects associated with the advertisement or information. User voice authentication and keywords or a code may be used as a key to authenticate a user and authorize the payment or transaction of a marketing item record via third party online stores or companies or data feeds associated with marketing objects within the centralized system or IAPP system.

In one embodiment, an exemplary computer-implemented method of managing a virtual repository includes a step of a user, via a user computing device, creating a virtual repository. The virtual repository includes a virtual repository, media file or media identification or media. The term “Media” or “Media file” or Media Information in this invention may contain one or more of the following: video data, media identification, image data, audio data, sound data, speaker data, speech data, face data, scene data, text data, event data, location data, time data, gaming data, user data, digital data, data feeds, and media information associated with TV shows, Movies, TV Series, advertisement, TV Ads, sporting events, streaming programs, podcast, celebrities, influencers, social media, establishments, and other users including item records and objects or a combination thereof. The term or word “Media” may have the same meaning as “Media file” or “Media information” in this current invention or vice versa. A “Media File, Media, and Media information may also contain a traffic system. A traffic system may be associated to an as-run log. A traffic system is used to log or store every TV AD Commercial at a TV station, streaming company, or TV network and keep a record on when they should be played throughout an hour, day, week, month etc. and an as-run log does reconciliation after airing to determined what was missed and re-slot it. A traffic system or “Traffic” is the scheduling of program material, specifically advertisement. Item Records associated to a traffic system of a media file may be identified through a time code, time code trigger, Temporal Data Recognition, and time code recognition. A programmed system obtains, on a server, via network communication, item records from a plurality of third party sources including merchants or other users selling items from a secondary market, the item records being records of items (e.g., clothes, furniture, users, program information, product details, gaming data, service details, video data, event data, sound data, objects, matching objects, marketing objects, etc. . . . ) acquired by the user. The programmed system collates the obtained item records. At this point the item records are merged into a structured form, such as a table or list or database. Item records may have the same meaning as, or associated with, marketing objects, matching objects, items, video data, sound data, users, consumers, clients, persons, individuals, objects, marketing directives, and vice versa. The step of the programmed system collating the obtained item records entails extracting data from the obtained item records (e.g., identifying and storing data for the fields of each item record) and merging obtained item records into a table, each item record comprising a plurality of fields or collections. The programmed system stores the collated obtained item records in a cache (i.e., a temporary storage). The programmed system presents to the user the collated obtained item records stored in the cache. This gives the user a chance to validate (e.g., accept, reject, and delete, or modify) records. The user, via the user computing device, validates the collated obtained item records stored in the cache as presented by the programmed system. Then the programmed system associates the validated collated obtained item records stored in the cache with the virtual repository. The programmed system also stores the validated collated obtained item records on a storage device, whereupon the cache may be wiped clean (i.e., all records may be deleted from the cache). Each item record may include a photograph of an item or an address (e.g., URL or pointer) to a photograph of an item. A link may also mean affiliate link or hyperlink. An affiliate link may be associated with any of the validated collated obtained item records. The affiliate link allows affiliate compensation for clickthrough purchases by other users. A software component on the user computing device (e.g., a plugin, addon or application) searches emails for item records, and provides the item records from searched emails to the programmed system for collating with the obtained item records, for subsequent validation in the cache. Another software component on the user computing device monitors browser activity for item records and provides the item records from browser activity to the programmed system for collating with the obtained item records, again for subsequent validation in the cache. Manually input item records may be received on the user computing device and provided (communicated via network communication) to the programmed system for collating with the obtained item records, again for subsequent validation in the cache. At least one image, video data, sound data, user data, event data, gaming data, and/or information relating to a virtual repository may be displayed on a display device of the user computing device. The displayed image and/or information may be one or more item photos or videos, a navigable two-dimensional graphic representation of the virtual repository, a navigable three-dimensional graphic representation of the virtual repository, item photos arranged in a continuous list from which any photo from the continuous list is displayable by user command, several levels of item photos or videos arranged in continuous lists from which any photo from a continuous list at each displayed level is displayable by user command. Virtual repositories and/or item records marked for sharing may be viewed (accessed for viewing but not changed) by other users. This allows users to browse virtual repositories and item records (e.g., images of items and information pertaining to such items) of other users. A user may record dates, timestamps, media identifications, scene names, and marketing objects of use of items or video data corresponding to item records. This facilitates management of items according to recorded use. Items may be marked for sale, rental, and donation. Item records may be systematically calendared by time and date of which an event is set to start or released to the public. In the cases of sale and rental, a marked item is shared with other users, who may purchase or rent the items through the system. In the case of donation, the user may select a charity to which the item may be donated.

A directive comprises an authoritative instruction pertaining to delivery of electronically deliverable reply. A directive may come with a function and may be responsive to interact with the user until the directive is satisfied. A directive may be a consumer directive or a marketing directive. A consumer directive may be one of many different types including, a location directive, a personal information directive, a general directive, and a specific directive. A personal information directive may provide a user's gender, race, age, income level, profession, and personal interests to facilitate delivery of reply marketing objects pertaining thereto. A general directive remains active until canceled. A specific directive and marketing directive instructs the system to which consumers the system should send a particular marketing object. A centralized processing engine saves each received directive as a record in a database referred to as a directive repository. A location directive identifies the user and provides location information for the user. The location information may comprise an address such as a home, business or temporary address, or another location. A location directive may be time bound, i.e., effective for a user-specified period of time. A personal information directive may provide some or all of a user's gender, race, age, religion, marital status, income level, education level, profession, and personal interests to facilitate delivery of marketing objects pertaining thereto. Items of data may be optional, to accommodate users with heightened sensitivity to privacy and/or anonymity.

A general directive remains active until canceled. A general directive identifies goods, services, categories of goods and services, brands, or other identifiable classificatory division of subject matter that is of interest or desired by a user. The general directive identifies the user and the subject matter of interest. A graphical user interface may present a user with a form that allows a user to identify a multitude of subject matter of interest. From the form, a general directive may be produced for each subject matter. By way of example and not limitation, one category may be pickup trucks and another category may be Ford F150® pickup trucks.

A specific directive is an immediate request. A specific directive identifies goods, services, categories of goods and services, brands, or other identifiable classificatory division of subject matter that is presently required by a user. The specific directive identifies the user and the subject matter required. A graphical user interface may present a user with a form that allows a user to identify each subject matter required. From the form, a specific directive is produced for each subject matter. Specific directives are processed immediately or as soon as practicable. A specific directive may be time bound, i.e., limited in duration (e.g., for a day, week, month, until an end date, etc. . . . ). By way of example and not limitation, a specific directive may request coupons or discounts for a particular business. The specific directive may be limited to a particular day when the coupons or discounts are needed. After that day, the coupons will not be provided unless requested again.

A marketing directive instructs the system to which users the system should send a corresponding marketing object. A marketing directive may specify users by subject matter of interest or by personal attribute or by location, as set forth in consumer directives (e.g., location, personal, specific, or general directives). A marketing directive is associated with a marketing object. The marketing object is an image, file, stream, or data that will be forwarded to each user with a consumer directive that matches a marketing directive. All directives may be associated with artificial intelligence and/or machine learning and/or deep learning or a combination thereof. Computer generated responses to directives, voice commands or personal digital assistants may be associated with artificial intelligence and/or machine learning and/or deep learning or a combination thereof. The marketing object may be stored in the database.

Time bound provisioning is available. All directives may be time bound. In other words, a directive may be active for a limited period of time, defined in hours, days, weeks, months, or years. For example, a general directive may be time bound for a year. The user associated with the general directive may receive a reminder of the time limit prior to the expiration, giving the user a chance to re-provision or remove the time limit. As another example, a merchant user may impose a time limit on a marketing directive for a coupon or discount. The marketing directive may expire on a determined date.

Unit provisioning is also available. For example, a merchant may want to limit a marketing directive to a maximum of 100 or 1000 or 100000 users or transactions. In this case, after the unit limit is reached, the marketing directive expires. The unit limit is reached when the number of copies made available to users equals the unit limit or when the number of transactions using the marketing directive (e.g., using a coupon or discount provided with the marketing directive) exceeds a unit (e.g., transactional) limit. For fairness, in one implementation, the limited number of users may be determined randomly, or using a random selection algorithm, from all users with consumer directives to which the marketing directive is responsive. Alternatively, the limited number of users may be selected based on seniority of their consumer directives-first posted, first served. These and other user selection criteria may be employed if a unit limit must be applied. In the case of a transactional unit limit, the limit may be applied on a first come first served basis.

The trigger creates a percipient sample pack (PSP), i.e., a sample pack or data pack. The PSP may include a user identification, location information, time information and/or captured (e.g., recorded) media. Thus, the PSP contains information and captured media. The user identification, location information, time information are PSP information. The captured media is PSP media. The captured media is recorded audio and/or video of a target. A captured advertisement, audio or video may also instantly save media or marketing objects to a database, repository, or computing device for a user. Captured media may be associated with a virtual repository or database. One or more virtual repositories may be associated with a database or may be one or more databases. A database may be one or more virtual repositories. The target may, for example, be a television program (e.g., a show. TV series, or movie, event, location, TV commercial, music sounds or rhythms, music video, objects, or item records), a streamed program, or a program from another source, such as a recording medium (e.g., a DVD), the Internet or a program delivery service that provides content by network communication. The captured media may be a portion of the target, i.e., a portion of interest to the user. A portion of a target may also mean the entire target or all objects in or on the target does not have to be identified through recognition technology to identify all the objects or the entire target or objects in the entire scene or location. This computer method is another example of a new technological invention. The user may be interested in the participants who appear in the captured media, the garments or accessories they are wearing, items they are using or other objects or objects related to services (e.g. make-up the participant is wearing and the make-up artist who put it on the participant and option or link to schedule an appointment) that appear in the captured media (e.g., furniture, dishware, art, pets, bed, lamp, event information. Services in captured media may also include but not limited to buildings with leasing options or purchasing options to office space, leasing information, realtor information, apartment information, homebuying information, residential space, and location information. The user might be interested in detailed information of the type of dog or cat in the captured media and the breeder of the dog or cat in the captured media with location and purchasing information. The user might be interested in a movie shown as a video trailer in a TV commercial and would like to calendar the movie and information about the movie, or would like a reminder to see the movie or a reminder to purchase tickets or an option to purchase pre-sale tickets now. System-generated AI-Driven recommendations may populate a user calendar or schedule from one or more media devices via metadata and marketing objects associated with signals, Wi-Fi, bandwidth, watermark signals, sound, speech, text, voice, video, advertisement, billboards. Those are several examples of targets.

Virtual repository information may be associated with product or service details, product or services links or product or service codes, video data, audio data, event data, celebrity data, or entertainment information. An object or object record may be an item or item record. An object may be a marketing object or matching object or object record. An object may be a numerical timestamp, time code, or duration value. An object or matching object may be a movie or television show scene. A matching object or object may be participant, participant or user details may include an image, product details, movie details, TV show details, scene information, numerical timestamp, colors, sizes, prices, services details, entertainment or TV guide schedule information, company logos, television or streaming channels, product categories, brand, and retailer information. A user may also be a participant. A user may also be a viewer. Each user account may come with user personal information or business information. One or more objects may be used to determine a matching program, location data, user, virtual repository, other item records, and participants in a scene, movie, tv show, event or any video data, sound data, event data, location data, or scene data for another user or an establishment.

The PSP is sent to a remote computing system, which includes a matching engine. The matching engine receives and processes the PSP or the captured media of the PSP to identify one or more related or corresponding records (each a target) of a virtual repository used for a functional response. Processing of the PSP entails parsing the PSP (i.e., separating the PSP into its components) and determining types of components (e.g., captured location (LOC), time, user identification (User_ID), photograph, recorded audio, recorded video, code image, etc. . . . ). Based upon the type of components included in the PSP, the matching engine performs target identification. In the case of recorded audio or a latitude longitude/GPS location, target identification may entail Automatic Content Recognition (ACR), such as sound recognition, speaker recognition, speech recognition, voice recognition, pattern recognition, location recognition, biometric data, audio fingerprinting and/or embedded digital watermark detection and identification of a combination thereof. In the case of recorded video or a latitude longitude/GPS location, target identification may entail Automatic Content Recognition (ACR), such as sound recognition, voice recognition, speaker recognition, speech recognition, logo recognition, scene recognition, typing recognition, pattern recognition, text recognition, image recognition, optical character recognition, biometric recognition, location recognition, facial recognition, object recognition, video fingerprinting, and/or embedded digital watermark detection and identification or combination thereof. In the case of a photograph or a latitude longitude/GPS location, target identification may entail facial recognition, object recognition, image recognition, location recognition, pattern recognition, image fingerprinting, and/or embedded code detection and identification of a combination thereof. A code image, such as an image of a matrix code (e.g., a QR code), may be processed to determine the alphanumeric equivalent of the code and may work in combination with automatic content recognition or target identification of media. Temporal (time) information and location information may be used alone or in combination with media (e.g., a photograph or recorded audio and/or video), to identify each target.

A watermark is a signal (e.g., an audio signal that is imperceptible to humans) that is included in the audio or video of a program. By way of example, companies who track which programs are watched by users have implemented technology that allows broadcasters and other distributors to embed watermarks in the audio. If a watermark is detected, the program may be identified from a database or similar repository that relates known watermarks to programs. The watermark may not only identify the program but also provide a timing component that indicates the part of the program. A program may be audio or video.

A fingerprint is a unique proxy or signature (e.g., a series of digital values, a waveform, etc.) generated from characteristics of the captured media. The fingerprint may be compared to a set of reference fingerprints corresponding to known programs. When a substantial match is found, the program and portion of the program that contains the captured media can be identified with a relatively high probability. Fingerprints and pre-determined fingerprints may be associated to matching objects. A computerized system and databases may be associated to APIs, data feeds, and client portals. Fingerprints and pre-determined fingerprints may be associated to portals, APIs, duration value, data feeds, timestamps, or a pre-defined duration value that match program duration values to determine matching objects. The computerized system may automate and synchronize programs, user repositories, entertainment databases, entertainment information, brands, retailers, APIs, data feeds, timestamps, matching objects for faster processing and outcomes. Within the current invention, all data feeds and content may be curated in real-time during any trigger. For one example, a gaming (betting) data feed can be used in the current invention to let users know which athletes or advertisements are shown or mentioned on the basketball court in real-time during live airing of the program or event and what item records are available. Curated media files, scenes, content, or data feeds may be used for example, but not limited to by a pause, move, change, start, or stop button or triggered to add, delete, or pause item records from user results. All results may be determined by curation in real-time.

The matching engine sends the user identification and target information to a Virtual Repository Matching Module (VRM). The VRM searches a database or other repository for records of associated with an identified target. A target may be a person or group of people (e.g., individuals who appeared in the captured media and/or items that are managed by a person and appeared in the captured media or services related to items or objects in the captured media). The person or group of people may appear in a broadcast or streamed show, at a live event, in public, in an image, audio or video on a webpage, in an image on a billboard, magazine page, or other tangible medium of expression. Accounts associated with the target are searched to identify records of items and/or services that relate to the target. Items may be associated to services. A user account may be associated to but not limited to an influencer, celebrity, business, organization, movie studio, TV Network, streaming service company, wardrobe supervisor, set designer, costume designer, fashion designer, and producer. A user account may use portal for outputs and inputs and communicating to the multi-directional system with timely efficiency and accuracy. (e.g. Portal for Retailers, Brands, TV Networks, Movie Studios, celebrities, and Fashion Designers to collaborate for the best outcome and profits.

The exemplary method accepts various triggers. A target trigger requests information associated with at least one virtual repository of the plurality of virtual repositories assigned to an identified user. An event trigger requests virtual repository information for one or more users appearing at a scheduled event. A location trigger requests information for one or more users at the same location (which includes the vicinity) as the location of the first user who submitted the trigger. A media trigger contains an image, voice, speech, face, object, location, video, or sound recording, from which a user's identity may be determined via pattern recognition, object recognition, screen recognition, biometric recognition, time code recognition, image recognition, scene recognition, text or typing recognition, video recognition, sound recognition, voice recognition, speaker recognition, logo recognition, Icon recognition, speech recognition and face recognition. A product trigger identifies a product, or contains an image of a product (e.g., in a photo or video), and seeks links to users and/or virtual repositories that contain item records that corresponds to the product. A depicted product or advertisement may be identified through object recognition or recognition technology. In addition, advertisement associated with a location may be recognized through recognition technology. A directive trigger includes a condition, which, when satisfied, causes the computing system to send results that include responsive details and functions until the user is satisfied. In all cases, displayed results may be filtered and sorted by the user. A single trigger or the term “Trigger” may include one or more of the following triggers, but not limited to a location trigger, product trigger, calendar trigger, media trigger, target trigger, event trigger, gaming trigger, image trigger, face trigger, video trigger, object trigger, logo trigger, scene trigger, time code trigger, touch sensor trigger (finger or cursor), biometric trigger, pattern trigger, voice trigger, speaker trigger, speech trigger, text trigger, audio trigger, beacon trigger, Bluetooth trigger, television proximity trigger, satellite trigger, cable box trigger, bounding box trigger, and a specific trigger or a combination thereof. All triggers may be associated with one or more recognition technologies. All triggers may be computer systematic or/and automated in this invention with or without human intervention. All triggers may include a bounding box. A bounding box is a geometric shape that encloses or surrounds an object or group of objects in a static image, digital image, video, or media. All overlays or transparent overlays or user interfaces may be triggered by a touch sensor. All results may be sent to a user via a computing device by but not limited to push notifications, systematic notifications, email, list, or link, all associated with item records. Item records are marketing objects.

Items may be added manually, by user input. Manual addition may entail typed user input, uploaded files, email, scanned documents, optical character recognition of documents, and verbal commands.

Items may be added from third party sources. Third party sources may include purchase histories from accounts accessible online. A virtual repository may also be a purchase history page for a user and vice versa. Such accounts may include online retailer and marketplace accounts (e.g., online Walmart, Amazon, and Macy's accounts). Another third-party source may be merchants' point of sale system data. Participating merchants may communicate purchase data for participating users to the system via an application programming interface. The purchase data may be pushed by a merchant from point-of-sale transactions by the user. Alternatively, purchase data may be pulled by a user from a merchant's point of sale system, via an application programming interface. Even purchase data for purchases at most brick-and-mortar establishments are stored on merchant servers connected to their point-of-sale systems.

Items may be added manually (e.g. upload) or via applications (e.g., plugins, portal, and add-ons) by artificial intelligence or that monitor a user's browser activity and emails for purchase data. A browser plugin may track online purchasing activity. Online purchases are detected via the website, artificial intelligence, and user selections, including online shopping cart activity. Emails, may provide order confirmations, many of which may contain a hyperlink to an account on a remote server where details of the transaction are provided. Location or establishment confirmations may be triggered by email data such as an email receipt. Accessing a remote account may require a login (e.g., user name and password), which the user can supply to the system. Emails may also provide detailed receipts, as in step 755. Receipts may also be uploaded by a user for processing. Such processing may entail optical character recognition and determining purchase data. The trigger leads to items of interest used in the scene and/or location for which the trigger was activated or associated with.

Data from sources other than manual entry may be stored in a cache or temporary storage until verified by a user. The cached data may be displayed to a user in a list comprised of records (rows) and fields (columns) or stored as a collection like in a relational database or a Mongo Database. Thus, a system and method according to principles of the invention merges (i.e., collates) data extracted for various sources, including remote (e.g., merchant systems) and local sources (e.g., mined emails) into a cached list for possible addition to a virtual repository. The user may verify each record for entry into the virtual repository. Data for a record may be modified by a user before verification. Records may be deleted by a user. For example, a user may determine that a record does not belong in the virtual repository, such as if the purchase is a gift for a friend.

Through an affiliate program, a user may earn compensation (e.g., a commission) for each item purchased through such a link. In this manner, consumers are efficiently provided links to purchase items of interest that appear in a program, while actors, production companies and others associated with a program are compensated for garnering consumer interest and facilitating sales of the items, all without any explicit marketing and without any direct communication between the consumer and user. A Service as A Software (SAAS) subscription model or computing system may be used to receive payment or compensation from sellers or suppliers for item records and/or marketing objects to be distributed or delivered as results to the user or consumer upon a trigger. The SAAS model or a service are the same or associated with the centralized repository computing system or virtual repository within the invention that allows agencies, advertisers, or storefronts to purchase product placement of marketing objects, items, services, or advertisement into the virtual repository for the purpose of allowing marketing objects associated with media to be purchased or viewed from a user computing device (User Interface).

In another example, a user may be interested in what items a person in the vicinity of the user is using (e.g., what a person is wearing or is advertising). Illustratively, a target in the vicinity of a first user may be an advertisement, stores, or item records inside a building, wearing attire or an item of apparel or accessory that interests the user. The first user or virtual assistant may select or trigger for identification of all other users in the first user's vicinity who have shared items, objects, of shared virtual repositories. Location information (e.g., GPS data) from the first user's device may be used to determine the first user's location. GPS or a physical address including marketing object or item record information may determine a user's location or determine user's repository or identification. User marketing objects or item records may be marketing objects and item records at the same physical address location (e.g. same establishment, same bar, same event, same street, same building). GPS data or location may have the same meaning as a physical address location. The “vicinity” may comprise an area within a determined range of the location. The determined range may be set by default or set and/or adjustable by the first user. If there is more than one other user in the first user's vicinity, the first user may be presented with a list of links to shared user data, from which the first user can browse and/or select or trigger a target.

Alternatively, the first user may voice command, scan, photograph, or record (e.g. audio, video) a target. From the location information from the first user's device, and the photograph, the first user may be presented with a list of links to shared user information, from which the first user can select the target. An implementation using facial recognition or any automatic content recognition may filter the list to shared user information for one or more users or user data who match the image, photograph, video, or advertising.

In some implementations, after a target is identified, the system determines if the identified target is a user. A user may be determined by identifying any item record or marketing object associated with the user and vice versa. All marketing objects or item records may be associated with a user and/or user virtual repository. If the person is a user, then the system may provide one or more links to shared data of the targeted user. Such shared data may include shared personal information, shared business information, shared item record data and a shared virtual repository. In other implementations, it is clear that a target is a user, and, therefore, this determination is unnecessary. For example, a user may select a target from a search of other users. A user may select or trigger a target using spoken words associated with a marketing object, item record, and/or location via a voice command. When selecting or triggering a building for example, a user may scan, photograph, use radar compass technology, video record, or voice command the building. The app may be voice controlled, or voice activated using subject matter related voice commands or other spoken utterances. When using a voice command, scanning, or recording a building within your vicinity, a user may receive a list of establishments and/or retailer details within the triggered building and the items or services they are selling, all within seconds. A user may point the smartphone or digital device including eyewear in the direction of any building or establishment and receive marketing object results associated with the building or establishment. This pointed direction may be known as radar compass technology. Item records may be queried via the internet or a virtual repository. This invention is designed to give users instant gratification in real-time with minimum searching or without any searching. In this invention, for example, a building might be seen and triggered from a tv show, advertisement, photograph, video, or in person. All results or functions may change or continue to be worked on until the user is satisfied with a final result. Via voice command, a result can be when the system or virtual assistant made a complete purchasing transaction on behalf of a user or change in information for a user.

In each case, a results list includes links, images, and advertisements that direct to shared virtual repositories and/or items of a sharing user. A user who follows such a link (i.e., a following user or advertising), may purchase one or more shared items, provided that the shared items are available from linked merchants. Such purchases may be initiated by selecting purchase links associated with the items. These shared items are associated with a database or repository. A repository may be a database. The selection may direct to a merchant website where the item may be purchased. Via an affiliate program, as described above, the sharing user may be rewarded for the purchase. In this manner, sharing users are rewarded for promoting items, such as by including items in their shared virtual repository, and by wearing or using items in public where other users may acquire an interest upon witnessing the user and/or the items being worn or in use. The sharing user becomes a live advertisement for the items. Traffic to a merchant's website may appreciably increase due to such advertising. Sales of the shared items are also likely to increase.

An invitation for a non-user identified by user entry or facial or voice recognition may be generated by the system. The invitation is a message to the non-user, inviting and encouraging the non-user to become a user of the system. The invitation may be sent by the requesting user, and/or by the system. The invitation may be sent to the non-user's known email address and/or social media account(s).

In another aspect of an exemplary implementation of the invention, a location-based trigger is used. A location-based trigger uses location information from a user's device and user repository information. Such location information is described above. The trigger may be activated by user command (e.g., selection of a control). The system determines if other users are at the same location, or in the vicinity. The determination is made using location information from each user's smart phone or similar device. If other users are at the same location, or in the vicinity, the system provides a results list or graphical display, for display on the user's device. In one implementation, the results include a list of users at the location and/or in the vicinity. The list may identify users by name and/or photo. The displayed name or photo may be a link or a pictogram that directs to the displayed user's shared virtual repository and/or items.

Illustratively, a user may be in a public space, such as a bar, a mall, a store, a street, a restaurant, a park, or the like. The user may see another person who is wearing clothes that interest the user. The user may initiate (e.g., select) a location-based trigger control. Upon receiving a location-based trigger command, the system receives the user's location information from the user's device. The system then searches its location records for all other users at the location or in the vicinity of the location. As discussed above, the vicinity is a system or user-defined range, such as, for example, a 250 m radius. GPS-enabled smart phones are typically accurate to within about 4.9 m (16 ft.) radius under open sky. However, their accuracy worsens near buildings, bridges, and trees, and indoors.

As long as a user does not disable location tracking, the system receives location information from each user's device (e.g., each user's GPS-enabled smart phone). In one implementation, the system maintains location records for a user indefinitely or for a determined time and in determined time increments. Historical location records are useful for identifying a user who was present at or in the vicinity of a location, but recently left.

Upon determining the users at and in the vicinity of the location, at the current time and recently, e.g., up to five minutes earlier, the system generates results for display on the device of the triggering user. The results may be displayed in a list or graphically. A list may include user names and/or photos linked to each user's shared virtual repository and or items. Tools may be provided to sort and filter the list. By way of example and not limitation, sorting tools may sort the results according to spatial proximity (e.g., distance from location) of each identified user, and/or according to time, i.e., temporal proximity, and/or according to fame as described below, and/or according to another distinguishing category (e.g., gender, race, age range, height range, etc. . . . ).

The marketing object is an image, file, stream, or data that will be forwarded to each user with a consumer directive that matches a marketing directive. The marketing object may be stored in the database.

A computer implemented consumer-driven centralized marketing methodology comprising steps of: receiving from a first user via a first programmed computing device a first directive, said first directive including a condition and identifying the first user and identifying a subject matter of interest to the first user, the condition comprising a condition from the group consisting of a price condition for the subject matter of interest, a pricing discount for the subject matter of interest, a topic for the subject matter of interest; Storing the first directive in a database on a second programmed computing device at a first time; Receiving from a second user via a third programmed computing device a marketing directive, said marketing directive identifying a marketed subject matter and including a marketing object; Storing the marketing directive in the database on the second programmed computing device at a time other than the first time; Subsequently, using the second programmed computing device, determining if the subject matter of interest of the first directive matches the marketing directive and subject matter and if the condition is satisfied, in the meantime sending the first user commercial advertisement associated to the matching subject matter prior to the copy of the matching marketing object distribution associated with a link to the first user to facilitate a purchase of the marketing object; If the subject matter of interest of the first directive matches the marketing subject matter and the marketing directive and the condition is satisfied, then making available to the first user, via network communication, from the second programmed computing device to the first programmed computing device, a copy of the marketing object associated with a link to facilitate a purchase of the marketing object.

The various databases described herein may comprise distinct separate databases, may be combined into one or more databases, or may comprise parts of larger databases. Thus, by way of example and not limitation, a participant or user database may be combined or associated with a virtual repository. All repositories and databases may be continuously updated or populated in an automated or systematic way manually or from a virtual (Digital) assistant. Changes of information from a web crawler may continuously populate information or, marketing objects, item records to a user repository. Similarly, a watermark database and fingerprint database may be combined into a multi-purpose database. Thus a database should not be construed to be limited to a distinct separate database, but, rather, may include any database that includes tables and relationships required to provide the described functionality.

In another invention, we are so inundated with television channels, shows, movies, music, apps, appointments, meetings, traveling, news, and passwords to name a few . . . . It's limitless!! Just too much to keep up with! Are you tired of the hassles from coordinating travels, restaurant options, shopping options, and entertainment options? I am, I believe we all are. Well welcome your Virtual Concierge and Lifestyle Personal Assistant. A virtual assistant, artificial intelligence assistant, or platform that will manage the selection process, so you do not have to . . . as it is a nightmare. Virtual assistant, artificial intelligence assistant, or AI system that is continuously and proactively searching, researching, reminding, taking notes, managing, executing, coordinating, correlating, scheduling, performing assignments, evaluating, executing, interpreting, recommending, purchasing, learning, evolving, notifying, customizing channels, performing duties, responsibilities, needs, or wants around your every move and very interest by fulfilling boredom gaps, traveling gaps, based on your personal and business daily calendar, personal, business, and family information, your habits, likes, needs, directives, resting location and traveling location while you are freed to enjoy all what the world has to offer. Your virtual or digital assistant in essence becomes a proactive thinker and can complete functions based on directives. This invention may all be completed with or without any user intervention using semantic intelligence, artificial intelligence, machine learning and a cognitive computing framework including neural networks within the current invention. Our vision is to create a centralized world where business marketing and consumer's needs and wants not limited to products, services, responsibilities, duties, and entertainment options from all industries will be learned and managed for timely pinpoint systematic or automated recommendations, reminders, assignments, and purchases based on time sensitive tasks, priorities, and popularity with little or no user intervention. The assistance of such a system will significantly reduce marketing cost of businesses while significantly increasing B2C and C2B awareness of timely mutual interaction. System can periodically read calendars of the user to look up Flight info to determine the city, state, and country the user has scheduled a flight. The system will also determine the location of the hotel the user will be staying. System determining flight information and hotel information from users can also be read with or without reading the calendar, not limited to third-party APIs, files, SMS notifications/text or emails. Since the user will be purchasing airline tickets and hotel stay from a centralized system of all products and services from multiple industries, the system will record information of these purchases to determine where the user is going or staying. System can also record information, dates, and times of other purchases for that particular day or any particular day to determine everything that user will be doing. For example: the user may purchase a concert ticket in advance, make reservations for a restaurant, go to a night club, Wedding, etc. . . . Depending where the user is going, what tickets they purchase on those days through the system, night club they may be going to, the system will perform predictive analysis and recommendations to send options of clothes the user might want to purchase on that trip. For example: Las Vegas, the system could send different bikini or swimwear if the trip was determined to be in the summertime. The system can also send matching outfits, shoes etc., to the user to match up clothes or shoes they previously purchased from the system that was in their virtual closet with other clothes from one or more merchants or retail stores. The system could also just systematically select outfits for the user directly from their closet. The system could send movies the user might like for their flight to Las Vegas during the boredom gap from the flight time of the trip. All without the intervention of the user which includes the consumer and the company or source. System can also know where the user is traveling, determine weather, and then start recommending clothes to wear during the duration of the trip. Basically packing the user's suitcase based on known intelligence within the system. For example, events purchased and scheduled within the centralized system, weather etc., The system will know the route they might be traveling to get to their hotel to notify them of things that are interesting to them or they need to do along the route based on directives the user selects or voice commands. System generated recommendations and predictive analysis based on purchases, calendar info, schedules. AI and machine learning. Recommendations, suggestions, reminders can be based on any topic, information, industry, product, and services from the centralized system. The system or platform will systematically schedule events like concerts, comedies, movies tickets, or any entertainment options in the user's calendar and can purchase these items at the same time. User's credit card information will be saved in the system for purchases. User chooses directive to have system automatically purchase product or service on demand or when it is first available for purchase. System within the invention may allow user to upload item records they own or use and also allow the user to create new advertisement or materials or item records within the system for machine learning, deep learning, distribution, processing, analyzing, recognition, marketing advertisement, or promoting purposes, Own, used, or created item records or objects may automate distribution to users based on their traveling schedules, traveling location, and home location. The suggestion and recommendations or marketing directives may be continuous until cancel. This means when a user books a trip or books a flight, the system may instantly start recommending item records from the traveling destination based on predictive analytics, preferences, habits, wants, needs, likes and much more. Calendar information and schedules may be populated by your virtual assistant proactively. If you like Jennifer Lopez and she is in town for a concert at your traveling location, you will be suggested to attend or purchase a Jennifer Lopez concert ticket. Your assistant constantly understands your habits though your inputs or history though listening, visually, actions, schedules, calendaring, travel, or other understandings. Suggestions or advertisement or item records within the invention may be recommended or suggested until you arrive back home from your trip. Basically, the system may control your experience until you get back home or wherever you go continuously unless it is given some direct order verbally or non-verbally to pause or stop. Advertisements or events or other duties and actions may be recommended based on your current calendar or schedule based on available or busy time slots. The virtual assistant or system within the invention could also proactively solve problems or perform assignments even performing assignments proactively that have due dates. Your virtual assistant may be proactive or reactive. Your virtual (digital) assistant or system may be associated with a virtual repository and marketing objects and item records and may be trained using deep learning, machine learning, cognitive computing, semantic intelligence on but not limited to the dictionary, vocabularies, announcements, directives, subject matters, memories, responses, mathematics, music, music genres, musicians, athletes, celebrities, entertainment categories (e.g. TV shows, concerts, sporting events, music), daily programming information like television programming, radio programming, streaming programming (e.g. show schedules, times, dates, celebrity appearances, cast information, show names, event names), spelling, languages and different dialects, Apple maps, Google maps, longitude and latitude, the internet, world current or past events. A QR code, 2D graphical models may be trained using machine learning and/or deep learning in the invention. All features within the invention may use the integration of Google Maps and Apple Maps to determine marketing objects associated with location data. An assignment or directive may include writing a paper, do homework, describing or understanding item records shown or heard on tv or videos or radio, purchasing item records shown or heard on tv, video, radio, or in-person, perform time sensitive tasks. In another example, this is a technological advancement the AI assistant mimics the human brain and thinks, interprets and understanding meaning, remembers, solves problems, and perform assignments or directives and functions for its owner or a user so the user does not have to. The

An object or matching object may be an item or item record. Services may be an item or item record. An object or item record may be a numerical timestamp, time code, time value, or duration value. An object, Item record, or matching object may be a movie or television show scene or event data. A matching object or object or item record may be a participant or user, participant or user details may include an image, product details, movie details, TV show details, streaming data, program data, a program written script, text, a script, closed caption, downloadable or uploaded materials/data or software applications, hyperlinks, scene information, advertising data, image data, video data, audio data, gaming data, pattern data, user data, file data, repository data, database data, merchant data, event data, location data, media identification, user identification, media type, media, business information, personal information, numerical timestamp, directives, colors, sizes, prices, services details, landmarks, buildings, houses, entertainment or TV guide schedule information, calendared information, analytics, company logos, date information, time information, time code, television or streaming channels, product categories, brand and retailer information. A user may also be a participant. A user may also be a viewer or listener. Each user account may come with user personal information or business information. All users, repositories, item records, items, and objects may be recognized or identified by voice command, scanning, a photo, video recording camera using a recognition matching engine including, but not limited to one or any combination of the recognition technologies: pattern recognition, object recognition, location recognition, event recognition, screen recognition, biometric recognition, time code recognition, image recognition, scene recognition, text or typing recognition, video recognition, sound recognition, voice recognition, speaker recognition, logo recognition, Icon recognition, speech recognition and face recognition. Recognition technology may be automatically processed or implemented in the camera or smartphone. An event trigger may also initiate or trigger event recognition. Event recognition may use location and event data to perform recognition. Location recognition may use location data and event data to perform recognition. A location trigger may also initiate or trigger location recognition. All recognition technology may be triggered to perform immediately upon video recording or audio recording or upon triggering time code or object for real-time results. In the current invention, video recognition may have the same meaning as image recognition and vice versa. Image recognition may have the same meaning as object recognition. Sound recognition may have the same meaning as speaker, audio, voice, music, and speech recognition and vice versa. Video and audio recordings, scanning and photos are triggers. All triggers may be associated with a matching engine for exact matching. Exact matching does not always mean exact matching.

Cognitive computing framework, semantic artificial intelligence, artificial intelligence, generative AI including neural networks may all be used to understand or process human natural language, directives, or questions from a user. Chat boxes like ChatGPT may also be used in the current invention to understand meaning and implement or carry out functions from directives. Commands may trigger by text, closed caption, or by speech. A virtual assistant (a computerized personal assistant) may trigger media and/or a computing device by voice command. A virtual assistant may be triggered by voice command from the user. Speech to text, text to sound, audio to text, text to video, video to text are all features that may understand meaning and may be used in the invention act as a directive or to generate questions, trivia, or to answer questions based on or associated with item records or marketing objects within the repository and/or database. Users may send other users marketing objects or item records using voice commands. For example, a voice command directive may tell the system to send my sister marketing objects or item records associated with a current advertisement or TV show the current user is viewing or hearing by including the users name and words or speech associated with the advertisement or TV show. The voice commands and functions are limitless.

In the current invention, a virtual assistant or AI assistant or system that may continuously performing “AI Duty or Duties” within the invention. An AI Duty or Duties may be known for but not limited to proactively searching, creating directives, comprehending, interpreting, researching, reminding, taking notes, assigning, organizing, carry out task or instructions, controlling it's environment, managing, configuring, reconfiguring, writing algorithms including algorithms on the fly, processing, training, educating, coding, documenting, coordinating, scheduling, calendaring, recommending, approving, declining, purchasing, learning, evolving, delegating, assigning, notifying, and customizing channels, options, AI duties around your every move 24 hours 7 days a week and very interest by fulfilling boredom gaps, traveling gaps, based on your personal and business daily calendar, personal, business, and family information, business work schedule and assignments, your habits, preferences, likes, needs, directives, resting location and traveling location while you are freed to enjoy all what the world has to offer. Your assistant in essence becomes a proactive and reactive thinker!! Your virtual assistant is designed and constantly configured daily through learning to think like a user or its owner, and it can carry out instructions, tasks, or assignments (e.g. Directives) on your command or on its own without user intervention not limited to one or more trained algorithms. An AI assistant may create algorithms and new logical and less risky paths for user satisfaction or assignment completion on the fly throughout the centralized system to find not limited to a quicker, faster, smarter, more efficient, more effective, and more cost-effective way to complete, reconfigure, optimize, or fix the user driven directives or AI driven directives, tasks, assignments, logic, or errors. An AI Assistant may create or send a directive to another AI assistant or AI agent and create logic for each directive. My vision is to create a centralized system/world where business marketing and consumer's needs and wants not limited to products, services, and entertainment options from all industries will be learned and managed for timely pin-point automated directives, recommendations, reminders, and purchases based on priority and popularity with little or no user intervention. The assistance of such a system will significantly reduce the marketing cost of businesses while significantly increasing B2C and C2B awareness of timely mutual satisfaction. We would like a world where the exact items and services you see or hear appear before your eyes via a computing device using a voice command with many options including a voice command purchase. The processing, features, tasks, mechanics, and virtual assistant may be automated or systematic not limited to using semantic intelligence, image processing, artificial intelligence, cognitive computing, and machine learning with or without user intervention. To solve one or more of the problems set forth above, in an exemplary implementation of the invention, a computer-implemented method of managing a virtual repository system includes providing on a computing system a plurality of virtual repositories. Each virtual repository is assigned to a user. Each virtual repository includes item records for items owned and/or used and/or managed by the user. A user may be an Artificial Intelligence assistant also referred to as an “AI assistant”. Artificial Intelligence may be an AI assistant and vice versa. An AI assistant is associated with the centralized system including one or more users, one or more databases, the internet, and the web within the invention. An AI assistant may be a virtual assistant or personal digital assistant. An AI assistant may be a personal virtual assistant. An AI assistant may be physical or virtual. A user may assign one or more accounts to one or more AI assistants. An AI assistant may be a computing device or computing system. An AI assistant may be robotic. A robot may take place or execute in many computing forms, shapes, and entities. An AI assistant may execute as one or more computing devices, take on one or more assignments, execute as one or more servers, execute with one or more databases, execute for or as one or more users, execute as one or more agents, and organize, process, manage, interpret, delegate, evaluate, assign, carry out a task, and control for or as them all simultaneously or in combination. For example, the AI assistant basically simulates an octopus with millions of tentacles, each tentacle assisting and processing one or more users of one or more repositories of one or more people, places, or things including businesses, non-profits, online stores, and storefronts. In essence, simultaneously carrying out assignments/directives and storing memory in the biggest brain which is the centralized system within the invention. This means an AI assistant can execute in an aggregated or collective manner and managing for more than one user or more than one computing device for more than one user. The AI assistant may act as one or multiple AI agents. It also means the AI assistant can execute as one single user or for one single user. An AI assistant may train item records in a machine learning system for but not limited to understanding, creative responses, comprehending, recreating, satisfying directives, evaluating, recommending, and recognition purposes. In essence, teaching itself with provided or available data information and large language models. A data pipeline may be funneled not limited to data stores, data streams, applications, to data load, event queue to data lake, data warehouse, processing to data science, business intelligence, analytics, and machine learning. An AI assistant may be used to control the entire process or environment.

The system within the invention may be connected to one or more third-party systems, software, and/or data feed including a scheduling or calendaring systems. The centralized system may also be one or more connected repositories and computing systems including computing systems, databases, websites, and data feeds from third party systems that communicate to each other to deliver triggered results including time and dated related information, marketing objects, and data via a network communication computing system with one or more processors including cognitive computing, artificial intelligence, semantic intelligence, or a combination thereof. A third-party computing system, database, data may be automated to systematically read, interpret, and analyze to understand, comprehend, and execute time sensitive information associated with users and advertisers for recommendations, suggestions, scheduling, calendaring, purchasing, via triggers and user directives. A directive may give a virtual assistant or computing system an assignment or task. For example, hey Slinkit (e.g. wake call), can you tell me what jeans JLO is wearing on CBS or what Jeans JLO is wearing on the movie “Out of Sight” and purchases them for me and if it is not available in my size, purchase them when the size first becomes available again. The directive may be active until canceled or until the user is satisfied. In the current invention, one trigger may trigger another trigger. This type of system is a technological advancement. In another example of this technological advancement, the virtual assistant may mimic the user's human brain or one or more human brains (e.g. one or more computerized virtual assistants connected to the centralized system), and thinks, interprets, and understands meaning, remembers, solves problems, and execute and performs assignments or directives and functions for its owner or a user so the user does not have to. The virtual assistant may be proactive and reactive for its owner or user. The virtual assistant may evolve and learn from one or more virtual assistants connected or associated with the centralized system within the invention. The virtual assistant may handle all functions, assignments, tasks involving a computer and/or computing system basically acting as the user's personal concierge virtual assistant. Recommendations and suggestions are associated with user's habits, likes, preferences, wants, needs, purchase history, selling history, current location, third party information, personal information, business information, family information, traveling location or itinerary, hotel stay, multiple choice questions, marketing objects, and item records (user data, meta data). Recommendations or suggestions may be implemented or created using directives triggered by users. For example, if a user books or schedules a flight with United Airlines, the user's flight information or itinerary may be read, analyzed, comprehended, or saved by the system or virtual assistant within the invention to recommend or suggest advertisement, events, restaurants, hotels, rentals, or information associated with the user's traveling or arriving location, city, or state. A virtual assistant or computing system may continuously create a user with a new itinerary via any old or new marketing objects or information associated with the user, user, or a source (e.g. restaurant) high popularity or high reviews (e.g. Yelp). This new information may populate a user's daily calendar or schedule. These recommendations and suggestions are system generated to be distributed to the user's computing device. Recommendations and suggestions may be marketing objects and item records within a repository triggered from automation and/or systematically when user flight information is complete and finalized or before the flight information is finalized, while the user is searching for possible departure and arrival dates and times. Once the traveling location is known or finalized by the user, second user, and/or third party user (e.g. United Airlines), the system may analyze all related marketing objects, item records, user habits, needs, wants, user preferences, user likes, purchase history, visited websites and other known data associated with user and compare it against third party user marketing objects and item records within the repository matching the user's traveling location, city, state, or country to recommend or suggest advertisement, events, music, restaurants or other information from the visiting location to the user's computing device. This calendaring process may be automated including using artificial intelligence. Automated calendaring may continuously update a calendar as marketing objects are made public or is new information or matches directives from the user. Calendaring may re-populate based on new user traveling schedule via airplane schedule information, hotel schedule information or GPS location input and route along the destination on the computing device. System or virtual assistant recommendations, suggestions, scheduling, and calendaring may be continuous as a user travel from location to location or when a user's known itinerary changes. For example, recommendations for a road trip or traveling by car from location to location or city to city. Recommendation and suggestions may be populated into a user calendar by date and time. Multiple recommendations and suggestions (e.g. Advertisement) may populate the same time slot giving a user the option to choose or keep one or more and/or delete one or more recommendations. A user may populate another calendar with a recommendation they want to keep or attend or purchase. A user may have snooze reminders to alert them a certain day or time prior to the event. Recommendations and suggestions for users may be paid advertisement. User recommendations and suggestions in the traveling or arriving location, city, or state or country may be determined by multiple choice, habits, needs, wants, likes, preferences, purchase history, visited websites, duration of time spent on subject matter videos or advertisement visually or through audio of a combination thereof. The system or virtual assistant may also schedule or calendar any other recommendations or suggestions for the user based on best probability and user needs, preferences, habits, and wants. Users may accept or decline the system's or virtual assistant's automated scheduling or calendared recommendations or suggestions. This is just one example of many unlimited examples of recommendation and suggestions from user's schedules, calendars, information from any known user location or traveling location. The system may Data Metrics are systematically or automated to analyzed, and constantly read and comprehended for both the consumer and the company to produce bi-directional, multi-directional real-time systematic or automated recommendations, predictive analysis, purchasing, marketing, awareness and managing using artificial intelligence, semantic intelligence, and deep learning, machine learning. The system can then create directives and perform an action based on a single personal data metrics or an aggregation of data metrics to be sent to any user both company and consumer. System can also deliver marketing objects based on data metrics. The system can systematically put together itinerary for the user and determine exactly where the user is spending the most money and the least money. The system could systematically evaluate the consumer's or user's spending habits and show them how to manage their money or determine how much money to save for a vacation of one or more people based of predictive analysis and also determine or recommend which products, services or vacation packages fit their budget based on how much money they make or based on how much they spend all to save money by a certain timeframe when such event or vacation is set to begin. Proposed itinerary based on historical purchase/preferences for vacation or other travel purposes, business or personal. System generated Recommendations can pull clothes from a user's fashion closet or an of archived repository of household purchased products from each user and match it up with currently viewed products or products on sale from one of more vendors or retail stores at anytime and anywhere. This recommendation can come prior to a wedding, vacation, or any event that is scheduled from the user or the system can just recommend products randomly based on newly stocked products, products that are discounted, previous purchases, known purchases, (purchase history), matching brands, etc., user can also manually match up products. Product can be matched using the matching logic in the invention. All Products on T.V. can be displayed on television or on any digital device including a smartphone of the customer initiating the trigger for product details, likes, purchases, or comparing, matching, or systematic suggestions from products on television against products owned inside their Personal Virtual Household Product Repository (ex. Household category, Product Category for ex.—Virtual Closet, Virtual Living room). Platform that centralizes the entire financial landscape

System through artificial intelligence, semantic intelligence, and machine learning will learn the underline detail agreements and contracts between the consumer and business or business and business for systematic managing, recommendations, reminding, organizing, coordinating, bill paying, payment options, investments, stock options, direct lending, data analytics and predictive analysis. For example, the system for each individual person can organize and manage what bills are a priority to get paid based on household or individual salary or income. System can recommend and provide input on pros and cons of particular bills that the individual or company chooses not to pay. The system could show the individual or business the total amount of interest of a particular bill that is not getting paid. The system can recommend between two different bills the individual or company is having a hard time deciding on which one should be paid first, which one can be put off for a month, or how long it will take to pay a bill etc. . . . . System will capture, archived, categorize, and save all bills, agreements, contracts, for individuals and companies (businesses) for but not limited to managing, matching, fix errors, coordinating, bill payments, and bi-directional predictive analysis. Individual and company can select which bills, agreements, contracts can be added to their repository for artificial intelligence and machine learning. Reading, proofreading, restructuring, rewriting, amending, and learning of any document may be completed through but not limited to artificial Intelligence, semantic intelligence, machine learning, email, scanning, Copy, paste, pdf, word document, and excel using machine learning and an AI assistant. All sources, platforms, users, places, and things may be interconnected within the centralized system.

Using a trigger to identify and recommend one or more matching objects to a user based on matching marketing directives, preferences, compatibility, and/or shared interest associated with one or more media files of one or more virtual repositories, and the triggered matching objects “only” existing at the same physical address location of other users at the time of the first trigger including a vicinity until a condition change is a unique technological advancement. This technological advancement allows users to purchase, like, advertise, view, contact, interact, or engage matching objects they see in-person, in real-time or after a triggering event. Each triggering event is unique to different results of the previous triggering event at the same physical address location. Each target may be a moving target. As users come and go or are in and out of a unique physical location, affects triggering results of matching objects. In this invention, automatic content recognition may be used for preventative measures to prevent crime for example. For example, facial and object recognition may be performed to locate suspects, criminals, or illegal immigrants in real-time from computerized cameras. Criminal databases, FBI databases, government databases, police databases, driver licenses, DMV databases, and personal, criminal, or public information or profiles associated with a photo of a user are marketing objects and item records that are associated with databases or repositories in this invention. A computerized camera/recorder, in real-time, may recognize a suspect or criminal through facial, location, and object recognition and determine the identity of that suspect or criminal, what they are wearing, what location they were recognized and do all this against one or more databases or repositories and send the matching information to authorities (e.g. authorities, law enforcement's computing devices), so they can converge on the suspect and criminal. The powerful cameras may also be implemented in robots including the eyes (e.g. biometrics) to perform facial recognition and/or object recognition while looking at people while walking in crowds or sitting idle. These robots are smart robots, smart enough to recognize criminals or anyone in crowds law enforcement officers are looking for through their robotic computing camera eyes. Robots may also recognize another person/individual for their owner (e.g. user) or a specific person/user. Once an individual or criminal is recognized by the robot, the robot may alert a plurality of authorities through a network communication computing system to the time, date, and location of the criminal or individual and send the authorities or individuals detailed information about the criminal or suspect or person. The robot may also detain the suspect or individual itself. This technological advancement will prevent people from committing crimes because any camera (e.g. street cameras, robots, robot eyes) could alert authorities immediately of their location when detected from a computerized recorder/camera. These cameras may use very enhanced camaras with powerful processing power not limited to GPUs that may record with no pixelation or blurriness of final results of images that are identified, or it can be recorded with pixelations and blurriness but change without pixelation or blurriness before identified and sent as a result to authorities or law enforcement via computing devices.

The matching engine or temporal data recognition provides a unique technological advancement, connecting a PSP to virtual repository records. The matching engine may be contextual, implementing a matching process specific to the content of the PSP. In the case of photograph or captured (i.e., recorded) audio and/or video, the matching engine detects and demodulates any embedded watermark or codes, fingerprints the captured audio or video for matching in a database of fingerprints, relates the fingerprint to an object record in the virtual repository. A database of fingerprints may comprise a database of fingerprints for scenes (portions) of programs or movies or objects or people visible in a scene. Each scene may be related to participants for the scene from a database that relates participants such as actors and producers to programs and scenes of the program. Facial recognition and/or voice recognition may be applied. Uniquely, the matching engine enables exact matching. By way of example, an exact garment worn by a person depicted in a video or photograph may be identified, and a link for purchasing that garment from a vendor of that garment may be sent to a user who actuates a trigger, all without any direct communication with the depicted person. In sharp contrast, heretofore, prior art systems merely identify a type of garment worn by a depicted person and through a search engine query produce links to similar items, which may be legion, but not an exact match. Heretofore, no such automated means of connecting object records to a captured/recorded subject matter existed.

Any Item record within the current invention may also go through machine learning technology and Artificial Intelligence training to recognize the exact item against the user repository similar items that are on the video or audio program. Using machine learning technology to train products and information via artificial intelligence to process, analyze queries, or directives to execute faster when delivering exact or similar products, marketing objects, or media files as results. Artificial Intelligence is used for faster processing, analyzing, rendering, and identifying item records or media files associated with Temporal Data Recognition or recognition technologies. The user voice command or computer system may also communicate with a virtual assistant, personal digital assistant, Artificial Intelligence, or a combination thereof to deliver results.

In the current invention, the term “artificial intelligence” may be used for one or more types of Artificial Intelligence and semantic intelligence. Artificial Intelligence systems are trained on a large amount of data, allowing it to learn patterns and make predictions or decisions based on that data. Artificial Intelligence may write its own algorithms based on being supplied with training data. Semantic Intelligence or mapping not only helps machines to interpret the heterogeneous big data to comprehend the corresponding context but can also help to detect big data anomalies and complete the missing information. The types of artificial intelligence (AI) and semantic intelligence used in the current invention are as follows, but not limited to:

Narrow AI: AI designed to complete very specific actions; unable to independently learn.

Artificial General Intelligence (AGI): AI designed to learn, think, and perform at similar levels to humans.

Generative Artificial Intelligence (GenAI): on the other hand, is designed for a wide range of tasks but lacks AGI's comprehensive understanding or learning ability. Instead of creating a single intelligent system, GenAI develops models that generate new content, mimic human creativity, and excel at specific tasks. It creates original content such as images, text, music, or code, using extensive data to produce relevant and realistic outputs.

Artificial Superintelligence: AI able to surpass the knowledge and capabilities of humans.

Reactive Machine AI: AI capable of responding to external stimuli in real time; unable to build memory or store information for future.

Limited Memory AI: AI that can store knowledge and use it to learn and train for future tasks.

Theory of Mind AI: AI that can sense and respond to human emotions, plus perform the tasks of limited memory machines.

Self-Aware AI: AI that can recognize others' emotions, plus has sense of self and human-level intelligence; the final stage of AI.

All functions or functionality within the current invention may be completed or performed using an artificial intelligence computing system or may be associated with artificial intelligence. Artificial intelligence may systematically or through automation generate requests, selections, directives, suggestions, web crawls, recommendations, reminders, notifications, and perform task or functions based on but not limited to, time, demand, a user calendar, a user schedule, a user needs, voice command, directives. Cognitive Computing may be used in combination or associated with Artificial Intelligence and Semantic Intelligence.

Semantic Intelligence is the ability to gather the necessary information to allow identification, detection and solving semantic gaps on all levels of the organization. Several types of semantic gaps can be identified:

The semantic gap between different data sources-structured or unstructured

The semantic gap between the operational data and the human interpretation of this data

The semantic gap between people communicating about a certain information concept.

One application of semantic intelligence is the management of unstructured information, leveraging semantic technology. These applications tackle R&D, sales, marketing, and security for activities that include Knowledge Management, Customer Care and Corporate Intelligence.

Several applications aim to detect and solve different types of semantic gaps. They range from search engines to automatic categorizers, from ETL systems to natural language interfaces, special functionality includes dashboards and text mining.

In this current invention, Semantic Intelligence is the ability to gather the necessary information, objects, or item records to identify, detect and solve semantic gaps across all levels of an organization or a centralized marketing system of organizations or an ecosystem or a combination thereof. Semantic Artificial Intelligence (Semantic AI) enables machines to interpret the intent of content rather than focusing on the exact words being used. This is extremely useful to improve search results and information findability. It links content to its implicit, hidden, or intangible meanings, simulating human-like understanding of content. This approach provides more accurate results that better align with the searcher's actual intent. Semantic AI is used in various applications to enhance understanding and processing of human language and intent. For instance, in e-commerce platforms, it is used to improve product search and recommendations. When a customer searches for “lightweight laptop for travel,” Semantic AI can understand the intent behind these words and suggest appropriate products, even if they do not exactly match the search terms. In content management systems, Semantic AI can be used in conjunction with taxonomies for intelligent content tagging and classification. It can automatically categorize articles, documents, or multimedia content based on their meaning and context, making them easier to organize and retrieve. Customer service chatbots utilize Semantic AI to better interpret customer queries and provide more accurate responses. For example, it can understand that “I can't log in” and “My account access isn't working” are essentially the same problem, even though they use different words. In healthcare, Semantic AI is used to analyze medical records and research papers, helping to identify patterns and connections that might not be immediately obvious to human researchers. Search engines employ Semantic AI to understand the context and intent behind user queries, providing more relevant results and even answering questions directly. Semantic AI significantly improves the efficiency and effectiveness of information findability, reducing time spent searching for relevant content. It provides more relevant search results, enhancing user satisfaction and engagement. This technology leads to better customer experiences by delivering more accurate and contextual information. In workplace settings, it boosts employee productivity by streamlining information access. Ultimately, Semantic AI supports improved decision-making by providing more accurate and contextually appropriate information to users. In this invention, Tokenization may also be implemented. Tokenization, in the realm of Natural Language Processing (NLP) and machine learning, refers to the process of converting a sequence of text into smaller parts, known as tokens. These tokens can be as small as characters or as long as words. The primary reason this process matters is that it helps machines understand human language by breaking it down into bite-sized pieces, which are easier to analyze. Tokenization breaks down vast stretches of text into more digestible and understandable units for machines. The primary goal of tokenization is to represent text in a manner that is meaningful for machines without losing its context. By converting text into tokens, algorithms can more easily identify patterns. This pattern recognition is crucial because it makes it possible for machines to understand and respond to human input. For instance, when a machine encounters the word “running”, it does not see it as a singular entity but rather as a combination of tokens that it can analyze and derive meaning from. Semantic AI significantly improves the efficiency and effectiveness of information findability, reducing time spent searching for relevant content. It provides more relevant search results, enhancing user satisfaction and engagement. This technology leads to better customer experiences by delivering more accurate and contextual information. In workplace settings, it boosts employee productivity by streamlining information access. Ultimately, Semantic AI supports improved decision-making by providing more accurate and contextually appropriate information to users. Semantic AI may be used in combination with search, target identification, matching engine, or any other processes with or without any user intervention.

Modern operating systems include a voice-user interface that makes spoken human interaction with a device possible, using speech recognition to understand spoken commands. System or Artificial Intelligence may use speech to text and text to speech to respond with an audible or text reply. Artificial Intelligence may be systematic or automated in its directives, request, actions, functions, and when delivering results. User spoken command can be analyzed to search user repository associated with products, services, events to deliver results the user's account, mobile phone, computing device, Smart TV from a radio or television or another computing device. These items, events, services (item records, Matching Objects) are talked about on the radio via voice over and radio advertisement. All Systematic or push notifications can be saved in an advertisement history or saved in a wish list. Notification history. Notifications may be sent to the email address of the viewer or as a notification itself via an email. In the current invention, all artificial intelligence types are referred to “Artificial Intelligence”. Artificial intelligence may be associated to, but not limited to, all triggers, processes, features, web crawlers, bots, recognition technologies, semantic intelligence, matching engine, a virtual (digital) assistant, AI models, AI agents, temporal data, and time codes for identification and processing purposes of item records, images, objects, items, media files, websites, corporate information, and virtual repositories of all users. Artificial Intelligence “AI” AI model is a computer program that uses algorithms to learn and make decisions based on data. AI models are designed to mimic human thought processes. AI Models may be used for data collection, algorithm selection, training, evaluation, testing, deployment, and maintenance. The models may be used for robotics and control systems for guidance. Large language models (LLMs) and convolutional neural networks (CNNs) are also examples of AI models. AI agents are tools that use artificial intelligence to perform tasks, learn, and adapt. They can work independently or as part of a larger system. These AI agents are designed to use real-time feedback, responses, and changing conditions to learn and take action. Learn and change based on the data they process. They can interact with their environment intelligently and rationally. There are many different types of agents: Simple Reflex Agent which use data and set of condition-action rules to make decisions. Model-Based Reflex Agents which use internal memory and percept history to create a model of the environment. Goal-Based Agent which use predefined rules and search algorithms to achieve specific objectives. Utility-Based Agents which act based on the best way to reach a goal. Learning Agents which adapt and improve over time. These AI agents and AI models may work in combination with each other.

In another aspect of an exemplary implementation of the invention, a user may add or submit a media file to a repository. A submission of a file may be an upload of a file from a user computing device. An addition of a media file may be a file created within the centralized system to create a repository or add to a repository. A user page contains fields in which media file information may populate or be added to. The media file may include a written or voice script of a program. A script is a written document that serves as a guide for the production of audiovisual work such as a movie, tv series, broadcast, or event. The media file may be a file not limited to a document, excel spreadsheet, pdf file, wave file, mp4 file, mov file, xml file, csv file, FTP file. A media file may be a script. A script may be a marketing object. Marketing objects or advertising may be file or download onto a file. Each video or audio or advertisement file may be analyzed, processed, fingerprinted and scripted to a unique text file (e.g. closed captioning) using speech recognition and natural language processing and stored or recorded in a user repository or database associated with a program (e.g. TV show, movie, TV series, podcast, radio show, program title, TV guide information, program details, event, user details) in which it was scripted from. Each media, video or audio file that is scripted and/or fingerprinted may also go through machine learning training including semantic intelligence for understanding, interpretation, and interactions with user communication and voice command subject matter directives associated with a script. A file may also contain and/or obtain program details associated with marketing object details not limited to a media id, media type, product type (e.g. shirt, lamp, beverage) scene information, products each participant or cast member is wearing, advertisement details, product placement details, services, URL hyperlinks, retail store and brand information, source information, personal or business information, image hyperlinks, hyperlinks, dates, time, bios, profile pic hyperlinks, product description, pricing information, sizes of products, colors of products, an physical address, longitude and latitude GPS coordinates, location information, discounts, and promo codes. A media file submitted or added via a user portal to a user repository within the centralized system by a user, may be systematically categorized and populated through a triggered automation by an AI assistant (e.g. Artificial Intelligence) for user marketing object navigation and approval within an Information, advertisement, and product placement system (e.g. service provider and/or sales system, SaaS system, associated with user repository). The information, advertisement, and product placement system may also be referred as a “IAPP system” within the invention. An IAPP system is associated with a computing device. An IAPP system is associated with marketing objects of media files and items of retailers or brands or other information or marketing object providers. An IAPP system is basically a virtual repository with user controls for navigation functionality to control, change, or populate a database. An IAPP system includes a user interface via a portal and user account that allows a merchant user to sell, advertise, or push marketing objects to other consumer users seeking information or triggering media. The merchant user is allowed to navigate through its repository not limited to viewing, clicking, making changes, modifications, deletions, additions, sharing, declining, and approvals of populated fields of the media file submission or addition. Datafeeds via a file or API related to marketing objects from third party stores or sources may be associated with IAPP marketing objects associated with a program or media. Each IAPP system will have user permissions and user calendar options. Each IAPP system may have a unit limit number, an expiration date for marketing objects or a media file, start and ending dates of advertisement placement or information placement. An IAPP system allows any user to receive marketing objects associated with any program or media described within the invention. Once a user's IAPP system is populated with marketing objects and approved by a user, any user may trigger the media or programs approved within the IAPP system to receive marketing objects via their user interface on their computing device. In regard to a user subject matter voice command directive trigger, an AI assistant via an Interactive Voice Response (IVR) system and Automatic Speech Recognition (ASR) system may be used to analyze, understand, and interpret the subject matter spoken words so the system can respond appropriately. The AI assistant may analyze, understand, and interpret the subject matter voice command directives or spoken words and match it up against a matching sequence of words in a script associated with marketing objects of a scene or media file, match it up against keywords within a media file associated with marketing objects related to a scene of a script or program or repository or match it up against keywords only or match it up against subject matter voice commands associated with marketing objects and marketing objects not spoken in the voice command directive but is from the same scene though association. Both marketing objects related to the subject matter voice commands and marketing objects not spoken in the voice command, but are identified with the same scene through association, may both be associated with the same media file of a IAPP system or one or more virtual repositories of an IAPP system. One or more marketing objects within a media file and/or IAPP system may corelate, associate, or work in conjunction to each other to accomplish a goal and/or satisfy a directive when analyzed, understood, and interpreted by an AI assistant. For example, a user may be watching a movie called “Mother” and would like to know the red dress Jennifer Lopez is wearing right now and want the AI assistant to make the purchase for them. For a user to accomplish this, a user may use a subject matter voice command directive trigger “Hey SlinkIt (e.g. Wake call), can you tell me information about the “red dress” “Jennifer Lopez” is wearing in the movie “Mother” on “ABC Network” right now? The AI assistant may first analyze the entire directive to interpret the meaning of the directive and/or the subject matter actress or character name Jennifer Lopez, the red dress, the movie name “Mother” and the TV Network ABC and perform a search to determine if Jennifer Lopez is currently TV by search a TV guide associated with the IAPP system or virtual repository to determine a matching objects and a channel the user is watching, if her name isn't identified on TV right now, the AI assistant may send a message to the user that the item couldn't be found or search other networks like Netflix or Hulu for network identification, but if one or more words of the subject matter is identified to determine a match, then the AI assistant will determine a match and identify the marketing objects including the “Red Dress” associated the subject matter Jennifer Lopez, ABC, and the Movie “Mother” in the repository or IAPP system and send the red dress product details including a link to the user who initiated the voice command via a user interface on a computing device. The AI assistant via voice response may communicate back to the user with an interactive voice response the product details about the red dress including the brand name, retail information, pricing, possible discounts, a location, and store name to purchase in-person. The AI assistant may proceed with asking the user if the user wants the AI assistant to purchase the red dress for them. If told to proceed with a purchase, the AI assistant may continue with more conversation or interaction to determine size, color, and shipping address and method of payment via a user mannequin, or sizes pre-set in the repository for a user (e.g. User Account). The AI assistant may even apply discounts. The AI assistant may then continue with a complete purchase or transaction process including using user authentication and authorization via verbal code, voice biometrics/recognition, eyes, face biometrics, handprint, or fingerprint biometrics. User authentication and authorization may be required and initiated. All other marketing objects associated with a scene or scenes that are associated with the red dress, may also be presented or displayed to a user via a user interface on a computing device from the same voice command trigger. A user may also tell the AI assistant to just save the red dress (e.g. marketing object) for viewing later using the same subject matter voice command directive but adding the spoken word or utterance “Save” to the command. Voice command may enable voice control. Where the user may control a system via voice spoken words and/or speech recognition. Voice Commerce may be term used to access any third-party application or website through voice command subject matter directives to seek product or services and authorize a payment from media. As for an advertisement or information associated with people, places, or things as it pertains to a user subject matter voice command directive trigger, the AI assistant may analyze, understand, and interpret the subject matter voice command directive trigger, a location of the advertiser and the user that initiated the subject matter voice command to identify the marketing objects associated with the advertisement or information. User voice authentication and keywords or a code may be used as a key to authenticate a user and authorize the payment or transaction of a marketing item record via third party online stores or companies or data feeds associated with marketing objects within the centralized system or IAPP system. A matching logic via an AI fashion assistant could match clothes for a user to wear before filming a program based on a written or voice script. An AI assistant may be an expert in its perspective industry using machine learning. The AI assistant is an expert to its repository or repositories in with it learns from (e.g. AI cooking assistant, AI prop assistant) via machine learning.

Within the same invention, buying products in real-time from television or radio. Actions or directives can also be selected to interact with television to receive information from a particular product or service to buy from a phone instantly. Celebrities, promoters, designers, television networks, television shows (e.g., QVC) radio networks may use such functionality to promote their shows and the products featured in their shows. A user may be notified of the date and time that a televised or radio broadcasted event, performance or appearance is occurring, or a product is being displayed on TV or discussed on radio. The notification may include a calendar entry. Concomitantly, the system may include a list, for each show or program, of products that appear in the show or program by time and date. The list may be linked to the notification and calendar entry provided to the user. A television show's calendar may synchronize with the user's calendar on their phone in real-time or the system. When an action or directive is selected the product shown in real-time will have a control or options for the user to select in real-time on their phone displaying the product on one or more strips in order to make a purchase. Network or television programming and retailer's product details via data feeds, API, can be synchronized with the system within the invention and with a repository and user's mobile digital device, remote etc. even if coming from a satellite . . . . This synchronization can come with a trigger for the user to initiate for displaying products shown on television or heard on radio stations into their mobile digital devices, data feeds or calendars at the same time they are watching the television or listening to the radio. Each network, celebrity, personal stylist, designer, retailer, or any source will have a portal which has access to the repository of archived purchases or universal virtual closet for selecting items or products they want users to access for product details while they are on television or at events. Any source may select any item within the virtual household repository for wearing purposes or select something from the repository of archived products or household they want to display on others phones or digital device when those users or viewers trigger the show at the time the product is shown from synchronization or the time or timeframe the user is saying they or another user is wearing the products or items. For example, if a specific celebrity like Justin Bieber selects products from his virtual closet he is wearing today at 7 am and then selects the network and/or show he is wearing those products on, then anyone who inquiries about Justin Bieber, can know exactly what he is wearing on that show at that particular time and day. The celebrity (Fashion Advertising Model), just like any other source or Fashion Advertising Model will have a portal or Page that lets them select the products they are wearing today and the network, show, or event they are wearing it on or the location they are wearing it at, and the day and time they are wearing the products. Most celebrity location awareness will be determined by the calendar of the event the celebrity will be appearing. The chronological synchronized programming of the networks or television programs may be synchronized with user's mobile digital devices. User's may be alerted, prompt, or notified on products or services associated with marketing or consumer directives during or prior to commercials coming on television or the radio for viewing or purchasing purposes. Companies, advertising agencies, or any company may have their products or services shown on a television show, movies, news, and commercial synchronized networks programming time slots 24/7 and their data feeds or portals to these products and services in the centralized computing system of all things. Once a television show or radio commercial, event, or product is triggered, a list can appear with images showing products on that particular program, show, or movie for the user to select. These images and product details will also trigger the data feed or portal or website matching the products that particular hour or time shown with the products or services within the centralized computer system, central computing system, or repository. The process is chronological synchronized between all devices, all consumers, network programming systems, data feeds, and portals. The networks may also be issued a data feed from companies for product syncing with their programming. Companies or networks during producing or prior to airing of the shows, events, news, or movies may have their own portal and website where they could list products they purchased from another storefront or the centralized repository within the invention. Within the centralized repository of products from multiple data feeds from various companies, the producers, directors or Production Companies of the shows or networks can access the website or application to purchase products they will be using in the production of their show, programming event, news event, or movie. Once the products are purchased, these products will be categorized, archived, or save within their inventory within their own website of purchased products. Once the products are categorized, any company, network, producer, director, or production company can access or select any product they will be using on their show, event, news, or movie before or during production or filming, and/or they could select products that will be shown during programming prior to the program being aired on television or radio. Within the production companies, networks, producers, or director's account or website, they will have a matching interactive synchronized chronological calendar of programs being aired, to that of the television or radio networks calendar of programs being aired. The purpose of this is so these producers, directors, or Production Company, or networks could match up the products being displayed on the particular show and synchronize it with the time and date the actual show, movie, or event will be shown or aired. Once again, all consumers will have a trigger to synchronize to the program to display the products they are viewing, inquiring, or want to purchase. Each product displayed comes with product detail information, a price, and where it can be purchased. Products can display by selecting the show anytime or during the time shown or trigger of the mobile digital device synchronizing with the television set or radio station. In this invention, commercials, shows, movies, events, and news are equal to or the same as video, video data, video streaming when delivering or distributing advertising, content, products or services to the user, customer, or consumer. Each company, production company or producer or director will have to sign up for an account to the centralized system and repository of products as described in the invention.

Data may be supplied to the database through other sources. As an example, a data feed may be provided for the database to receive updated data from supplier (e.g., vendor and/or designer) data sources (e.g., databases). By way of example and not limitation, a CSV data feed may be used to load a CSV file to load product information from a supplier's database. The file may contain all data for all products from the supplier's database. Alternatively, the file may contain data for products that have changed since the last CSV file provided.

Data may also be supplied to the database through synchronization or asynchronous. One-way file synchronization, i.e., mirroring, may also be employed to update data copied into the database from a supplier's data sources. Consistency among data from a supplier's source to the target data storage may be established by timestamp synchronization. In this implementation, all changes to the source data are marked with timestamps. The time of all synchronizations are stored, at the source, at the target or at both locations. Synchronization may proceed by transferring or displaying all data with a similar timestamp. Video programs and audio programs may also be synchronized with a user repository including being synchronized with a computing device user interface. The computing device user interface in essence becomes an exact virtual representation of the video or audio program in timecode synchronization and scrolling in synchronization with the program displaying item records or marketing objects from a media file associated with a virtual repository that is associated with the video or audio program. For example, a user could watch television and have their smartphone user interface displaying items from a TV show in exact synchronization that the items are being shown on the TV show. Exact may not always mean exact. The user smartphone or any computing device may become synchronized with a video or audio program with but not limited to an account with the TV Network or Satellite provider, streaming company, or from a third-party account that is associated with the tv network, satellite provider or streaming company and with the methods described in the invention. An event may become synchronized as well and an item may be curated in real-time to match the program, this may synchronize with the event in-person while watching the event live.

A supplier or business may also provide a portal (e.g., an enterprise information portal) (EIP), as a framework for making product information available, managing marketing directives, managing consumer directives, and satisfying directives. An administrator of a system according to principles of the invention may access the supplier's data through the supplier's EIP. Additionally, a system according to principles of the invention may automatically access the supplier's data through the supplier's EIP, such as by using a crawler to systematically browse the portal to update indexes and data in the database. Web Crawler or bot may also browse the internet or website for source data or user data. Web Crawler or bot may act with a directive to automatically populate a virtual repository or database with website information, user data, data feeds, media files with or without time or dated related content or information. A bot and web crawler (e.g. AI Bot, AI web crawler) may be controlled or driven by artificial intelligence to perform task not limited to indexing, searching, purchasing, assigning, evaluating, learning, interpreting or a combination thereof using little or no user intervention. All bi-directional directives and matching of all directives to the user, consumer, marketing object, object, object record, item, subject matter, company, vendor, source or purchasing system may also be systematically generated, suggested, recommended, notified, distributed, or satisfied using a graphical (Graph) database such as an AWS Neptune database, Mongo database, or virtual repository of a combination thereof.

Time, time information, time stamp, time code, and time data, as used herein includes a timestamp, which is data that indicates the date and time at which a particular event occurred and may be represented in a standardized format, such as Unix time (the number of seconds elapsed since Jan. 1, 1970, UTC), ISO 8601 (a standardized date and time format), or in a custom format specific to the application or system; and also includes time codes represented as a sequence of numbers or characters that encode hours, minutes, seconds, and frames, the format of which can vary depending on the standard or system being used, such as SMPTE time code (Society of Motion Picture and Television Engineers), MIDI time code (Musical Instrument Digital Interface), and LTC (Longitudinal Time Code).

Time data may be used to determine a program, scene, event, movie, location of an individual user or user data or establishment, or other time related occurrence. The determined subject matter may then be correlated to one or more records of the virtual repository for a response.

Time is determined. The time is the time at which the trigger was activated. The time may be determined from a system clock on the computing device on which the trigger was activated. Additionally or alternatively, time may be determined from another source, such as, but not limited to GPS signals. Each Global Positioning System (GPS) satellite contains multiple atomic clocks that contribute very precise time data to GPS signals. GPS receivers decode these signals, effectively synchronizing each receiver to the atomic clocks. This enables very precise timing.

In the matching engine on the remote computing system, the type of media file(s) is determined. Such a determination may be made by file extension and/or playback. The media file is then processed to produce a fingerprint or signature (collectively a “signature”). A file may be uploaded manually. A file may be uploaded and analyzed without fingerprinting. The signature may be determined using any fingerprinting or signature methodology including those described above.

In matching, extracted and encoded data, signatures, fingerprints, and/or features are compared against a database of known sources or enrolled templates. Various similarity metrics, such as Euclidean distance, cosine similarity, or chi-square distance, may be used to measure the similarity. A match is determined based on the closest match or a predefined threshold. The outcome of this step is a match with a stored value, id or other subject matter that is related to one or more records in the virtual repository.

A response or result is then generated. The response is transmitted to the computing device of the user who activated the trigger. The response may be a functional response, which includes a link, pictogram, information associated with marketing objects and item records, users, advertisement, questions, answers, bios, calendar object or one or more other user-actuatable objects.

Computer calendaring allows users and/or Artificial Intelligence to view, create, edit, and manage their schedules. Calendaring software stores schedule information in a structured format, typically in a database or file system. This data includes details such as event titles, dates, times, locations, descriptions, and any associated reminders or alerts. Users can create new events, recommendations, or appointments by entering relevant information into the calendaring software. This information may be entered manually through a user interface or imported from other sources, such as emails, contacts, external calendars, or responses as described herein. The invention may work with most calendaring software and services. The calendaring software handles date and time management, allowing specification start and end dates and times of events, as well as recurring patterns such as daily, weekly, monthly, or yearly occurrences. The calendaring software provides notifications and reminders to alert users about upcoming events, appointments, or deadlines. These notifications can be delivered through various channels, including pop-up alerts, emails, SMS messages, or mobile app notifications. In one embodiment, a response includes a calendar object which includes data for calendaring, e.g., an event file or one or more listings from a television guide API or file, which includes structured data representing various attributes of an event or television program such as the title, date and time, location, description, attendees, cast, price, ticketing options, and any associated reminders or alerts. An event or television listing (e.g. TV guide) file may be in iCalendar (.ics) format, in vCalendar (.vcs) format, in Microsoft Outlook Calendar (.msg, .pst) format, in Google Calendar format (.xml, .ical, .json), in more than one format, and/or in a format that works with a calendar software identified by a user or detected on the user's smartphone or tablet from default app settings. Any database or repository in this invention may be stored as, uploaded with, or populated with a CSV file, an XML file, JPG file, WMP file, Json file, MP4 file, wave file, Doc file, PDF file, a flat file, or in other formats. Each file may contain media information including media data from a photo, video, audio, and advertisement or use information. A system or AI assistant according to principles of the invention may read from, write to, and modify, via the web, calendar data for calendar (e.g., Google Calendar) services that provide external access to data and functionality through an API (e.g., the Google Data Protocol). Thus, for example, a user's calendar may be updated to indicate when a pending aggregate directive expires, the date(s) and time(s) for fulfillment of an aggregate directive accepted by a supplier, and reminders for approaching deadlines. Calendared data may include text, graphics, any of which may comprise hyperlinks to other text, graphics, audio and/or video data, files, or streams.

System generated recommendations and predictive analysis based on purchases, calendar info, schedules, media files, virtual repository, websites, users, artificial intelligence, semantic intelligence, and machine learning. Recommendations, suggestions, reminders can be based off any topic, information, industry, advertisement, databases, repositories product and services from the centralized system. The universal centralized system is a system combined or connected to one or more item records or marketing objects associated with one or more repositories and/or databases associated with one or more users associated with media.

In this invention, one or more written words in a singular term may have the same meaning as a plural term as vice versa. Repository may have the same meaning as a database and vice versa. Resting location is location data associated with the user's current location or home location via GPS/Latitude longitude coordinates from the user's assigned computing device. Travel location is a future location, or a confirmed location associated with travel plans, travel confirmation, or a destination outside the home location. For example, if a user lived in Los Angeles and traveled to New York, New York will become my travel location for the dates and times of the trip. Location information is determined by GPS/Latitude and Longitude coordinates via a computing device. All marketing objects and data feeds may be associated with GPS/Latitude Longitude coordinates, and/or a physical street address of an establishment or building, and/or a city, state, country, and zip code. A computing device is associated with one or more computing systems. A user profile may be associated with a user's ethnicity, gender, date of birth, preferences, directives, and location information including a time zone.

### BRIEF DESCRIPTION OF THE DRAWINGS

The foregoing and other aspects, objects, features and advantages of the invention will become better understood with reference to the following description, appended claims, and accompanying drawings, where block diagrams and flowcharts for the AI-Driven Lifestyle Orchestration System conceptually illustrate the components and operational steps of the Automated AI-Driven Lifestyle Orchestration System and provide visual aids help to clarify the interactions between hardware, software, AI components, and user actions.

FIG. 1 provides a first portion of a system architecture overview block diagram that conceptually illustrates main components of the system and their interconnections in accordance with principles of the invention.

FIG. 2 provides a second portion of the system architecture overview block diagram that conceptually illustrates main components of the system and their interconnections in accordance with principles of the invention.

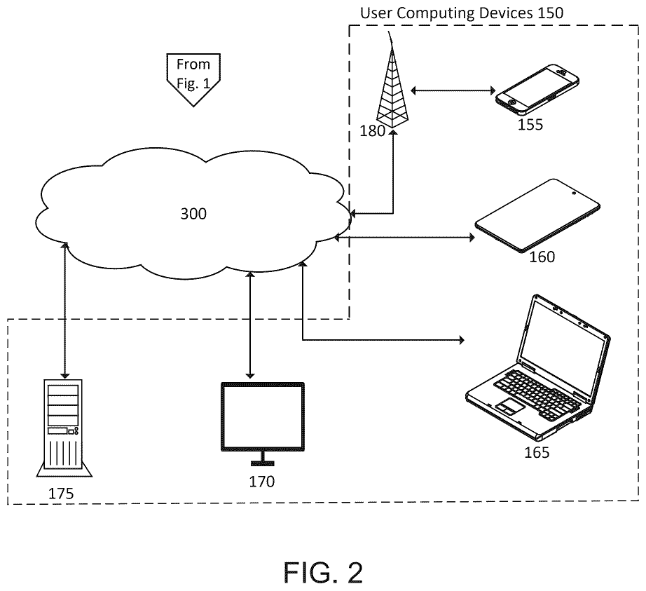

FIG. 3 provides a third portion of the system architecture overview block diagram that conceptually illustrates main components of the system and their interconnections in accordance with principles of the invention.

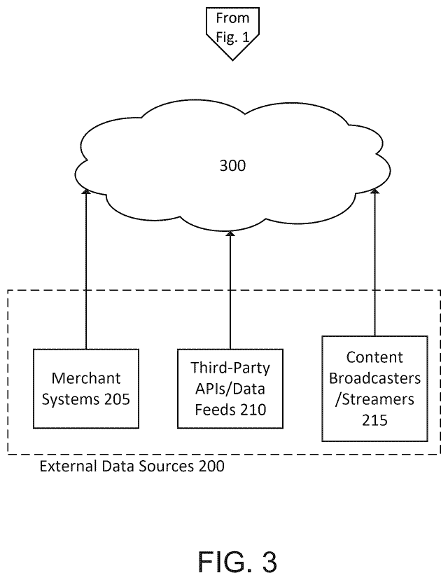

FIG. 4 provides a virtual repository management flowchart that conceptually illustrates steps of creating, populating, and managing a user's virtual repository in accordance with principles of the invention.

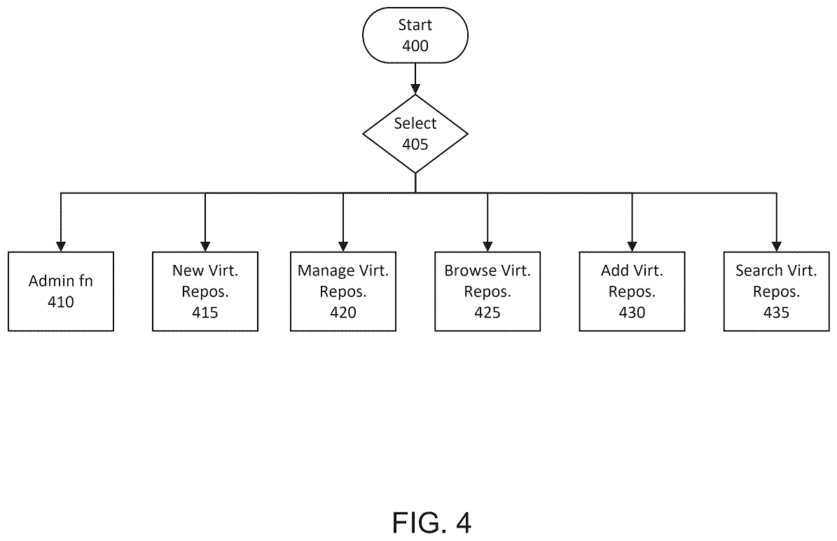

FIG. 5 provides a triggering and matching process flowchart that conceptually illustrates a sequence of steps from a user initiating a trigger to receiving a functional response in accordance with principles of the invention.

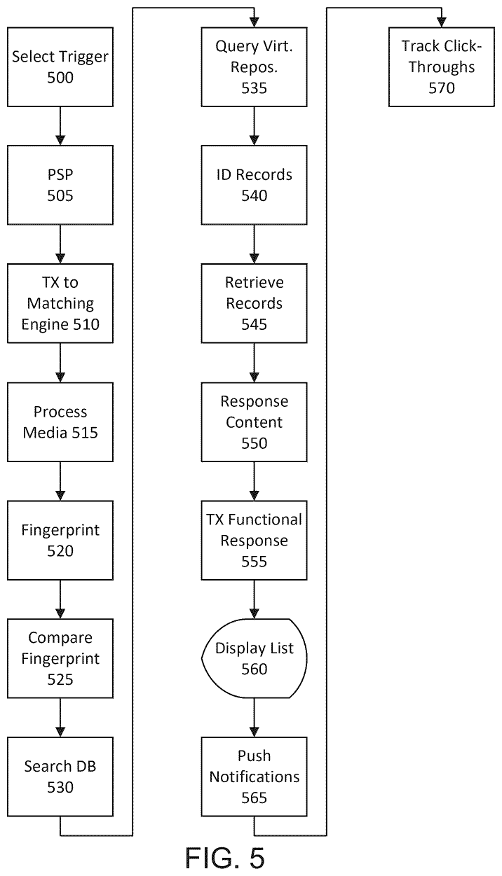

FIG. 6 provides an AI-driven scheduling and lifestyle orchestration flowchart that conceptually illustrates steps of the AI assistant proactively managing a user's schedule and delivering personalized recommendations in accordance with principles of the invention.

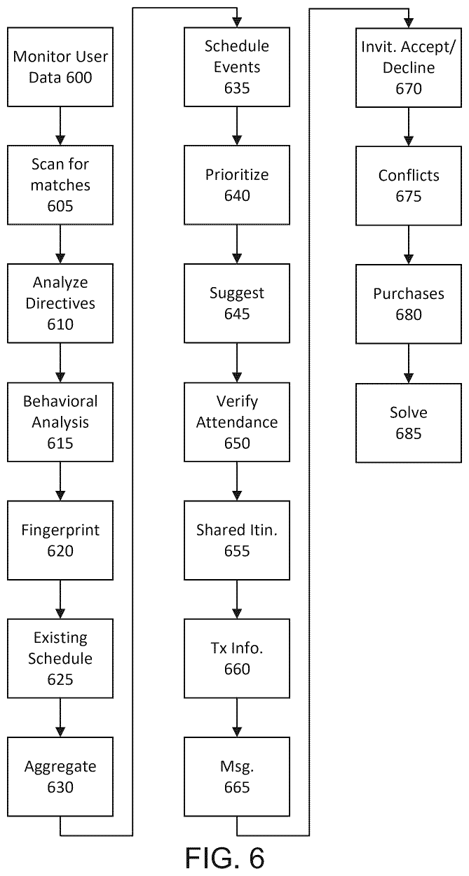

FIG. 7 provides a data flow and system integration block diagram that conceptually illustrates the origin and flow of different data types into and out of the centralized system, illustrating how various components interact for data ingestion, processing, and delivery in accordance with principles of the invention.

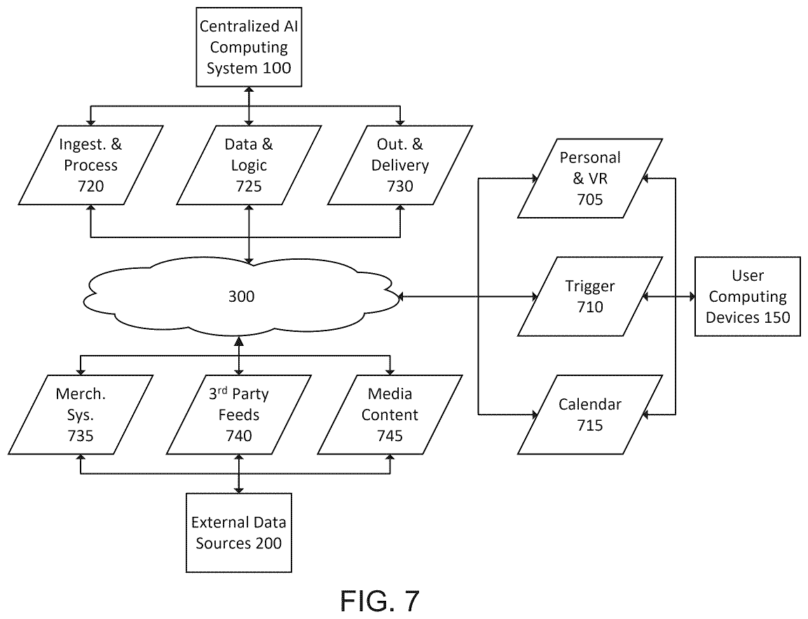

Those skilled in the art will appreciate that the figures are not intended to be drawn to any particular scale; nor are the figures intended to illustrate every embodiment of the invention. The invention is not limited to the exemplary embodiments depicted in the figures or the specific components, configurations, shapes, relative sizes, ornamental aspects, or proportions as shown in the figures.

### DETAILED DESCRIPTION

This invention presents a sophisticated Automated Personal AI-Driven Lifestyle Orchestration System 100, meticulously engineered to proactively manage a user's intricate calendar and dynamic daily life. Its core innovation lies in its ability to intelligently deliver and strategically schedule marketing objects 115 within a seamlessly integrated digital ecosystem. This capability is fundamentally achieved through a complex orchestration of location-based, system-generated triggers 500, continuously activated and contextualized via a user's diverse computing devices 150, which intelligently leverage granular marketing object location data in real-time. At the very heart of this system resides a powerful AI computing processing engine 105. This engine is not merely a reactive processor; it is designed to meticulously interpret, semantically analyze, and continuously learn from a vast array of incoming data streams. These streams include detailed files associated with external source data feeds, dynamic user locations intrinsically linked to user-defined and inferred directives 110 (which precisely encapsulate a user's preferences, explicit voice commands, and inferred interests), and comprehensive, evolving user profiles. The proactive calendaring of matching marketing objects 115 is not a static process; instead, it is dynamically and continuously influenced by a complex, multi-faceted set of factors. These include real-time consumer directives 110, continuously updated product reviews, emerging popularity trends, and a myriad of external source data files/feeds 210, including highly specific and targeted marketing directives 110 issued by third-party entities. The calendar population within this system operates across a dual operational paradigm: it can indeed function reactively, based on explicit consumer manual input or direct voice commands (e.g., “Schedule a haircut for me on Friday”). However, its truly transformative capability lies in its proactive mode, driven by sophisticated, continuously operating, location-based triggers 500. These triggers intelligently match marketing objects 115 to complex patterns derived from consumer directives 110 and learned preferences, cross-referencing them against an expansive, constantly updated, and comprehensive database 125, which may also include a personalized user repository 125. These marketing objects 115 are broadly defined to encompass an exceptionally wide spectrum of information, including, but not limited to, real-time TV listings, precise geographical places of interest, tangible items (e.g., products, apparel), detailed television program metadata, comprehensive product information, interactive hyperlinks to external resources, precise timestamps, dates, times, granular user demographic and behavioral data, and extensive service information. Crucially, each trigger 500 is consistently and intrinsically associated with a computing digital device (e.g. smartphone, smart TV, computer, smartwatch, smart glasses,) 155 or other active user computing device, which serves as a ubiquitous sensor and interaction point. This seamless association enables the AI assistant to not only query for exact matching data from a user's highly personalized and dynamic virtual repository 125 but also to concurrently access and synthesize information from a vast, continuously updated database 125 comprising aggregated source data, real-time data feeds 210, and prevailing marketing directives 110. This profound combination of proactive, context-aware intelligence, ubiquitous sensing, and highly personalized data synthesis represents a fundamental, non-obvious, and technically advanced improvement over existing systems. Prior art solutions are typically confined to reactive responses, lack the deep contextual understanding to anticipate complex user needs, and are inherently limited by fragmented data sources and disjointed personal organization tools. The invention's unique anticipatory capability, achieved through this intricate AI orchestration, directly addresses the technological problem of fragmented, inefficient, and often overwhelming personal information management, transforming it into a seamless and intelligently managed lifestyle.

### System Architecture and Core Components

The robust, scalable, and extensible capabilities of this system 100 are intrinsically derived from its flexible implementation, which can be manifested through various combinations of dedicated hardware, specialized software (including high-performance firmware, finely tuned micro-code, and custom-designed microchips), or a sophisticated hybrid approach. The invention can also be embodied as one or more computer program products tangibly residing on non-transitory computer-usable or computer-readable storage media. Such media encompass a wide array of cutting-edge technological formats, including advanced electronic storage (e.g., high-speed solid-state memory), magnetic storage (e.g., enterprise-grade hard disk drives, magnetic tapes for archival), optical storage (e.g., Blu-ray discs, holographic storage), electromagnetic storage (e.g., propagated signals in a network), infrared, or advanced semiconductor technologies. Specific, non-limiting forms include high-bandwidth Random Access Memory (RAM), Read-Only Memory (ROM), Erasable Programmable Read-Only Memory (EPROM), high-capacity Flash memory, high-performance hard disk drives, ultra-fast solid-state drives (SSDs), and various forms of optical discs. All intricate algorithms, executable code modules, complex memory structures, robust data storage mechanisms, distributed data repositories, advanced graphics rendering processes, and sophisticated artificial intelligence components can be stored, managed, or directly utilized within a specialized microchip, either individually or in a tightly integrated, System-on-Chip (SoC) configuration. These custom-designed microchips are not generic processors; they are specifically engineered to be equipped with exceptionally powerful, task-optimized processing units. This includes dedicated Graphics Processing Units (GPUs), which excel in parallel processing for rapid visual rendering and complex neural network computations; Tensor Processing Units (TPUs), purpose-built accelerators specifically designed for dramatically speeding up machine learning workloads, particularly neural network training and inference; and Language Processing Units (LPUs), specialized AI processors engineered for highly efficient and low-latency artificial intelligence tasks predominantly related to natural language understanding and generation. This advanced and often custom-designed hardware configuration is critical, enabling the system 100 to concurrently manage a multitude of complex AI assistant directives 110 and assignments with unprecedented efficiency and responsiveness. LPUs, in particular, represent a significant advancement, being sufficiently powerful and meticulously optimized to execute sophisticated Large Language Models (LLMs) at remarkably high speeds. This addresses and effectively overcomes traditional computing density and memory bandwidth challenges that typically plague conventional general-purpose processors when attempting to handle such demanding AI tasks in real-time. This architectural specialization profoundly enhances the system's 100 ability to deeply understand context, accurately interpret nuanced human language, and coherently generate natural language responses and actions, leading to significantly faster, more subtle, and highly accurate computing responses and AI duties. The overall computing processing and network communication systems 300 within the invention are architecturally designed from the ground up to seamlessly integrate one or more of these powerful, specialized processors (GPUs, TPUs, LPUs) into a cohesive distributed computing environment. This integration is optimized to efficiently complete complex, multi-modal tasks and to accurately interpret nuanced voice command directives 110, thereby ensuring precise results and effective assignment fulfillment with minimal latency. This intricate integration of specialized hardware with advanced software, coupled with the dynamic, real-time processing of vast, diverse data streams, represents a non-obvious and fundamental technical improvement over conventional, less integrated systems. Such prior art solutions typically rely on rigid rule-based programming, are limited by fragmented data sources, and suffer from the performance bottlenecks of general-purpose processing. The ability of the system 100 to continuously learn, adapt dynamically, and proactively manage a user's complex and evolving lifestyle through sophisticated AI-driven insights directly addresses the fundamental technological problem of fragmented, reactive, and often overwhelming personal organization tools. It enables a truly intelligent, anticipatory, and adaptive user experience that fundamentally transforms the nature of human-computer interaction from mere command-response to genuine ambient assistance. The computer program code necessary for carrying out the operations of the present invention can be written in any programming language compatible with the corresponding computing devices 150 and their operating systems, emphasizing that software embodiments are not tied to a particular language. This computer program code can be provided to a processor of a general-purpose computer, a special purpose computer, or any other programmable computing apparatus (e.g., a phone, personal digital assistant, virtual assistant, tablet 160, laptop, personal computer 165, or computer server) as executable instructions. When these instructions are executed, they create the means for implementing the functions described herein. The computer code can be stored in a computer-readable memory, directing the apparatus to function in a particular manner, thereby producing a manufactured article that implements the described functions and steps. This transformation of generic computing hardware into a specialized AI-driven lifestyle manager constitutes an inventive concept, as it imbues the apparatus with novel functionality that is significantly more than merely implementing an abstract idea.

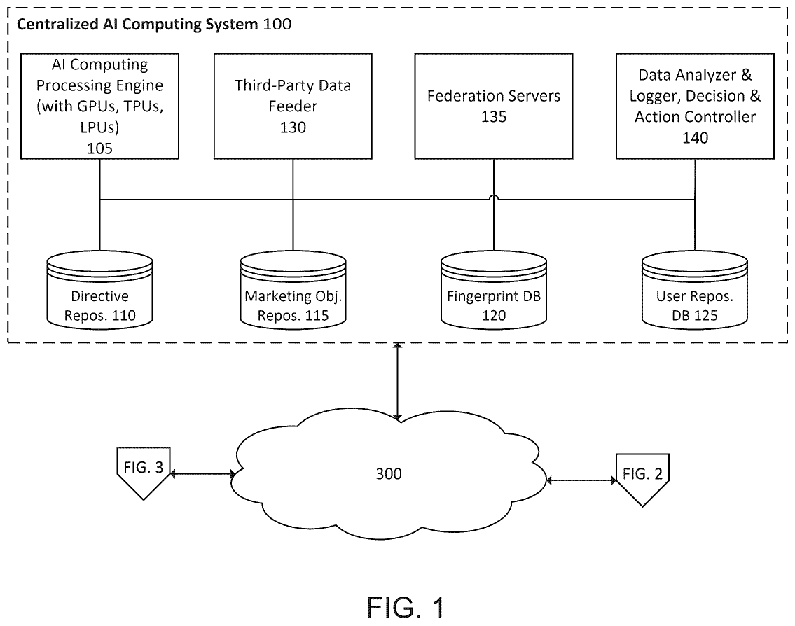

A high-level block diagram (FIG. 1) provides a conceptual overview of the system's 100 fundamental hardware components and their intricate interconnections within a distributed network environment. Users interact with the system 100 primarily through various computing devices 150, which serve as the primary client endpoints for data input and output. These devices are diverse and include, but are not limited to, cutting-edge smartphones 155, versatile tablets 160, powerful laptops, ubiquitous personal computers 165, high-performance desktops, and smart TVs 170. These client devices communicate seamlessly with the central system wirelessly (e.g., via Wi-Fi, cellular networks like 5G, Bluetooth) or via wired connections (e.g., Ethernet) over the expansive Internet 300. To facilitate robust interaction, these client devices are equipped with essential software, such as standard web browsers (e.g., Chrome, Safari), dedicated client applications (e.g., desktop software), or specialized mobile apps, all meticulously designed for intuitive inputting and displaying of information to the user. Many of these mobile devices 150 are specifically designed to include robust cellular wireless communication modules (e.g., LTE, 5G modems) to ensure continuous and ubiquitous internet access, even when traditional Wi-Fi networks are unavailable, thus maximizing system availability and responsiveness. While a significant portion of these computing devices 150 are directly utilized by end-users for the creation, access, and sophisticated management of their personalized virtual repositories 715, other specialized hardware endpoints play crucial roles. These include, for instance, modern point-of-sale (POS) systems at retail locations or dedicated backend servers, which are specifically employed by merchants 205 for automated data supply (e.g., transaction data, product availability), real-time transaction processing, or executing sophisticated backend computational tasks related to inventory and customer relations. This highly diversified and interconnected hardware interaction model, spanning from consumer-facing mobile devices to complex, enterprise-level merchant backend systems, is a critical enabler. It facilitates the seamless, secure, and bidirectional flow of information necessary for the system's advanced functionalities, thereby enabling real-time commerce, personalized service delivery, and comprehensive lifestyle orchestration across an extensive and dynamic network. This distributed architecture, capable of integrating disparate hardware and software environments, is a key technical differentiator from simpler, monolithic systems.

At the architectural core of the invention, one or more robust computers, typically in the form of high-performance servers, either directly incorporate or have high-speed, low-latency access to a sophisticated database management system (DBMS). A server within this distributed architecture might, for example, function as a federation server 135. In this role, it is responsible for coordinating data access, ensuring data consistency, and maintaining security across potentially disparate data sources and geographical locations. The central computer system 100 itself is architected as a complex, multi-component entity, purpose-built for high-volume, real-time data processing and intelligent decision-making. Its modular design can comprise distinct components such as a first federation server 135 (primarily for managing internal data flows, user authentication, and system health checks), a data analyzer 140 (responsible for advanced data interpretation, semantic understanding, and complex pattern recognition using various AI models), a data logger 140 (for meticulously recording all system activities, data states, and operational metrics for auditing and future model training), a decision data logger 140 (specifically for logging the inputs, outputs, and confidence scores of decision-making processes), a decision controller 140 (the central intelligent module that formulates proactive recommendations and initiates automated actions based on AI inferences), an action data logger 140 (for precisely tracking the execution status and outcomes of all initiated actions), an action controller 140 (the module responsible for executing determined actions by interfacing with relevant internal or external services), a second federation server 135 (dedicated to managing and authenticating secure data integrations with external third-party systems), a third-party data feeder 130 (a module or dedicated data pipeline for efficiently receiving, normalizing, and ingesting data from external sources), and a third-party controller 140 (for orchestrating complex interactions, API calls, and data exchanges with external systems). When a user creates or expresses a directive 110 (e.g., a voice command like “Find me a good Italian restaurant nearby,” or a preference selection like “follow this celebrity's style”) using their personal computing device 150, this directive 110 is securely transmitted to the central computer system 100 via the network 300, typically using robust encrypted communication protocols such as TLS/SSL (Transport Layer Security/Secure Sockets Layer) to ensure data confidentiality and integrity. The first federation server 135 then performs initial, rapid validation and verification of the directive's 110 authenticity and acceptability, ensuring it originates from an authenticated user and adheres to predefined system policies and user permissions. Upon successful validation, the directive 110 proceeds to the data analyzer 140 for comprehensive and often real-time analysis. This analysis is a computationally intensive process involving multiple specialized machine learning models: Natural Language Processing (NLP) models for parsing human language, Computer Vision (CV) models (e.g., CNNs) for image/video analysis, and semantic AI models for extracting deep contextual meaning, user intent, and relevant entities. The extracted insights and processed data are meticulously logged and stored within the central database 125, serving as valuable input for future AI model training and system optimization. Subsequently, the analyzed directive 110, now enriched with semantic understanding, moves to the decision data logger 140, where its processing state and intermediate analysis results are recorded, before being forwarded to the decision controller 140. The decision controller 140, leveraging sophisticated AI algorithms, complex rule-based engines, and real-time inference from learned models, determines if any related marketing objects 115, or other relevant information, are available that precisely match the user's directive, current context (e.g., location, time of day), and learned preferences. This decision-making process is highly adaptive and continuously optimized through reinforcement learning techniques. If such objects or information are identified with a high confidence score, the decision controller 140 initiates an automated action (e.g., sending the relevant marketing object 115 to the user's device, intelligently scheduling an event into their calendar, initiating a purchase via an e-commerce API). This action is then rigorously logged by both the decision data logger 140 (recording the specific decision made) and the action data logger 140 (recording the execution details and outcome of the action), ensuring a complete and transparent audit trail. Finally, the action is completed by the action controller 140, which interfaces with various external systems (e.g., third-party APIs for reservations, payment gateways) or internal modules to reliably deliver the intended outcome to the user. This rigorous, multi-component processing chain, involving real-time, AI-driven analysis, intelligent and proactive decision-making, and automated action based on deeply contextualized user intent, provides a robust, non-obvious, and technically advanced solution to the pervasive problem of efficiently matching ephemeral user interest with relevant commercial opportunities and lifestyle services, thereby profoundly transcending the limitations of static, reactive, or manually triggered marketing and personal management systems of the prior art.

To ensure the authenticity, integrity, and timely integration of information and marketing objects 115 obtained from diverse third-party sources 200 (e.g., large online retailers, dynamic event organizers, real-time content providers, social media platforms), the central computer system 100 incorporates a dedicated and robust external data management subsystem. This subsystem comprises a second federation server 135, a third-party controller 140, and a third-party data feeder 130. Data originating from external sources 200 is first securely transmitted (e.g., via RESTful APIs, Webhooks, or direct data pipes) to the second federation server 135 for stringent authentication and validation protocols. This critical step ensures that the incoming data is indeed from a trusted, verified source and meets predefined quality, format, and security standards (e.g., data schema validation, cryptographic signature verification). Upon successful authentication and initial parsing, this external data is intelligently directed to the third-party controller 140. The third-party controller 140, employing advanced data routing algorithms and potentially AI-driven data classification, determines its appropriate storage locations and optimized processing pathways within the system. This may involve directing the data to the third-party data feeder 130, which acts as a specialized staging area or a dedicated repository for external data, often residing within the main database 125 but logically segmented for efficient management and retrieval. The third-party data feeder 130 is designed to normalize incoming data into a consistent internal format, enriching it where possible with additional metadata. Subsequently, authenticated, normalized, and enriched marketing objects 115 can be efficiently retrieved from the third-party data feeder 130 and securely transmitted to the user's device 150 for display or interaction. This intricate data verification, routing, normalization, and integration mechanism is a critical technical improvement, enabling the system to reliably and dynamically integrate vast, diverse external data streams into a cohesive, trusted, and constantly updated platform. The system's ability to automatically pull verified and structured data from a third-party data feeder 130 into the central system 100 on an ongoing and often real-time basis significantly enhances its operational robustness, adaptability to new data sources, and the freshness and accuracy of the information it provides to users. This robust external data integration, a sophisticated undertaking, represents a non-obvious capability that distinguishes the invention from less comprehensive or manually curated data systems of the prior art.

One or more databases 125, forming the central knowledge base and memory of the system, contain meticulously aggregated data records or files pertaining to individual and shared virtual repositories 715. These databases are designed for high-performance querying, robust transactional integrity, and ensure data consistency across the distributed system. A highly available and robust communications network 300, which encompasses both local area networks (LANs) within data centers and wide area networks (WANs) like the public Internet, securely connects the central server infrastructure, either directly or indirectly, to end-user computing devices and external data sources. Data Sources may be any company or user selling goods and services. Interconnected computing elements and modules within the overall system 100 communicate seamlessly and efficiently through various low-latency and high-throughput mechanisms, including interprocess communication (IPC) for intra-server communication, remote procedure calls (RPCs) for inter-server communication, and distributed object interfaces (e.g., DCOM, CORBA, or modern microservices architectures) for highly modular and scalable interactions. Databases 125 are securely stored on one or more geographically distributed and/or redundant storage devices (often referred to as data storage clusters) to ensure high availability, fault tolerance, and disaster recovery. These databases can be efficiently queried and managed using various standard and proprietary database access means, such as Structured Query Language (SQL) for relational databases, or specific APIs for NoSQL databases, alongside standard protocols like Open Database Connectivity (ODBC), DCOM, or CORBA. A client device 150, executing its application, can initiate secure processes that interact with the central server infrastructure to supply, access, and manage data within the virtual repositories without compromising the overall database 125 integrity, thanks to robust transaction management, granular access control lists (ACLs), and data validation mechanisms. In addition to housing user-specific virtual repositories 715 and aggregated marketing object data, the data storage components also contain a dedicated database 120 of media (audio/video) fingerprints corresponding to various types of content, such as streamed programs, broadcast shows, movies, and advertisements. This fingerprint database is crucial for real-time content identification and is optimized for extremely fast lookup operations. The robust, secure, and flexible data management and communication framework described underpins the system's ability to handle vast amounts of real-time media and user data, which is a significant technical hurdle in enabling proactive lifestyle management by ensuring data consistency, high availability, efficient accessibility across the entire network 300, and secure data handling. This integrated data infrastructure, capable of managing both user-generated content and externally sourced content with high fidelity and at scale, represents a non-obvious and technically superior departure from simpler, siloed database systems of the prior art.

The various databases and repositories described herein, while functionally distinct, are architecturally flexible. They may comprise physically distinct, separate databases, or they may be logically or physically combined into one or more consolidated databases for efficiency and ease of management. Alternatively, they may comprise partitioned segments or distributed parts of larger, enterprise-wide database systems. Thus, by way of example and not limitation, a participant database (storing information about individuals associated with media) may be seamlessly combined with a virtual repository (storing items owned/used by individuals). Similarly, a watermark database (for imperceptible content identifiers) and a fingerprint database (for derived content signatures) may be integrated into a single, multi-purpose media content identification database to streamline lookup operations. Therefore, the term “database” as used in this detailed description should not be construed to be limited to a distinct, separate physical database instance, but, rather, may include any logical or physical data storage construct that includes tables, schemas, data models, and relationships required to provide the described functionality, regardless of its underlying physical distribution, partitioning strategy, or specific DBMS technology used. This flexible and scalable database architecture is crucial for supporting the system's ability to handle massive data volumes and diverse data types while maintaining high performance and reliability.

### Media Processing and Real-Time Object Matching

Users 150 initiate real-time content analysis and object discovery by selecting a trigger 500 via a dedicated application (app) installed on their portable computing device 150, such as a tablet 160, smartphone 155, or smart TV 170. This trigger 500 is not a generic capture button; it is intelligently designed to be contextually aware, capable of being directed at various specific targets in the user's environment. These targets can include, but are not limited to, a live television program playing on a screen, a movie being viewed in a theater, audio emanating from a radio broadcast, a person observed in a public setting or at a specific event, or even a static 2D matrix code (e.g., a QR code on a poster). Upon activation, the trigger 500 automatically and instantaneously generates a Percipient Sample Pack (PSP) 505. The PSP 505 is a specially structured and timestamped data packet designed to encapsulate the user's immediate context and the captured target media. Each PSP includes essential metadata: secure user identification (e.g., an encrypted user ID to maintain privacy), precise location information (e.g., real-time GPS coordinates, Wi-Fi triangulation data, or IP-based location estimates), accurate time information (a high-resolution timestamp of the capture event), and the actual captured media 505 itself, which can be recorded audio, video, and/or high-resolution still photographs of the target. The application 400 providing this functionality is highly configurable, allowing the user to explicitly select whether to capture only audio, only video, or a combination. Alternatively, the system can intelligently determine the optimal capture mode based on the identified target and prevailing environmental conditions (e.g., prioritizing audio in low-light conditions, or video for static objects). The “target” itself is the specific subject of the user's interest within the media or environment, which can be a live broadcast television program, a streamed program (e.g., from a subscription service like Netflix or Hulu), or content from any other multimedia source. The captured media 505 specifically isolates and represents the portion of the content that has piqued the user's interest, such as specific participants in a scene, their particular attire, or distinct objects displayed prominently within the media. In many real-world scenarios, captured audio is often preferred for initial processing due to its inherently lower bandwidth requirements compared to high-definition video, making its transmission faster and more efficient. Furthermore, audio capture is less sensitive to environmental factors like direct line of sight or challenging lighting conditions that can significantly degrade video quality. The intelligent and automated creation of this PSP 505—a highly structured, context-rich data pack containing synchronized multimodal sensory input—is a novel and non-obvious technical solution. It directly addresses the significant and long-standing problem of efficiently capturing and contextualizing ephemeral user interest in dynamic, real-time media environments, a persistent challenge in developing truly interactive and commerce-enabled content experiences. This process goes far beyond simple data collection; it is a dynamic, context-aware packaging of critical information that enables subsequent, highly intelligent processing at an unprecedented level of detail and relevance, forming a foundational element of the invention's patentability.

Once a PSP 505 is accurately generated and prepared, the smartphone application securely transmits this data packet to a remote computing system 100. This remote system hosts the sophisticated media identification module (matching engine) 510, which is comprised of one or more specialized computer programs and advanced machine learning models designed for high-performance, real-time media analysis. Upon receiving the PSP 505, the matching engine 510 initiates a multi-stage processing pipeline to identify the captured content. First, it performs an initial analysis of the captured media 505 to determine if it contains an embedded digital watermark. Concurrently or as an alternative identification method, the engine generates a unique fingerprint 520 of the captured media 505. When the captured media 505 is a video stream (e.g., recorded from a television screen, a projector, or a digital signage display) or an advertisement, the matching engine 510 performs crucial video cropping operations. This involves intelligently detecting the precise boundaries of the broadcast or streamed video content within the captured frame (e.g., automatically identifying and removing television screen bezels, detecting, and eliminating black bars from aspect ratio mismatches, or isolating the primary content area from other extraneous environmental elements). By performing this intelligent cropping, the subsequent fingerprinting process can focus exclusively on the relevant, in-frame recorded segment, thereby significantly improving the accuracy of the content identification and dramatically enhancing computational efficiency by reducing the amount of irrelevant data to process. This invention supports various advanced cropping methodologies, including real-time detection of regions of interest based on dynamic visual cues (e.g., identifying and tracking moving objects, detecting significant pixel color changes or motion vectors across contiguous frames). These techniques often leverage sophisticated computer vision algorithms and pre-trained deep learning models (e.g., object detection networks). Critically, similar dynamic cropping techniques can also be applied to the reference fingerprint databases offline to ensure consistent processing and comparison. The integration of media cropping directly into the real-time fingerprinting pipeline represents a non-obvious technical improvement, as it significantly enhances the accuracy and efficiency of content identification by minimizing irrelevant data and noise. This constitutes a substantial technical improvement over less refined methods of the prior art that may struggle with extraneous visual information or environmental clutter, frequently leading to false positives or missed matches. This selective and intelligent processing ensures that only the most pertinent information is used for matching, thereby optimizing system resources, reducing computational load, and enhancing the overall precision and reliability of content identification in diverse real-world environments.

A watermark, as specifically utilized in this invention, constitutes an imperceptible digital signature, typically an audio signal, that is digitally embedded within a program's primary audio or video stream. This watermark serves as an exceptionally robust and covert mechanism to precisely track content distribution from its original point of generation (e.g., a broadcasting station, a content delivery network server, or a studio mastering suite) to its final consumption destination (e.g., a user's computing device). The embedding process involves inserting a unique content identification code (e.g., a second-by-second serial number that increments throughout a program, a unique broadcast ID, or a specific show/episode identifier) at a central distribution center or a content origin server. This code is then transmitted by subtly modulating carrier wave signals, such as inaudible sounds within the ultrasonic frequency range of the audio spectrum, or by imperceptible pixel manipulations within the video stream that are carefully engineered to be indiscernible to the human eye or ear. Upon capture by the user's device, the matching engine employs specialized signal processing algorithms to demodulate the appropriate frequency range of the captured sounds (or analyze the video for embedded patterns) to robustly extract this hidden code. If a watermark is successfully detected and extracted, it is then demodulated to yield the modulated information, which directly provides the precise content identification code. The program (e.g., a specific show, movie, TV commercial, or live event) can then be swiftly and unequivocally identified by cross-referencing this extracted code against a dedicated database 120 that stores known watermarks and their corresponding program metadata. This method often provides a highly precise timing component, indicating the exact segment, scene, or time-slice of the program being viewed (e.g., “Season 3, Episode 5, at 17 minutes and 32 seconds”). Notably, this system is engineered to work seamlessly with dynamic, real-time content, including live broadcasts and continuously streamed content, which can incorporate real-time watermarks to enable precise, frame-level tracking of content distribution using continuously updated unique content identification codes. The utilization of these sophisticated watermarks provides an exceptionally robust, low-latency, and highly efficient mechanism for content identification, representing a significant and non-obvious improvement over less reliable methods of the prior art that might be adversely affected by signal degradation, external acoustic or visual noise, or rapid changes in environmental conditions. This ensures reliable and precise content matching, offering a higher degree of fidelity and speed for content creators, advertisers, and distributors by significantly reducing false positives and errors common in less robust content tracking and identification systems.

A dedicated local database 120 of program fingerprints 520 (e.g., for extensive libraries of shows, movies, broadcast programs, or events) stores unique digital signatures meticulously derived from the content itself. Each program within this comprehensive database may have multiple associated fingerprints 520, carefully crafted to correspond to different segments, scenes, or time intervals of the content. This allows for fine-grained identification within a longer piece of media. The system employs a standardized, highly robust, and computationally efficient method for generating these reference database fingerprints. Crucially, the exact same method for fingerprint generation is then consistently and dynamically applied to generate a fresh fingerprint 520 for the captured media 505 contained within the PSP 505. This consistency ensures reliable comparisons. This newly generated fingerprint 520 for the captured media 505 is then subjected to a high-speed comparison against the vast collection of database fingerprints to identify a match 525. Upon a successful and confident match, the system precisely identifies the program and its corresponding specific portion (e.g., a particular scene, a specific timestamp within an episode). A fingerprint 520 serves as a unique proxy or abstract digital signature derived from the inherent acoustic or visual characteristics of the captured media 505, enabling its comparison to a predefined set of reference fingerprints. When a substantial match is found, typically determined by exceeding a predefined similarity threshold (calibrated for accuracy vs. robustness), the program and its specific portion can be identified with a high degree of statistical probability and confidence. The invention is not limited to a singular specific fingerprint methodology; instead, it is adaptable to any technique that efficiently and robustly generates unique and discriminative fingerprints 520 for both captured media 505 and reference program segments. Similarity searching, a core component of the matching process, often employs various distance functions (e.g., Euclidean distance, cosine similarity, Hamming distance for binary fingerprints) to quantify the dissimilarity between fingerprints. This enables the system to find “similar” objects within the database 125. This means identifying objects whose dissimilarity is below a specified, dynamically adjusted threshold, or, in the absence of an exact perfect match, identifying the least dissimilar objects that still meet a relevance criterion. The distance function effectively measures dissimilarity, such that retrieving a more similar object implies retrieving one with a lesser calculated distance. To handle the immense scale of media content (potentially millions of hours of audio/video), the fingerprint database employs advanced indexing structures (e.g., inverted indices for feature hashing, k-d trees for multi-dimensional data, Locality-Sensitive Hashing (LSH) for approximate nearest neighbor search). These indexing techniques significantly accelerate the search process, reducing the need for exhaustive comparisons and enabling real-time performance. This sophisticated, multi-stage fingerprinting and matching process directly addresses the critical technical challenge of accurately identifying specific, ephemeral content segments from noisy, partial, or real-world user-captured media-a significant and complex challenge in conventional content recognition systems that often yield inaccurate or irrelevant results due to environmental variability or incomplete data. By providing a high-precision, robust, and real-time content matching capability, this invention substantially improves the overall utility and actionable insights derived from user interaction with dynamic media, representing a non-obvious and highly valuable technical advancement.

An exemplary audio fingerprinting method employed by the system is meticulously designed to convert a raw audio signal into a robust, compact, and unique sequence of relevant features, capable of resisting various real-world distortions encountered during capture (e.g., background noise, reverberation, codec compression). This process typically involves several computationally optimized and sequential steps, each contributing to the robustness and discriminability of the final fingerprint:

Preprocessing: The initial audio signal, whether analog (e.g., from a microphone) or digital, is first digitized (if necessary) and formatted into a standardized digital representation. This critical initial step includes resampling the audio to a consistent sample rate (e.g., 44.1 kHz, 16 kHz) and converting it to a uniform bit depth (e.g., 16-bit PCM). These steps normalize the input for subsequent processing.

Framing and Windowing: The continuous audio stream is then divided into a series of short, often overlapping, frames of a predetermined duration (e.g., 20-30 milliseconds, with 50% overlap). A window function (e.g., Hamming window) is applied to each frame to minimize spectral leakage and ensure smooth transitions between frames. This framing allows for localized analysis of the audio signal's spectral characteristics over short time intervals.

Linear Transformation: A linear transformation, typically the Fast Fourier Transform (FFT), is applied to each framed segment. The FFT converts the audio signal from the time domain to the frequency domain, generating a spectrum that reveals the distribution of energy across different frequencies within that frame. This spectral representation is crucial for extracting frequency-based features and significantly reduces data redundancy compared to raw time-domain samples. Alternatively, the Discrete Cosine Transform (DCT) could be used, providing similar benefits.

Feature Extraction and Dimensionality Reduction: From the frequency-domain data, specific feature vectors are extracted to reduce dimensionality and increase invariance to common audio distortions. This is a critical step for robustness. Examples include:

Mel-Frequency Cepstrum Coefficients (MFCCs): These are widely used as they mimic the non-linear human auditory perception of frequency. The process involves mapping the power spectrum onto the Mel scale, taking the log, and then applying a DCT. MFCCs are particularly robust to changes in recording conditions.

Spectral Flatness Measure (SFM): This feature quantifies the “noisiness” or “tonality” of a signal within a frame, providing a different dimension of description.

Other relevant music information retrieval (MIR) features such as harmonicity (purity of tone), bandwidth (spread of frequencies), loudness (perceived amplitude), and zero-crossing rates (frequency of sign changes in the waveform) can also be computed and combined to create a richer and more discriminative feature set.

Temporal Dynamics (Delta and Delta-Delta Coefficients): To capture the dynamic changes in the audio signal over time and account for temporal variations (e.g., onset of notes, changes in phonemes), high-order time derivatives (known as “delta” and “delta-delta” coefficients) of the base features (e.g., MFCCs) can be calculated and appended to the feature vectors. This adds crucial temporal context to the fingerprint.

Quantization and Compression: Finally, to optimize for robustness, normalization across varying loudness levels, ease of hardware implementation, and significantly reduced memory requirements for storage and transmission, a low-resolution quantization can be applied to the combined feature vectors. This involves mapping feature values to a smaller set of discrete values. The initial steps result in a high-dimensional sequence of feature vectors per frame. The final fingerprint 520 is then modeled by summarizing these multidimensional vector sequences into a single compact vector (e.g., by averaging, or by concatenating summary statistics from different frames). For instance, 16 filtered energies representing a 30-second audio clip could result in a 512-bit signature. This approach is computationally efficient and produces compact fingerprints 520, which can also be represented as sequences (traces or trajectories) of features over time for more detailed matching. For more complex recognition scenarios or larger databases, these feature vectors can also be clustered (e.g., using K-means or Gaussian Mixture Models) to generate a compact representation, such as a feature map or lookup table, enabling even faster approximate nearest neighbor lookups. This sophisticated audio fingerprinting algorithm efficiently and robustly solves the technical problem of robust and quick audio content identification, even amidst varying acoustic conditions, significant background noise, and different audio compression artifacts. This provides a tangible and non-obvious improvement over less resilient recognition methods of the prior art that often struggle with the inherent complexities and environmental interference of real-world audio.

Video fingerprinting 520, a critical component of the system, involves an intricate, multi-stage process to capture video data, transform it into a highly discriminative and robust representation, and extract features optimized for accurate real-time content identification. This advanced process typically includes:

Video Capture & Initial Preprocessing: The video stream is initially captured from the user's device. It then undergoes essential preprocessing steps. This includes converting the video frames to grayscale (reducing data volume while preserving fundamental structural information), resizing frames to a standardized resolution, and optionally applying temporal and spatial downsampling to a reference frame rate (e.g., 10 frames per second) to normalize variations between different capture devices and significantly reduce the computational load for subsequent processing.

Domain Transformation for Invariance: To enhance robustness against common geometric operations that might occur during video capture (e.g., minor camera movements, changes in perspective, scaling), the video frames can be transformed into a domain invariant under these operations. Advanced mathematical techniques like the Radon transform (useful for detecting linear features regardless of orientation) or the Fourier-Mellin Transform (providing scale and rotation invariance) can be employed for this purpose. Alternatively, the system can leverage pre-trained deep learning architectures, such as ResNET50 (a powerful Convolutional Neural Network known for its deep residual layers) or models developed by leading AI research entities like OpenAI (e.g., CLIP-like models adapted for video analysis), which directly extract high-level robust features from raw pixel data.

Feature Extraction-Global vs. Local & Spatio-Temporal: The primary goal of video fingerprinting 520 is to derive a small number of pertinent, highly discriminative features (fingerprints) from video clips. These fingerprints are then used to identify video queries by measuring the “distance” or similarity between a query fingerprint and a database of reference fingerprints. Feature extraction for video fingerprinting 520 can involve:

Global Features: Derived from the entire video frame, such as a color histogram (representing the distribution of colors) or the Centroid of Gradient Orientation (describing the overall directionality of edges). While simple, these are generally less robust to partial views or significant visual changes.

Local Features: Focus on localized structural patterns, which are inherently more robust against distortions like rescaling, partial cropping, insertion of logos, or picture-in-picture effects. Local features are typically extracted using interest point detectors (e.g., Harris corner detector, SIFT (Scale-Invariant Feature Transform), SURF (Speeded Up Robust Features)), which identify salient, repeatable points across different views of an image. These detectors are combined with differential features of local regions (e.g., local intensity gradients, descriptors of patches around interest points).

Spatio-Temporal Features: To make fingerprints 520 even more discriminative and precisely localized in both space and time, features are extracted across both spatial and temporal dimensions. This involves detecting spatio-temporal interest points (points that are stable and distinctive across a sequence of frames) and computing descriptors like contrast context histograms around these dynamic points.

Deep Learning Integration for Advanced Recognition: For highly accurate image, video, facial, or object processing, the system is designed with a modular architecture that allows for seamless integration of state-of-the-art deep learning models from various research institutions and companies. This includes powerful Convolutional Neural Networks (CNNs) (e.g., ResNet50, EfficientNet), and more recent Vision Transformers, which are particularly effective for complex visual recognition tasks. As a concrete example of this integration, an input video clip can be processed through a pipeline: first converted to grayscale, then resized to a standard input dimension, and subsequently, local regions are detected using a robust spatio-temporal interest point detector. The clip is then resampled at a fixed frame rate, and a local region of interest is selected within each down-sampled frame based on the characteristic strength and scale of the detected interest point. Subsequently, a contrast content histogram is calculated for this selected local region and normalized into unit vectors, which serve as local fingerprints.

Intelligent Cropping for Triggered Video: During a video trigger 500 event, the system specifically utilizes advanced image/video recognition technology to detect the presence of a television 170 screen or other display within the captured frame. Its edges are precisely identified and cropped, and only the video content within those cropped edges is recorded to create a PSP 505. This cropped PSP is then fed to the Media Information Module (matching engine) 510 and Virtual Repository Matching Module (VRM) 535 for further processing.

Multi-Modal Fingerprint Generation: Fingerprints 520 or watermarks are not limited to single modalities. They can also be created or digitized by detecting and analyzing various intricate patterns from the captured media 505 or the original program. This includes detailed analysis of: color patterns, specific item patterns, shadow formations, brightness levels, contrast variations, speed of visual changes, speed of scene changes, speed of camera movements (e.g., pans, zooms), characteristic wavelengths, frequencies, and even precise distances between participants or objects within the visual field. These sophisticated fingerprints 520 and watermarks can be generated using a complex combination of one or more of these multi-modal detections derived from the video recording or captured media 505. This multi-faceted and highly adaptive approach to video fingerprinting produces exceptionally robust and discriminative features. This technically solves the profound problem of accurately identifying specific visual content in dynamic media, even under varying real-world conditions, noise, or intentional alterations, thereby fundamentally surpassing the capabilities of prior art solutions that typically struggle with complex visual environments and ensuring reliable content identification in real-time. This level of detail in identification significantly contributes to the invention's patentability.

The matching engine 510, after successfully generating a robust fingerprint or detecting a watermark, then securely transmits the user identification and the identified program information (e.g., unique program ID, timestamp) to the Virtual Repository Matching Module (VRM) 535. Within the VRM 535, the generated video or audio fingerprint 520 becomes immediately available for high-speed searching within various indexed databases. It is important to clarify the specialized focus of different fingerprinting modalities: Video fingerprinting 520 specifically relates to identifying and matching visual elements such as faces (e.g., using facial recognition algorithms), distinct objects (e.g., product logos, furniture), text (e.g., on-screen text, subtitles), scenes (e.g., specific indoor/outdoor environments), and embedded codes found within the visual media information. Conversely, audio fingerprinting 520 primarily focuses on recognizing and categorizing auditory elements such as human speech (e.g., using speech recognition models), distinct voices (e.g., speaker identification), and composite sounds (e.g., music, ambient sounds like a busy train station). The primary objective of the VRM 535 is to find a precise and confident match between the captured media's fingerprint 520 (from the PSP) and a corresponding segment of a program's fingerprint 520 stored in the central database 120 (the reference fingerprint database). This is achieved using highly optimized searching techniques and advanced distance metrics (as described previously). The matching process identifies the most likely reference in the database 120. Once identified, this reference is directly linked to the relevant virtual repository 715 which contains detailed information about participants and marketing objects. In instances where the PSP 505 detects more than one potential match (e.g., multiple similar items are present in the same scene, or multiple versions of a program exist), these candidate matches are intelligently presented to the user 150. The user can then disambiguate by selecting the program they are currently watching, or the specific item of interest, to view associated users, items, and/or services. To efficiently compare captured audio fingerprints 520 against a vast scale of millions of others in real-time, the system leverages advanced techniques like indexing structures (e.g., inverted indices, k-d trees, or specialized hash tables) and computational biology heuristics (adapted from algorithms used for genomic sequence alignment, offering fast approximate nearest neighbor search capabilities, such as those implemented in libraries like FAISS or Annoy). These techniques are applied to rapidly generate and evaluate candidate reference audio fingerprints for efficient exhaustive searching, significantly reducing lookup times in massive datasets. This highly efficient and accurate matching engine 510, combining multimodal recognition capabilities with advanced indexing and searching techniques, provides an inventive concept that significantly improves upon conventional, less integrated content identification systems by drastically reducing processing time and improving accuracy in dynamic, real-time environments. This combination of speed, precision, and multi-modal processing is crucial for delivering timely and relevant results that meet user expectations for immediate gratification and seamless interaction, further bolstering the patentability of the system.

After a program and its specific segment have been accurately and confidently identified by the matching engine, the system proceeds to a subsequent, crucial logical step: consulting another dedicated database 125 530. The purpose of this consultation is to precisely determine participants (such as actors, hosts, guests, or producers associated with the content) or detailed item records, particularly those directly associated with the identified captured portion of the media. This participant and/or item database 125, which can be dynamically accessed whether it is local to the central system or securely stored remotely in a distributed cloud environment, intelligently establishes and maintains complex relational data structures linking participants to specific programs, individual scenes, and even precise timestamps within those scenes. Once relevant participants have been accurately identified through this relational lookup (e.g., by matching participant IDs to roles in the identified program segment), the system proceeds to query the relevant virtual repository 715. The VRM 535 then performs a targeted, high-speed search within a comprehensive aggregated database 125 or specifically within the identified user's virtual repository 125 535 for records pertaining to these identified participants (many of whom are also registered virtual repository users with their own curated item collections) or for specific items that demonstrably appeared within the captured media 505. This intelligent search links these identified entities to the program and its specific portion. This sophisticated process effectively identifies shared records of items 540, such as a specific actor's attire (e.g., a designer dress, a brand of watch) or a particular object used prominently in a scene (e.g., a prop, a piece of furniture, a vehicle). Critically, these detailed item records, along with their associated “use information,” are often retrieved directly from a production company's dedicated virtual repository 715 (which might contain detailed metadata about items used in their productions), or from a celebrity's public-facing virtual repository. The technical solution offered by the VRM 535—in its unprecedented ability to precisely link detected ephemeral media content (what a user sees or hears) to specific, contextually rich virtual repository items (detailed product information, “use information,” pricing, availability) owned by individuals (e.g., celebrities, influencers) or production companies—solves a complex, pervasive, and non-obvious practical problem in media monetization and user engagement. It efficiently bridges the gap between fleeting user interest in media content and immediately actionable commercial opportunities, a capability fundamentally missing or inadequately addressed by prior art solutions. This innovative, real-time linking mechanism enables novel monetization of content directly from its appearance within any form of media, transforming passive viewership into active, commerce-driven engagement and providing a distinct advantage over conventional static product placements.

### User Interaction, Recommendations, and Monetization Mechanisms

At its overarching core, the invention is a sophisticated Automated Personal AI-Driven Lifestyle Orchestration System 100, architected from the ground up to proactively manage a user's intricate calendar and dynamic daily life by intelligently delivering and strategically scheduling highly relevant marketing objects within a seamless digital ecosystem. This system represents a profound paradigm shift, fundamentally revolutionizing how individuals interact with both information and commercial opportunities. It moves far beyond the limitations of mere reactive responses, instead providing anticipatory, contextually aware, and deeply personalized assistance that learns and evolves with the user.

As previously detailed, a central and innovative element of this invention is the semantic intelligence-powered assistant, which constitutes a critical software and AI component within the larger computing system 100. This assistant is specifically designed with advanced processing capabilities for receiving and interpreting one or more digital files. These files are intelligently associated with one or more marketing objects 115 and can encompass various forms of multimedia data, such as high-resolution images or streaming video segments. Crucially, a unique aspect of this system is its ability to specifically identify these marketing objects 115 as being items that have been created, used, or owned by a second user. This groundbreaking capability allows the system to recognize items featured by individuals who may be public figures, such as a celebrity wearing a particular outfit in a photograph, or an influencer showcasing a product in a video. The semantic intelligence computing system 100 then proceeds to associate these received marketing objects 115 with their detailed “use information” specifically for the second user of the second virtual repository. This “use information” is rich, contextual data that can include, for example, the date and time the celebrity wore the outfit, the location of the event, the media context (e.g., name of the show, episode number), and even personal comments or reviews from the second user about the item. Through an automated process highly driven by advanced semantic intelligence algorithms (e.g., natural language understanding, knowledge graph lookups, entity extraction), the system automatically populates 430 these marketing objects 115, along with their comprehensive “use information,” into meticulously categorized fields associated with the second virtual repository. This intelligent and automated categorization ensures that the items are organized in a semantically meaningful way that directly matches the categorized marketing objects derived from the media file, thereby enabling highly efficient retrieval and deep contextual understanding by other users. This automated, semantic-driven population of virtual repositories with rich, context-aware use information extracted directly from unstructured or semi-structured media represents a key technical advancement over conventional systems. Prior art systems typically require tedious manual data input or lack the deep contextual understanding necessary to infer such rich use information, thus limiting their ability to provide truly personalized and actionable recommendations.

The user's primary mode of initiating direct interaction with the system is intuitive and natural: the computing system 100 receives from a first computing digital device 150 of a first user a first trigger voice command subject matter directive 110. This voice command directive 110 represents a highly natural and intuitive way for the user to express their immediate interest, seamlessly requesting specific information. This request can include personal user data and marketing objects 115 associated with a particular subject matter (e.g., “Find me a jacket like the one Brad Pitt wore in the movie ‘Once Upon a Time in Hollywood’”). Critically, these requested marketing objects 115 are associated with one or more virtual repositories 715 belonging to the second user (e.g., Brad Pitt's virtual repository, or the movie's production company's repository), thereby indicating a direct semantic connection between the first user's verbal query and the second user's digital collection or public persona.

Upon receiving this voice command, the semantic intelligence computing system 100 immediately initiates a sophisticated marketing object identification process on the first user voice command directive 110. This identification process involves deep linguistic analysis and sophisticated interpretation of the subject matter of interest as articulated in the natural language voice command. The system first intelligently identifies the specific “first user” from the characteristics of the first trigger voice command (e.g., voice biometrics, user profile linked to the device). Subsequently, it intelligently identifies the “second user” from the first user's voice command subject matter of interest, recognizing that the second user is semantically associated with the relevant second virtual repository (e.g., by querying a knowledge graph linking actors to movies and their associated costume departments/virtual repositories). The computing system 100 then performs a complex matching operation: it determines if the identified subject matter of interest pertaining to the second user (e.g., a specific jacket owned/used by Brad Pitt) precisely matches the voice command subject matter of interest expressed by the first user. This complex matching, which involves advanced natural language understanding (NLU), semantic parsing, and real-time cross-referencing of diverse user and repository data (e.g., public data, private user preferences, marketing object metadata), goes far beyond simple keyword searches of the prior art. If a confident match is confirmed between the subject matter of interest in the first user's voice command and the marketing subject matter of interest contained within the second user's repository (or a publicly available related repository), the system then immediately makes available to the first user on their first computing digital device 150, via the network communication 300, a copy of one or more matching marketing objects 115. This copy of the matching marketing objects 115 invariably includes one or more highly relevant links (e.g., direct purchase links to e-commerce sites, links to detailed product reviews, links to related media), facilitating immediate access to further information or direct commercial transactions. This multi-stage ability to interpret complex natural language voice commands, perform precise semantic matching across disparate and distributed data sources, and deliver actionable, commerce-enabled results in real-time addresses a significant technological problem: bridging the gap between human intent expressed in natural language and actionable digital information and commerce. This provides a truly inventive and non-obvious concept that profoundly enhances human-computer interaction in a highly personalized, efficient, and commercially viable manner.

### Proactive Scheduling and Calendar Integration

A crucial and highly distinguishing aspect of this invention, extending far beyond the limitations of simple information retrieval or reactive scheduling, is its inherent ability to proactively and intelligently manage a user's calendar. The system is equipped with advanced AI algorithms that enable it to intelligently populate a user's calendar 635 with relevant date and time-sensitive information or marketing objects 115. This proactive population is based on a deep, real-time interpretation and sophisticated analysis of various inputs: user-created directives (e.g., manually entered preferences), user-selected content, and nuanced voice-command directives 110, combined with continuously updated user preferences, diverse source data feeds, marketing objects, and dynamic location data. This intelligent process can occur seamlessly and unobtrusively, with or without explicitly prompting the user for scheduling confirmation or calendar population. Once identified and intelligently scheduled, the relevant information or marketing objects 115 are then delivered directly to the user interface of their mobile computing device 150 as a comprehensive, visually rich list. This list intelligently incorporates associated information, direct links, relevant images, and/or embedded videos, providing a holistic context. The system's unique ability to intelligently and proactively schedule events and information into the user's calendar 635, often anticipating needs before explicit instruction, represents a key technical improvement over passive calendar entries of prior art systems, transforming the calendar from a mere record-keeper into a dynamic, anticipatory lifestyle assistant.

The system's innovative approach further comprises the capability of dynamically populating an event or advertisement directly into a user's calendar 635, seamlessly blending personal scheduling with commercial opportunities. This functionality is enabled by the sophisticated semantic intelligence-powered assistant, which is designed to carry out a wide range of functions for a user, including the critical ability to initiate a purchase 680 of an item directly from a calendar entry or recommendation. This highlights the system's unparalleled ability to translate user preference and contextual understanding into direct, actionable commerce. The semantic intelligence-powered assistant can also meticulously save marketing objects 115 or other relevant information at the explicit direction of a user, offering a highly personalized and intelligent information curation service (e.g., saving a recipe from a cooking show, an outfit worn by a celebrity). Furthermore, the system is capable of populating a calendar 635 with date and time-sensitive information directly on command, offering precise control when desired. Beyond simple scheduling, the system demonstrates its profound practical utility in real-world scenarios by automatically scheduling a reservation for a user via a third-party reservation application (e.g., OpenTable, Resy), streamlining complex multi-step processes into a single, intuitive interaction.

This Automated Personal AI-Driven Lifestyle Orchestration System further distinguishes itself through its advanced capability to intelligently pull in date and time-sensitive information, including rich media content or detailed event specifics, from a vast array of diverse source data. This is achieved through the system's sophisticated interpretation and analysis capabilities. It processes consumer-selected directives, user-created content (e.g., photos, notes), or natural voice-command subject matter of interest directives 110. This analysis is seamlessly integrated with existing user profiles, learned user preferences, and historical user behavior patterns. The analyzed results are then dynamically presented in a highly personalized user interface on their computing device 150. The precise presentation is determined by a rigorous matching process that aligns the incoming source data (including embedded marketing objects 115) against the consumer's current subject matter of interest directives 110, their continuously evolving user preferences, comprehensive user profiles (which can include granular demographic information such as gender and ethnicity for highly targeted recommendations), and their detailed user history. This deep contextualization and proactive matching, involving the synthesis of multiple disparate data points for personalized scheduling, provide a significant technical improvement over prior art systems. Such older systems typically rely solely on rudimentary keyword searches or laborious manual data entry for scheduling, lacking the nuanced understanding and automation capabilities of this invention.

The system also uniquely incorporates an automated Smart Calendar component, which is intrinsically associated with the automated personal AI-driven lifestyle assistant. This Smart Calendar is not merely a digital agenda; it is a dynamic, intelligent entity that integrates date and time-sensitive information, including rich media or event details, from diverse and constantly updated source data streams. Its seamless integration and proactive population are based on continuously interpreting and analyzing consumer-selected directives, user-created content, or voice-command subject matter of interest directives 110. This analysis is always performed in conjunction with a deep understanding of the user's comprehensive profile, their evolving preferences, and their historical interactions. The analyzed results, refined by AI models, are dynamically populated into the user's smart calendar via their computing device interface 150 by intelligently matching the source data (including granular marketing objects 115) against the consumer's real-time subject matter of interest directives 110, their explicit and inferred user preferences, and their detailed user profiles. This represents a significant advancement in calendar intelligence.

A groundbreaking aspect of this technology, showcasing its commercial potential and non-obvious nature, is its ability to directly and strategically push paid or curated date and time-sensitive advertising and promotional information, including rich marketing objects 115, directly into a user's personal calendar. This highly targeted advertising is uniquely based on the system's deep interpretation and sophisticated analysis of a multi-dimensional data set: consumer-selected, created, or voice-command subject matter of interest directives 110; comprehensive user profiles; learned user preferences; detailed user history; and continuously updated marketing directives 110, specific marketing objects 115, and frequently updated source data feed information from advertisers. The interpreted and analyzed user information (e.g., implicit desires, past behaviors) is rigorously and semantically matched against real-time marketing directives 110, precise location information (e.g., proximity to a retail outlet), specific marketing objects 115, and dynamic data feeds 210 received from advertisers, content sources, or commercial establishments. The fundamental purpose of this in-depth interpretation and complex analysis of user profiles, preferences, voice command directives 110, and history is to accurately identify and predict matching directives and marketing objects. This allows the system to intelligently populate a user's calendar at a highly opportune and specific time and date, (according to the user's location time zone) serving various purposes: providing timely reminders, delivering personalized recommendations, offering rich informational content, and/or directly facilitating a purchase. The calendar itself is flexibly structured with 24/7 date and time slots, (according to the user's location time zone) accommodating any nuanced scheduling need of the user. This intelligent, highly targeted advertising and scheduling capability represents a significant technical improvement in marketing automation, providing contextually relevant information directly into the user's most personal planning space. This approach is far more effective and less intrusive than untargeted, generic advertisements of the prior art, significantly enhancing conversion rates and user satisfaction by delivering value precisely when and where it is most relevant.

The automated personal AI-Driven lifestyle assistant or smart calendar further profoundly enhances its utility by proactively populating a user's calendar 635 based on continuous analysis of rich user data, highly precise user location data (including real-time GPS latitude and longitude coordinates meticulously analyzed against semantic location data such as city and state names, specific establishment or venue names, or even historical latitude/longitude patterns), and diverse source data including marketing objects 115. Location data may be a physical address including marketing objects, buildings, establishments, or a user associated with latitude and longitude coordinates associated with a radius or a proximity of the Latitude and Longitude coordinates. This proactive calendar population occurs one or more times daily, often in the background, via the user's mobile computing device 150, which continuously determines and updates the user's current, travel, and predicted location. The AI lifestyle assistant's sophisticated algorithms and underlying logical models are meticulously designed, leveraging machine learning, to constantly understand its owner 600 at a deep, behavioral level and to proactively populate the owner's calendar with relevant activities and destinations 24/7. This intelligent algorithm 610 is capable of seamlessly understanding its owner's existing personal and business calendar entries (e.g., from integrated services like Google Calendar, Apple Calendar, or Outlook) 625. It then intelligently suggests complementary activities and places to go 645, filling in gaps or enhancing existing plans. For instance, after confirming a user's dental appointment at 9 AM or a staff meeting at 1 PM, the system will seamlessly suggest subsequent, contextually appropriate activities 645 (e.g., a nearby coffee shop, a quick fitness class before the next meeting). This predictive capability extends to even verifying attendance at confirmed reservations by precisely matching user GPS location to the establishment's known coordinates 650 at the appropriate scheduled time. Furthermore, the AI assistant is capable of intelligently scheduling different category events into time slots following a confirmed matching GPS location of the user 150 and establishment (Marketing object 115), suggesting complementary activities 645. For example, if a user 150 attended a restaurant at 6 PM, the personal AI assistant might intelligently determine not to schedule another restaurant dinner for at least another 3 hours, instead proactively proposing a complementary activity such as dessert at a nearby cafe, a bowling alley, or a rooftop live event instead at 7:30 PM, 8 PM, or 8:30 PM. The AI assistant can also aggregate the selected or spoken subject matter of interest voice command directives 110 and user profiles 710 of one or more users 150 to create a group trip or group event for those aggregated users 630, showcasing its multi-user planning capabilities. It can combine multiple users' directives 110 and preferences to intelligently construct a unified group trip itinerary, dynamically populated with relevant marketing events for each day throughout the duration of the trip or event (Populate shared itineraries 655). This includes the advanced capability of finding exact matching opportunities and expressing an event via a semantic subject matter voice command directive 110 for precise calendar population. It proactively prompts the user with timely notifications or alerts about incoming invitations, crucial information, or events 660, and significantly enriches calendar entries with valuable source data, marketing objects 115, direct interactive links, relevant high-resolution images, captivating video trailers, celebrity information, and even immediate automatic streaming video or audio (e.g., initiating a TV series stream from Disney+ directly after selecting a hyperlink from a calendar entry). This seamless integration extends to calendaring information by parsing confirmation receipts from various sources, including Google Calendar, Apple Calendar, third-party applications, and user emails, leveraging user preferences and location directives via an automated process. The system proactively solves problems with due dates 685, actively monitoring deadlines and dependencies, further enhancing its utility as a comprehensive lifestyle manager. This continuous monitoring, deep understanding of user context, and proactive behavioral response, facilitated by the AI processing engine 105, represent a significant technical improvement over basic calendar systems that require explicit user input for every entry, thus enabling a truly ambient and intelligent personal assistant.

The system empowers a user to instruct the computing system 100 or their Personal AI Concierge Lifestyle Assistant, through either direct touch-screen selection or a natural voice command directive 110, to save or actively “follow” a specific directive 110 or preference, which can pertain to any topic, product, service, or subject matter imaginable. Once a directive 110 is securely saved and stored in the computing system 100 (typically within the user's profile associated with their private virtual repository), by the user 150, via a file upload, real-time data feed, API integration, or other seamless upload means to a computing device 150, the user 150 begins to proactively receive real-time notifications, contextual information, product suggestions, or service offerings directly associated with that stored or saved directive 110. This real-time information could be triggered by something seen or heard from a television program or a radio broadcast (e.g., a particular song playing), or by a live event happening in the user's vicinity. For instance, if the user has saved “Oatmeal Ice Cream” as a preference, when that user 150 is driving their vehicle, the AI assistant or system 100 will intelligently detect their proximity to a relevant location and notify that user 150 via their computing device 150 if a nearby establishment is currently selling oatmeal ice cream. This alleviates the need for the user 150 to actively remember such niche details, as their AI assistant will proactively provide the reminder and opportunity. As another compelling example: if a user 150 has saved “Tupac Shakur” as a directive 110 or preference in the system 100, and a special documentary program about him is scheduled to be shown on television, the AI Assistant will intelligently schedule that program into the user's calendar 635 with a proactive notification informing the user 150 that content related to Tupac Shakur is about to be discussed or shown on a certain channel at a certain time and day. A directive 110 is broadly defined; it may represent a personal preference, a specific interest, a desired action, or any Topic. A topic-driven subject matter directive 110 may be triggered or contextually relevant if it is listed, viewed, or heard on television, a smartphone 155, a radio, or other media outlets or computing devices 150. A list of keywords or specific directives may be provided in a user-uploaded file, via a data feed, or uploaded directly to a computing device 150. A directive 110 can also be passively detected if heard via a television broadcast or program or a radio broadcast or program through advanced audio recognition, or even conveyed by a sophisticated watermark signal not consciously heard by the human ear. A directive 110 associated with content may be detected and understood using advanced sound recognition or speech recognition algorithms. Importantly, an audio signal used for a directive can be imperceptible to humans, allowing for discreet and continuous content monitoring.

This sophisticated technology manifests as a personal AI concierge lifestyle assistant, purpose-built to interpret and analyze complex consumer directives 110 and respond with highly contextualized results as they become relevant or exist in real-time. Results are dynamically delivered to a user 150 via their mobile computing device 150 if the results are immediately available (e.g., a nearby store selling a desired product), if the results pertain to a future date (e.g., an upcoming event), or when the results first become publicly available (e.g., concert ticket sales opening). The AI assistant or central computing system 100 continuously and intelligently checks for a user's current geographical location, detects changes in their location (new location), or anticipates a user's destination location (e.g., a planned trip extracted from emails or calendar entries). Once a location is detected or predicted, the AI assistant or computing system 100 leverages this information to identify one or more specific locations (e.g., precise street addresses, venue names) via a first user mobile computing device 150 using accurate GPS/latitude-longitude coordinates. It then initiates a complex real-time analysis: carefully analyzing available marketing objects 115, relevant events, and one or more files associated with the identified location. This analysis is conducted against a multi-dimensional profile of the first user, including their topic-driven consumer directives 110, explicit and inferred subject matter interests, lifestyle preferences, current popularity trends (e.g., trending restaurants), and comprehensive user profile information, all to find exact matching opportunities. The AI assistant proactively populates highly personalized recommendations directly to the user calendar 635 (as shown in step 635 in the flowchart) in a prioritized order. This prioritization is based on date and time-sensitive events and the most relevant matching marketing objects 115 (e.g., lifestyle options like restaurants, nightlife events, concerts, ticketing events, TV shows, wellness activities like massages, outdoor activities like hiking or boating, or specialized pursuits like fishing) that are most likely to genuinely interest the user 150 at that specific location and time. Critically, results do not necessarily have to be populated to a user's calendar; they can alternatively be delivered as a real-time, dynamic list to the user interface on their device. Every marketing object/item record 115 in the central database 125 is meticulously associated with precise latitude-longitude coordinates, enabling highly localized and contextually relevant recommendations.

A comprehensive database 125 of marketing objects 115 is meticulously organized into a hierarchical structure of categories and granular subcategories. For instance, the “Restaurants” category could include subcategories like “Italian,” “American,” “Mexican,” “Vegan,” etc. Other top-level categories include “Nightclubs,” “Bars,” “Live Events” (with subcategories such as “Sports,” “Concerts,” “Festivals”), “Active Life” (e.g., “Fitness,” “Hiking,” “Boating,” “Golfing”), and “Beauty & Spa services” (e.g., “Massage,” “Tanning”), among many other diverse Topics. A user's calendar may be intelligently populated with these marketing objects 115 and organized using the same categorical structure for intuitive navigation. The AI assistant is specifically engineered with sophisticated machine learning algorithms to continuously understand its user's location with high precision and to be intelligent enough to proactively populate the calendar with the most likely schedule of things to do and places to go for its owner, ensuring comprehensive lifestyle orchestration (as represented by Monitor User Data 600 and Scan for Matching Content/Opportunities 605). This extends across a full 24/7-day cycle, from suggesting early morning breakfast spots and nearby workout places, to proposing lunchtime venues, to arranging sophisticated nighttime dinner reservations, and finally, offering late-evening sporting events or nightclub options. This adaptive scheduling occurs each day or on selected days when a user 150 expresses a desire to know what is happening in any specific city or location (Contextual Analysis 610). The Personal AI assistant demonstrates its advanced intelligence by also being smart enough to interpret a dinner reservation from a populated and confirmed entry in external calendar applications like Google Calendar or Apple Calendar 625. It can then intelligently ascertain if the user 150 actually attended the dinner reservations by precisely matching the user's GPS/latitude-longitude coordinates against the establishment's location at the precise time of the reservation (Verify attendance 650). Furthermore, a non-obvious capability is its ability to intelligently schedule different category events into subsequent time slots following a confirmed matching GPS location of the user 150 and establishment (Marketing object 115), thereby suggesting complementary activities 645. For example, if a user 150 was confirmed to have attended a restaurant at 6 PM, the personal AI assistant might logically determine not to schedule another restaurant dinner again for another 3 hours. Instead, it would proactively propose a complementary activity such as dessert at a nearby cafe, a bowling session, or a rooftop live event as intelligent follow-up suggestions at 7:30 PM, 8 PM, or 8:30 PM. The AI assistant also possesses the advanced capability to aggregate the selected or spoken subject matter of interest voice command directives 110 and user profiles 710 from one or more distinct users 150. This aggregation is used to create a unified group trip or group event for those aggregated users 630, providing a seamless multi-user planning experience. It can combine multiple users' directives 110, preferences, and availabilities to construct a cohesive and optimized group trip itinerary, dynamically populated with relevant marketing events and activities for each day throughout the duration of the planned trip or event (Populate shared itineraries 655). This includes the advanced capability of finding exact matching opportunities and expressing an event via a sophisticated subject matter voice command directive 110 for precise and personalized calendar population, representing a comprehensive and intelligent approach to lifestyle management.

One significant and particularly patentable technological advancement embedded in this invention is a sophisticated, context-aware, and location-sensitive AI assistant that operates as a true Lifestyle Orchestration Engine. This AI-Driven Lifestyle Orchestration System represents a profound breakthrough in consumer-centric artificial intelligence by seamlessly unifying previously disparate functionalities into a cohesive and fluid user experience. These functionalities include: advanced behavioral analysis 620, intelligent smart calendaring (Intelligently schedule events into user's calendar 635), real-time multi-modal media recognition, and dynamic location-based marketing. Unlike existing systems of the prior art, which merely react to explicit user inputs or static confirmations, this invention creates a continuous, adaptive, and self-improving feedback loop of sensing, analyzing, predicting, and acting. It achieves this by integrating several advanced technological components into a highly cohesive and synergistically operating system. Natural Language Processing (NLP), powered by advanced LLMs, enables the system to deeply understand and interpret complex, nuanced voice commands and implicitly expressed user preferences (Interpret/analyze user directives 610) far beyond simple keyword recognition. Location-Based Services (LBS), utilizing high-precision GPS, Wi-Fi triangulation, and IP address geolocation, continuously identify current and anticipate future (e.g., destination-based) locations for delivering hyper-personalized, automated, and geographically relevant recommendations (Monitor User Data 600). Calendar Integration & Behavioral Analysis allows the system to seamlessly interface with popular third-party calendar tools like Google Calendar or Apple Calendar, intelligently cross-referencing information to proactively plan future activities based on dynamically populated date and time events and historical user behavior patterns (Monitor User Data 600, Understand existing commitments 625). Marketing Object Intelligence leverages rich, multi-dimensional user data 600, including their explicit directives 110, combined with a meticulously categorized and semantically enriched database 125 of establishments, geographical locations, events, and products. Each entry in this database is precisely geotagged and timestamped for highly accurate and contextual matching (Scan for Matching Content/Opportunities 605). Proactive Content Matching continuously analyzes broadcast and streaming content in real-time, employing advanced sound recognition, text recognition (OCR), and speech recognition techniques, and even utilizing imperceptible audio signals (watermarks) to deliver highly relevant, media-related, and topic-driven directive recommendations (Scan for Matching Content/Opportunities 605). Multi-User Aggregation facilitates streamlined group planning by intelligently combining the diverse interests and preferences of multiple users 150 and dynamically generating shared itineraries for specific destination locations (Aggregate preferences from multiple users 630, Populate shared itineraries 655). User-Centric Algorithms, powered by continuous reinforcement learning, continuously refine themselves based on ongoing user interactions, expressed preferences, and explicit confirmations or rejections (Apply behavioral analysis 620). This enables the system 100 to dynamically evolve and better understand each individual's unique lifestyle and habits over time. The assistant also incorporates a sophisticated Adaptation to Plans module, effectively avoiding scheduling conflicts by recognizing existing commitments (e.g., work meetings, family events) and intelligently adapting its suggestions accordingly (e.g., proposing dessert options as a logical and non-conflicting follow-up to an already confirmed dinner reservation) (Suggest complementary activities 645).

This AI assistant transcends the mere capabilities of a simple command-response tool. It actively anticipates user needs before they are explicitly articulated, adapts seamlessly to rapidly changing circumstances (e.g., traffic, weather, sudden event cancellations), interprets subtle contextual cues (Interpret/analyze user directives 610), and proactively manages complex schedules (Intelligently schedule events into user's calendar 635), fundamentally transforming how users 150 interact with their time, digital media, and physical surroundings. This marks a significant and non-obvious leap forward in consumer AI, effectively bridging comprehensive lifestyle management with the cutting-edge concept of ambient computing. More than just an advanced calendar, this orchestration system functions as a true ambient computing layer—an invisible, ubiquitous, and ever-present assistant that subtly yet profoundly shapes and enhances the user's daily life without requiring constant explicit interaction. It provides not only essential reminders and sophisticated scheduling functionalities but also actively curates rich, highly personalized experiences that align deeply and dynamically with a user's evolving values, interests, ingrained habits, and immediate surroundings. The AI assistant maintains a continuous, granular awareness of the user's current and predicted location, their calendar state (availability, commitments), their evolving preferences (both explicit and inferred), and their relevant social context. It delivers highly curated content and experiences that span the entire day, ranging from optimal breakfast suggestions and personalized event recommendations, to timely entertainment alerts, and even wellness activities, all intelligently personalized by time of day, precise location, and detailed lifestyle profile. This represents a substantial and non-obvious leap beyond existing scheduling tools, which lack this level of contextual integration and proactive foresight. The orchestration system operates with an unprecedented level of autonomy and adaptability that genuinely mirrors human judgment, proposing intelligent plans after meals, expertly coordinating complex group travel based on aggregated shared tastes, or subtly reminding a user 150 of a nearby point of interest as they happen to pass by. It seamlessly bridges the gap between digital life and real-world experience, transforming static scheduling into a dynamic, AI-powered proactive lifestyle engine, marking a truly meaningful advancement in the field of lifestyle AI. The system further delivers notifications/information to a user 660, including real-time, context-sensitive alerts directly to their mobile device. It also provides calendar entries that are not static, but are richly enhanced with interactive hyperlinks, embedded media previews, aggregated reviews, and precise geolocation data. Moreover, based on explicit user permission or continuously learned behavioral patterns, the system can execute complex tasks/assignments 665, such as sending messages 665 (e.g., automated email confirmations, personalized text messages or emails), intelligently accepting or declining invitations 670 based on calendar availability and preferences, proactively responding to calendar conflicts 675 by suggesting alternatives, initiating purchases 680 (e.g., concert tickets, restaurant bookings), and proactively solving problems related to due dates 685 (e.g., reminding of upcoming bill payments, project deadlines).

Thus, the present invention provides a comprehensive, computer-implemented method for proactively managing a user's lifestyle and facilitating real-time commerce, addressing the inherent limitations of conventional, reactive digital tools. This innovative method begins with a computing system 100 configured to store one or more databases 125. At least one of these databases 125 is intricately associated with one or more virtual repositories 715. Each of these virtual repositories 715, crucial for organizing user data, is associated with one or more marketing objects 115. These marketing objects 115 uniquely include machine-processable “use information,” which provides detailed context-of-use data, such as the time, date, and location of an item's prior or intended utilization. This comprehensive use information transforms static product data into dynamic, actionable insights, a significant technical improvement over systems that merely list items without contextual usage. Furthermore, at least one of these virtual repositories 715 is populated through an automated process 430, where marketing objects 115, including their detailed “use information,” are intelligently added via an artificial intelligence computing processing engine 105. This automated population leverages advanced AI algorithms to derive and categorize use information from diverse data sources, effectively transforming raw data into structured, actionable insights for personalized lifestyle management. This continuous, intelligent data ingestion and organization address the technical challenge of maintaining current and relevant digital inventories without manual effort, a common failing in prior art.

The system's adaptability further allows at least one of these virtual repositories 715 to be dynamically associated with one or more users 150. These users 150 are, in turn, uniquely associated with one or more marketing objects 115, including their machine-processable “use information.” To facilitate complex multi-user interactions, one of these virtual repositories 715 is specifically designated as a second virtual repository, distinctly associated with a second user. This architecture enables the system to manage and interpret shared interests and collaborative activities among multiple individuals.

The operational flow for real-time commerce and contextualized information delivery begins when the computing system 100, powered by its enhanced processing capabilities enabled by the artificial intelligence computing processing engine 105, receives input from a semantic intelligence powered assistant. This assistant receives one or more digital files which are intelligently associated with one or more marketing objects 115 of media data. These marketing objects 115 represent items demonstrably created, used, or owned by the second user, such as a celebrity's attire shown on television. This establishes a direct, verifiable link between digital content (like a video stream) and real-world assets. The semantic intelligence computing system 100 then associates these received marketing objects 115 with their machine-processable “use information” specifically for the second user of the second virtual repository. Through a semantic intelligence automated process, the system automatically populates 430 one or more marketing objects 115, including their use information, into meticulously categorized fields associated with the second virtual repository. This intelligent population enhances the semantic richness and retrievability of stored information, improving upon static item catalogs.

A critical interaction occurs when the computing system 100 receives from a first computing digital device 150 of a first user a first trigger command subject matter directive 110. This trigger command subject matter directive 110 represents a complex, natural language instruction, such as a voice command, explicitly requesting first information. This requested information includes user data and marketing objects 115 associated with a particular subject matter. Importantly, these marketing objects 115 are specifically associated with one or more virtual repositories 715 of the second user, enabling the system to fulfill queries like “What is Jennifer Lopez wearing in this movie?” by linking the query to the second user's (Jennifer Lopez's) virtual repository. This direct, semantic linking of a user's verbal query to a specific virtual repository, overcoming the limitations of keyword-only searches, is a significant technical advancement.

The semantic intelligence computing system 100 then performs advanced marketing object identification on the first user command subject matter directive 110. This identification process leverages sophisticated semantic parsing to interpret the nuanced subject matter of interest expressed by the first user. It accurately identifies the first user from their first trigger command and precisely identifies the second user based on the first user command subject matter of interest's association with the second virtual repository. The computing system 100 then determines if the interpreted subject matter of interest of the second user semantically matches the command subject matter of interest of the first user through a computationally efficient comparison. This matching is based on deep semantic relationships rather than mere keyword presence, allowing for highly accurate and contextually relevant results. If the subject matter of interest of the first user command semantically matches the marketing subject matter of interest of the second user repository, the system then makes available to the first user on their first computing digital device 150, via network communication 300, a digital copy of one or more matching marketing objects 115. This copy of the matching marketing objects 115 invariably includes one or more actionable links, facilitating immediate access to further information or commercial transactions. This entire process, from complex natural language input to semantically intelligent matching and delivery of actionable, linked information, solves the technological problem of bridging human intent with dynamic digital information and commerce, providing an inventive concept that significantly enhances human-computer interaction in a highly personalized and efficient manner. The precise identification and delivery of contextualized marketing objects based on a user's nuanced voice command represents a technical improvement over broad, untargeted advertising methods.

Extending beyond simple information retrieval, a critical aspect of this invention is its ability to proactively manage a user's calendar. The method further comprises intelligently populating an event or advertisement to a user's calendar 635 based on real-time contextual data and user preferences. This functionality is enabled by the semantic intelligence powered assistant's capacity to carry out complex user-directed functions, including initiating a purchase 680 of an item by orchestrating a sequence of digital transactions on behalf of the user. This demonstrates a proactive, assistive capability that goes beyond passive display. The semantic intelligence powered assistant can also intelligently save marketing objects 115 or other relevant information at the explicit direction of a user, offering a personalized information curation service that continuously adapts to user needs. Furthermore, the system 100 is capable of populating a calendar 635 with date and time sensitive information directly on command, thereby streamlining user organization and reducing manual effort. The system's proactive capabilities extend to automatically scheduling a reservation for a user via integration with a third-party reservation application, thus extending automated lifestyle management to external service providers. This integrated, anticipatory calendaring system represents a significant technical advancement over traditional, reactive digital calendars that require constant manual updates.

This Automated Personal AI-Driven Lifestyle Orchestration System further distinguishes itself by intelligently pulling in date and time sensitive information, including media or event details, from various source data. This is achieved through the system's interpretation and analysis of consumer-selected, created, or voice-command subject matter of interest directives 110, alongside user profiles, user preferences, and user history. The analyzed results are then presented in a user interface on their computing device 150, determined by precisely matching the source data (including marketing objects 115) against the consumer's subject matter of interest directives 110, user preferences, comprehensive user profiles (including gender and ethnicity), and user history. This deep contextualization and proactive matching provide a significant technical improvement over systems that rely solely on keyword searches or manual data entry for scheduling, enhancing the relevance and utility of calendar entries.

The system uniquely incorporates an automated Smart Calendar associated with the automated personal AI-driven lifestyle assistant. This Smart Calendar integrates date and time sensitive information, including media or event details, from diverse source data. Its integration is based on the interpretation and analysis of consumer-selected, created, or voice-command subject matter of interest directives 110, alongside user profiles, user preferences, and user history. The analyzed results are dynamically populated into the user's smart calendar via their computing device interface 150 by precisely matching source data (including marketing objects 115) against the consumer's subject matter of interest directives 110, user preferences, and user profiles. This automated, intelligent population of a user's calendar provides a tangible improvement over conventional calendar systems, which are passive and require manual intervention for contextualized scheduling.

A groundbreaking aspect of this technology is its ability to push paid or curated date and time sensitive advertising and promotional information, including marketing objects 115, directly into a user's calendar. This is uniquely based on the system's interpretation and analysis of consumer-selected, created, or voice-command subject matter of interest directives 110, user profiles, user preferences, user history, and marketing directives 110, marketing objects 115, and frequently updated source data feed information 210. The interpreted and analyzed user information is rigorously matched against marketing directives 110, location information, marketing objects 115, and data feeds 210 from advertisers, sources, or establishments 200. The fundamental purpose of this in-depth interpretation and analysis of user profiles, preferences, voice command directives 110, and history is to accurately identify matching directives 110 and marketing objects 115 to populate a user's calendar at a precise time and date, serving multiple functions: providing timely reminders, offering personalized recommendations, delivering crucial informational updates, and/or actively facilitating a purchase 680. The calendar itself can be flexibly structured with 24/7 date and time slots, accommodating any scheduling need. This intelligent, targeted advertising and scheduling capability represents a significant technical improvement in marketing automation, providing contextually relevant information directly into the user's personal planning space, which is far more effective and less intrusive than untargeted advertisements.

The automated personal AI-Driven lifestyle assistant or smart calendar further enhances its utility by proactively populating 635 a user's calendar based on user data 600, user location data (including GPS latitude and longitude coordinates analyzed against location data such as city and state names, establishment or venue names, or latitude/longitude coordinates), and source data including relevant marketing objects 115. This calendar population occurs one or more times daily via the user's mobile computing device 150 to continuously determine the user's location. The AI lifestyle assistant's algorithms and logic are meticulously designed to constantly understand its owner 600 and proactively populate the owner's calendar with activities and destinations 24/7 (Monitor User Data 600, Scan for Matching Content/Opportunities 605, Contextual Analysis 610). This intelligent algorithm 610 is capable of understanding its owner's existing personal and business calendar entries (e.g., Google Calendar, Apple Calendar, or Outlook) 625 and then intelligently suggesting complementary activities and places to go 645. For instance, after confirming a user's dental appointment at 9 AM or a staff meeting at 1 PM, the system 100 will seamlessly suggest subsequent activities 645, even verifying attendance at confirmed reservations by matching user GPS location to the establishment 650 at the appropriate time. Furthermore, the AI assistant can execute tasks or assignments 665 through user voice commands, such as sending emails or texts 665. It can intelligently invite other users to trips or events, and accept or decline invitations 670 based on calendar availability. It proactively prompts the user with notifications or alerts about incoming invitations, crucial information, or events 660, and enriches calendar entries with valuable source data, marketing objects 115, direct links, relevant images, captivating video trailers, celebrity info, and even automatic streaming video or audio (e.g., initiating a TV series stream from Disney+ directly after selecting a hyperlink). This seamless integration extends to calendaring information by parsing confirmation receipts from various sources, including Google Calendar, Apple Calendar, third-party applications, and user emails, leveraging user preferences and location directives via an automated process. The system 100 proactively solves problems with due dates 685, further enhancing its utility as a comprehensive lifestyle manager. This continuous monitoring and proactive behavior, facilitated by the AI processing engine 105, represent a significant technical improvement over basic calendar systems that require explicit user input for every entry, transforming passive calendaring into an active, intelligent personal assistant.

The system empowers a user 150 to instruct the computing system 100 or Personal AI Concierge Lifestyle Assistant, through either selection or a voice command directive 110, to save or actively follow a specific directive 110 or preference, which can pertain to any topic or subject matter. Once a directive 110 is successfully saved and stored within the computing system 100, by the user 150, via a file, data feed 210, API, or other upload means to a computing device 150, the user 150 begins to receive real-time notifications, information, products, or services associated with that directive 110 and their user profile. This real-time information could be seen or heard from a television or radio program or an event, where the directive 110 or preference will be heard or seen on. It can be concert information or a store location that is carrying a product or service the user 150 needs or does not want to forget about. For example, if a user 150 chooses to follow “Oatmeal Ice Cream” as a preference, when that user 150 is out for a drive, the AI assistant or system 100 will notify that user 150 via a computing device 150 if a nearby establishment is selling oatmeal ice cream. This alleviates the need for the user 150 to actively remember such details, as its AI assistant will remind him. Another example: if a user 150 has saved “Tupac Shakur” as a directive 110 or preference in the system 100, and a special program about him is scheduled to be shown on television, the AI Assistant will automatically schedule that program into the user's calendar 635 with a notification informing the user 150 that Tupac Shakur is about to be discussed or shown on a certain channel at a certain time and day. A directive 110 may be a preference. A directive 110 may be any Topic. A topic-driven subject matter directive 110 may be listed, viewed, or heard on television, a smartphone 155, a radio, or other media outlets or computing devices 150. A list or keywords may be in a file, data feed 210, or uploaded to a computing device 150. A directive 110 may be heard via television broadcast or program or a radio broadcast or program, or conveyed by a watermark signal not heard by the human ear. A directive 110 associated with content may be heard using sound recognition or speech recognition. An audio signal may be imperceptible to humans.

This technology is a personal AI concierge lifestyle assistant designed to interpret and analyze consumer directives 110 and respond with results as they exist. Results are delivered to a user 150 via a mobile computing device 150 if the results are available right now or if the results have a future date, or when the results become public for the first time. The AI assistant or computing system 100 continuously checks for a user's current location, new location, or a destination location of a user 150 (e.g., planned trip). Once a location is detected, the AI assistant or computing system 100 may identify one or more locations via a first user mobile computing device 150 using GPS/latitude longitude coordinates of one or more locations and begin analyzing marketing objects 115, events, and one or more files associated with the location against topic driven consumer directives 110, subject matter, lifestyle preferences, popularity, and profile information of a first user to find exact matching. The AI assistant proactively populates recommendations to the user calendar 635 in the order of date and time sensitive events/matching marketing objects 115 (e.g., lifestyle options, Restaurants, nightlife events, concerts, ticketing events, TV shows, massages, hiking, boating, fishing) that are most likely to interest the user 150 at that location. Results do not necessarily have to populate a user calendar but can instead be delivered as a list to the user interface. Each marketing object/item record 115 in the database 125 is associated with latitude longitude coordinates.

A comprehensive database 125 of marketing objects 115 is meticulously organized into categories and subcategories. For instance, this could include restaurants (e.g., Italian, American, Mexican), nightclubs, bars, live events (such as Sports, Concerts, festivals), active life (e.g., fitness, hiking, boating, golfing), Beauty & Spa services (e.g., Massage, tanning), among many other Topics. A calendar may be populated with marketing objects 115 to be organized the same. An AI assistant is engineered to continuously understand its user's location and is smart enough to populate the calendar with the most likely schedule of things to do and places to go for its owner (Monitor User Data 600, Scan for Matching Content/Opportunities 605, Contextual Analysis 610). This spans from early morning breakfast spots and early workout places to nighttime dinner reservations, late-evening sporting events or nightclub options each day or on selected days a user 150 wants to know what is happening in any city or location (Contextual Analysis 610). The Personal AI assistant is also smart enough to interpret a dinner reservation from a populated, confirmed reservation in Google Calendar or Apple Calendar 625 and ascertain if the user 150 actually attended the dinner reservations by matching the GPS/latitude longitude coordinates at the precise time of the reservation (Verify attendance 650). Furthermore, it is capable of scheduling different category events in time slots following a confirmed matching GPS location of the user 150 and an establishment (which acts as a marketing object 115) (Suggest complementary activities 645). For example, if a user 150 went to a restaurant at 6 pm, the personal AI assistant might not schedule a restaurant dinner again for another 3 hours, instead proposing a complementary activity such as dessert, bowling, or a rooftop live event instead at 7:30 pm, 8 pm, or 8:30 pm. The AI assistant can also aggregate the selected or spoken subject matter of interest voice command directives 110 and user profiles 710 of one or more users 150 to create a group trip or group event for those aggregated users 630. It can combine multiple users' directives 110 to construct a unified group trip itinerary, populated with relevant marketing events for each day throughout the duration of the trip or event (Populate shared itineraries 655). This includes the advanced capability of finding exact matching and expressing an event via a subject matter voice command directive 110 for precise calendar population.

One significant technological advancement embedded in this invention is a context-aware, location-sensitive AI assistant that operates as a Lifestyle Orchestration Engine. This AI-Driven Lifestyle Orchestration System represents a breakthrough in consumer-centric artificial intelligence by seamlessly unifying behavioral analysis 620, smart calendaring (Intelligently schedule events into user's calendar 635), real-time media recognition, and location-based marketing into a cohesive and fluid user experience. Unlike existing systems, which merely react to user inputs or confirmations, this invention creates a continuous feedback loop of sensing (Monitor User Data 600), analyzing (Contextual Analysis 610), predicting (Suggest complementary activities 645), and acting (Intelligently schedule events 635). It integrates several advanced technological components into a highly cohesive system. Natural Language Processing (NLP) enables the system to understand and interpret complex voice commands and user preferences (Interpret/analyze user directives 610). Location-Based Services (LBS), utilizing GPS, latitude, and longitude coordinates, identify current and future (e.g., Destination) locations for personalized, automated, geographically relevant recommendations (Monitor User Data 600). Calendar Integration & Behavioral Analysis allows the system to interface with popular calendar tools like Google Calendar or Apple Calendar, cross-referencing information to intelligently plan future activities based on date and time populated events and past behavior (Monitor User Data 600, Understand existing commitments 625). Marketing Object Intelligence leverages rich user data 600, including their directives 110, with a meticulously categorized database 125 of establishments, locations, events, and products, each geotagged and timestamped for precise matching (Scan for Matching Content/Opportunities 605). Proactive Content Matching continuously analyzes broadcast and streaming content for sound, text, and speech recognition techniques, even using imperceptible audio signals, to deliver media-related, topic-driven directive recommendations (Scan for Matching Content/Opportunities 605). Multi-User Aggregation facilitates streamlined group planning by combining the interests of multiple users 150 and generating shared itineraries at specific destination locations (Aggregate preferences from multiple users 630, Populate shared itineraries 655). User-Centric Algorithms continuously refine themselves based on user interactions, preferences, and confirmations (Apply behavioral analysis 620), enabling the system 100 to evolve and better understand each individual's lifestyle. The assistant also incorporates Adaptation to Plans, effectively avoiding scheduling conflicts by recognizing existing commitments and intelligently adapting its suggestions accordingly (e.g., proposing dessert options as a logical follow-up to a dinner reservation) (Suggest complementary activities 645).

This assistant transcends the capabilities of a simple command-response tool. It actively anticipates needs, adapts to changing circumstances, interprets subtle context (Interpret/analyze user directives 610), and proactively manages schedules (Intelligently schedule events into user's calendar 635), fundamentally transforming how users 150 interact with their time, media, and surroundings. This marks a significant leap forward in consumer AI, effectively bridging comprehensive lifestyle management with the concept of ambient computing. More than just a calendar, this orchestration system acts as an ambient computing layer—an invisible, ever-present assistant that subtly shapes and enhances the user's daily life. It provides not only reminders and scheduling functionalities but also curates rich, personalized experiences that align deeply with a user's values, interests, habits, and immediate surroundings. The AI assistant is constantly aware of the user's location, their calendar state, their preferences, and their social context. It delivers highly curated content and experiences ranging from breakfast suggestions and event recommendations to timely entertainment alerts and wellness activities, all personalized by time of day, location, and lifestyle profile. This represents a substantial leap beyond existing scheduling tools. The orchestration system operates with a level of autonomy and adaptability that mirrors human judgment, proposing plans after meals, expertly coordinating group travel based on shared tastes, or subtly reminding a user 150 of a nearby interest as they pass by. It seamlessly bridges the gap between digital life and real-world experience, transforming static scheduling into a dynamic, AI-powered proactive lifestyle engine, marking a truly meaningful advancement in lifestyle AI. The system further delivers notifications/information to a user 660, including real-time alerts to a mobile device. It also provides calendar entries enriched with hyperlinks, media previews, reviews, and geolocation data. Moreover, it can execute tasks/assignments 665 based on user permission or learned behavior, such as sending messages 665 (email, text). The system can accept or decline invitations 670, respond to calendar conflicts 675, initiate purchases 680 (e.g., concert tickets), and proactively solve problems with due dates 685.

The foregoing detailed description of preferred embodiments of the present invention provides comprehensive illustration and description, but it is not intended to be exhaustive or to limit the invention to the precise form disclosed. Modifications and variations1 that do not depart from the spirit and scope of the invention are possible in light of the above teachings or may be acquired from practice of the invention.

For example, while various series of acts and/or steps have been described in a particular sequence, the order of these operations may be modified in other implementations consistent with the principles of the invention, provided logical dependencies are maintained. Furthermore, non-dependent acts or steps may be performed in parallel to enhance efficiency and responsiveness. Still further, although implementations described above discuss the use of facial and voice biometrics for user identification and personalization, it is contemplated that other forms of biometric information (e.g., fingerprints, eye retinas and irises, hand measurements, handwriting analysis, gait patterns, typing patterns, etc.) may be employed to identify individuals and provide corresponding virtual repository information or personalized services, thereby expanding the adaptability and security of the system.

The term “comprises/comprising” when used in this specification, including the claims, is taken to specify the presence of stated features, integers, steps, or components but2 does not preclude the presence or addition of one or more other features, integers, steps, components, or groups thereof. This is intended to indicate an open-ended list of elements, allowing for further additions or variations.

It will be apparent to one of ordinary skill in the art that aspects of the invention, as described above, may be implemented in many different forms of software, firmware, and hardware. The specific implementations illustrated in the figures and described in the specification are merely exemplary. The actual software code, specialized control hardware, or specific circuit designs used to implement aspects consistent with the principles of the invention are not limiting of the invention. Thus, the detailed operation and behavior of the various aspects were described primarily at a functional and logical level without explicit reference to the specific underlying software code or hardware schematics—it being understood that one of ordinary skill in the art would be able to design and implement such software and control hardware to realize the described aspects based on the detailed functional and architectural description provided herein.

No element, step, or instruction referenced in this application, including the claims, should be construed as critical or essential to the invention unless explicitly described as such using terms such as “essential,” “critical,” “must,” “required,” or similar unequivocal language. Also, as used herein, the indefinite article “a” is intended to include one or more items. Where only one item is intended, the term “one” or similar restrictive language is used.3 Further, the phrase “based on” is intended to mean “based, at least in part, on” unless explicitly stated otherwise, indicating that other factors or inputs may also contribute to the basis of the determination or action. While an exemplary embodiment of the invention has been described, it should be apparent that modifications and variations thereto are possible, all of which fall within the true spirit and scope of the invention. With respect to the above description then, it is to be realized that the optimum relationships for the components4 and steps of the invention, including variations in order, form, content, function and manner of operation, are deemed readily apparent and obvious to one skilled in the art based on this detailed disclosure, and all equivalent relationships to those illustrated in the drawings and described in the specification are intended to be encompassed by the present invention. The above description and accompanying drawings are illustrative of numerous modifications that can be made without departing from the fundamental principles of the present invention, the scope of which is to be limited only by the language of the following claims. Therefore, the foregoing is considered as illustrative only of the principles of the invention. Further, since numerous6 modifications and changes will readily occur to those skilled in the art upon reading this detailed description, it is not desired to limit the invention to the exact construction and operation shown and described, and accordingly, all suitable modifications and equivalents are intended to fall within the scope of the invention as claimed.

What is claimed is:

1. A computer-implemented method for proactively managing a user's lifestyle and facilitating real-time commerce, the method comprising: a computing system storing one or more databases, at least one of said one or more databases being associated with one or more virtual repositories, at least one of said one or more virtual repositories being associated with one or more marketing objects, said marketing objects including use information, and at least one of said one or more virtual repositories being populated through an automated process with marketing objects including use information via an artificial intelligence computing processing engine;
wherein at least one of said one or more virtual repositories is associated with one or more users, said one or more users being associated with one or more marketing objects including use information;
wherein one of said one or more virtual repositories is a second virtual repository associated with a second user;
the computing system receiving from a semantic intelligence powered assistant one or more files associated with one or more marketing objects of media data, said one or more marketing objects being marketing objects of items created, used, or owned by the second user;
the semantic intelligence computing system associating said marketing objects with use information for the second user of the second virtual repository and automatically populating one or more marketing objects including use information in categorized fields associated with the second virtual repository matching categorized marketing objects of the media file;
the computing system receiving from a first computing digital device of a first user a first trigger command subject matter directive, said first trigger command subject matter directive requesting first information including user data and marketing objects associated with a subject matter, said marketing objects being associated with one or more virtual repositories of the second user;
the semantic intelligence computing system performing marketing object identification on the first user command subject matter directive, said identification including interpreting the subject matter of interest and identifying the first user from said first trigger command, and identifying the second user from the first user command subject matter of interest associated with the second virtual repository;
the computing system determining if the subject matter of interest of the second user matches the command subject matter of interest of the first user; and if the subject matter of interest of the first user command matches the marketing subject matter of interest of the second user repository, then making available to the first user on the first computing digital device, via network communication, a copy of one or more matching marketing objects, said copy of one or more matching marketing objects including one or more links.

2. The method of claim 1, further comprising populating an event or advertisement to a user's calendar.

3. The method of claim 1, wherein the semantic intelligence powered assistant carries out functions for a user, said functions including initiating a purchase of an item.

4. The method of claim 1, wherein the semantic intelligence powered assistant saves marketing objects or information at the direction of a user.

5. The method of claim 1, further comprising the system populating a calendar with date and time sensitive information on command.

6. The method of claim 1, further comprising the system automatically scheduling a reservation for a user via a third-party reservation application.

7. A computer-implemented method for contextualized content delivery and scheduling, the method comprising:
a computing system storing one or more databases, said one or more databases being associated with one or more virtual repositories;
at least one of said one or more virtual repositories being associated with one or more marketing objects, said marketing objects including use information; at least one of said one or more virtual repositories being populated through an automated process with marketing objects including use information;
wherein at least one of said one or more virtual repositories is associated with one or more users, said one or more users being associated with one or more marketing objects including use information; wherein one of said one or more virtual repositories is a second virtual repository associated with a second user;
the computing system receiving from a semantic intelligence powered assistant one or more marketing objects, said one or more marketing objects being marketing objects of items created, used, or owned by a second user;
the computing system associating said marketing objects with use information for the second user of the second virtual repository, and through a semantic intelligence automated process populating one or more marketing objects including use information in categorized fields associated with one or more virtual repositories of a second user;
the computing system including semantic intelligence receiving from a first computing digital device of a first user a first trigger command subject matter directive, said first trigger command subject matter directive requesting first information including data and marketing objects associated with the command subject matter directive, said command subject matter directive being associated with one or more virtual repositories of a second user;
the computing system including semantic intelligence performing marketing object identification on the first user command subject matter directive, said identification including interpreting the subject matter of interest and identifying the second user from the first user command subject matter of interest associated with the second virtual repository;
the computing system determining if the subject matter of interest of the second user matches the command directive subject matter of interest of the first user; and if the subject matter of interest of the first user command directive matches the marketing subject matter of the second user, then making available to the first user on the first computing digital device, via network communication, a copy of one or more matching marketing objects associated with the subject matter directive.

8. The method of claim 7, further comprising adding date and time sensitive information to a calendar.

9. The method of claim 7, wherein the marketing object includes an advertisement.

10. The method of claim 7, wherein the trigger includes identifying the user including the location of the user.

11. The method of claim 7, wherein the marketing objects include a link.

12. The method of claim 7, further comprising populating of marketing objects from the web via a web crawler.

13. The method of claim 7, wherein the directive includes a condition.

14. The method of claim 7, further comprising making available to the first user on the first computing digital device, the streaming content or a video trailer or an audio trailer of the subject matter command directive.

15. A computer-implemented method for proactive lifestyle orchestration and calendar management, the method comprising:
a computing system storing one or more databases, at least one of said one or more databases being associated with one or more virtual repositories, at least one of said one or more virtual repositories being associated with one or more marketing objects including use information, and at least one of said one or more virtual repositories being populated through an automated process of marketing objects including use information via artificial intelligence;
wherein at least one of said one or more virtual repositories is associated with one or more users, said one or more users being associated with one or more marketing objects including use information; wherein one of said one or more virtual repositories is a second virtual repository associated with a second user of a plurality of users;
the computing system receiving from artificial intelligence one or more files associated with marketing objects associated with the second user, said marketing objects being marketing objects created, owned, or used by the second user; the computing system including artificial intelligence associating the marketing object with use information for the second user of the second virtual repository;
the computing system including artificial intelligence receiving from a first computing digital device of a first user one or more directives including use information of the first user, said one or more directives being associated with marketing objects and use information of the second virtual repository of the second user; and subsequently,
the computing system including artificial intelligence receiving from the first computing digital device of the first user an automated system generated location information trigger, said automated location information trigger of the first computing device of the first user requesting the resting or traveling location information, a user profile including directives of the first user; wherein the resting or traveling location information, a user profile including directives of the first user is associated with location information of a second user, and the location information of the second user is associated with one or more files of marketing objects including date and time sensitive advertisement associated with the second user, said second user being associated with use information and one or more virtual repositories;
the computing system including artificial intelligence performing resting or traveling location identification on the first user computing digital device, said identification including determining the resting or traveling location and a user profile of the first user and performing artificial intelligence on the first user directives including use information of the first user to determine if the first user directives and use information match the marketing objects and use information of one or more virtual repositories of a second user, including the second user location; and if there is a match, then the automated computing system including artificial intelligence begins populating the date and time sensitive marketing objects and advertisement, including a link, of the second user repository into matching date and time fields of the calendar of the first user computing digital device, said automated calendared marketing objects, advertisement, and link being responsive to the automated system generated location trigger of the first user computing device.

16. The method of claim 15, wherein the resting or traveling location information is determined by GPS data, location input, calendar input, email reservation confirmation, email confirmation receipts, or a third-party calendar travel or reservation confirmation.

17. The method of claim 15, wherein populating a calendar with marketing objects, events, and advertising includes utilizing a subject matter voice command directive.

18. The method of claim 15, wherein populating a calendar includes aggregating directives from one or more users for recommendations for a combined group trip.

19. The method of claim 18, wherein the group trip includes all users receiving the same calendar schedule for the date and time duration of the trip.

20. The method of claim 15, further comprising automated streaming video/audio, such as a TV series stream, after selecting a hyperlink.

21. The method of claim 15, wherein executing tasks or assignments includes responding to calendar conflicts.

22. The method of claim 15, wherein executing task or assignments includes facilitating a purchase.

23. The method of claim 15, wherein executing tasks or assignments includes proactively solving problems with due dates.

24. A computer-implemented method of exact matching marketing objects in a repository system supplied from a trigger, the method comprising:
a computing system storing one or more databases, at least one of said one or more databases being associated with one or more virtual repositories, at least one of said one or more virtual repositories being associated with one or more marketing objects, said marketing objects including use information, and at least one of said one or more virtual repositories being populated through an automated process of marketing objects including use information via artificial intelligence;
wherein at least one of said one or more virtual repositories is associated with one or more users, said one or more users being associated with one or more marketing objects including use information; and wherein one or more marketing objects are associated with one or more virtual repositories associated with a second user;
the computing system receiving from artificial intelligence one or more files associated with marketing objects, said marketing objects including video data of a second user, said video data being associated with marketing objects related to a video program of a second user, and said one or more marketing objects being marketing objects of items created, used, or owned by a second user; the computing system associating said marketing objects with use information for the second user of the second virtual repository and through an artificial intelligence automated process populating one or more marketing objects including use information in categorized fields associated with one or more virtual repositories of a second user;
the computing system including artificial intelligence receiving from a first computing digital device of a first user a first trigger command subject matter directive, said first trigger command subject matter directive requesting first information including video data of a video including marketing objects associated with the command subject matter directive, said command subject matter directive being associated with one or more virtual repositories of a second user;
the computing system including artificial intelligence analyzing and performing marketing object identification on the first user command subject matter directive, said identification including interpreting the subject matter of interest and the video data, and identifying the second user from the first user command directive subject matter of interest and the video data associated with the second virtual repository;
the computing system determining if the subject matter of interest of the second user matches the command directive subject matter of interest of the first user; and if the subject matter of interest of the first user command directive matches the marketing object subject matter of the second user, then making available to the first user on the first computing digital device, one or more matching marketing objects including one or more links associated with video data of the video related to the second user, said one or more matching marketing objects being responsive to the first user first trigger command subject matter directive.

25. The method of claim 24, wherein the marketing object includes TV listings.

26. The method of claim 24, further comprising automated streaming video/audio, such as a TV series stream, after selecting a hyperlink.

27. The method of claim 24, further comprising executing tasks or assignments based on user permission or learned behavior, such as sending messages.

28. The method of claim 27, wherein executing tasks or assignments includes responding to calendar conflicts.

29. The method of claim 27, wherein executing tasks or assignments includes initiating purchases.

30. The method of claim 27, wherein executing tasks or assignments includes proactively solving problems with due dates.
